(19) United States
(12) Patent Application Publication
(10) Pub. No.: US 2017/0028870 A1
(43) Pub. Date: Feb. 2, 2017

(54) ROTATIONAL COUPLING USING MAGNETICALLY GENERATED LIFT AND CONTROL OF MAGNETICALLY LIFTED VEHICLES

(71) Applicant: Arx Pax Labs, Inc., Los Gatos, CA (US)

(72) Inventors: Chase Nachtmann, Bend, OR (US); D. Gregory Henderson, Saratoga, CA (US); David P. Olynick, Albany, CA (US); Albert Hartman, Palo Alto, CA (US); Wendy Lorimer, Ann Arbor, MI (US)

(73) Assignee: Arx Pax Labs, Inc., Los Gatos, CA (US)

(21) Appl. No.: 15/223,137

(22) Filed: Jul. 29, 2016

Related U.S. Application Data
(60) Provisional application No. 62/198,301, filed on Jul. 29, 2015.

(51) Int. Cl. B60L 13/04; H02N 15/00; A63C 17/12

(52) U.S. Cl. CPC B60L 13/04; A63C 17/12; H02N 15/00; B60L 2200/20; A63C 2203/12

(57) ABSTRACT

Electromechanical systems using magnetic fields to induce eddy currents and generate lift and/or thrust are described. Magnet configurations which can be employed in the systems are illustrated. The magnet configuration, rotation, and/or tilt can be used to generate lift and/or thrust. Arrangements of hover engines, which can employ the magnet configurations, are described. Further, vehicles, which employ the hover engines and associated hover engines are described.

### CROSS-REFERENCE TO RELATED APPLICATIONS

This application claims priority under 35 U.S.C. §119 of U.S. Patent Application No. 62/198,301, filed Jul. 29, 2015, by Henderson, et al, titled, “ROTATIONAL COUPLING USING MAGNETICALLY GENERATED LIFT AND CONTROL OF MAGNETICALLY LIFTED VEHICLES”, which is incorporated herein by reference in its entirety and for all purposes.

### FIELD OF THE INVENTION

This invention generally relates to electromagnetic levitation systems, and more particularly to devices, which employ electromagnetic levitation.

### BACKGROUND

It is well known that two permanent magnets will attract or repulse one another at close distances depending on how the poles of the magnets are aligned. When aligned with the gravitational force vector, magnetic repulsion can be used to counteract gravity and lift an object. For the purposes of lifting an object and then moving it from one location to another location, magnetic repulsion is either unstable or too stable. In particular, opposing magnets can either be aligned such that the object remains in place but then can't be easily be moved to another location or the magnets can be aligned such that the object is easily moveable but won't remain in place but not both.

Another magnetic repulsion effect is associated with generating a moving magnetic field near a conductive object. When a permanent magnet is moved near a conductive object, such as a metal object, eddy currents are established in the conductive object, which generate an opposing magnetic field. For example, when a permanent magnet is dropped through a copper pipe, an opposing magnetic field is generated which significantly slows the magnet as compared to a non-magnetic object dropped through the pipe. As another example, in some types of electric motors, current is supplied to coils which interact with magnets to move the magnets. The moving magnets interact with the coils to induce eddy currents in the coils which oppose the flow of current supplied to the coils.

Magnetic forces including magnetic lift are of interest in mechanical systems to potentially orientate and move objects relative to one another while limiting the physical contact between the objects. One method of generating magnetic lift involves an electromagnetic interaction between moving magnetic fields and induced eddy currents. This approach, using eddy currents, is relatively undeveloped. In view of the above, new methods and apparatus for generating magnetic lift using eddy currents are needed.

### SUMMARY

Electromechanical systems using magnetic fields to induce eddy currents in a conductive substrate and generate lift and directional movement are described. In particular, hover engines are described which rotate a configuration of magnets to induce eddy currents in a conductive substrate where the interaction between the magnets and the induced eddy currents are used to generate lift forces and/or propulsive forces. In one embodiment, to generate propulsive forces, mechanisms are provided which allow a tilt orientation of the configuration of magnets relative to the conductive substrate to be changed. The mechanisms enable control of a direction and a magnitude of the propulsive forces. Vehicles using these mechanisms are described.

In one embodiment, a hover vehicle is disclosed. The vehicle includes a plurality of hover engines, each hover engine having: (i) an electric motor including a winding, a first set of permanent magnets and a first structure which holds the first permanent magnets wherein an electric current is applied to the winding to cause one of the winding or the first set of permanent magnets to rotate, and (ii) a second structure, configured to receive a rotational torque from the electric motor to rotate the second structure. The second structure holds a second set of permanent magnets, and the second set of permanent magnets are rotated to induce eddy currents in a substrate such that the induced eddy currents and the second set of permanent magnets interact to generate forces which cause the vehicle to hover above and/or translate from location to location along the substrate. The vehicle further includes one or more controllers coupled to the hover engines for individually controlling a tilt of each of the hover engines, an on-board electric power source that supplies the electric current to the hover engines via the one or more controllers, and a rider platform including a front end, a back end and an upper surface. The hover engines are arranged with respect to one another and the tilt of each hover engine are selectable so as to cause the vehicle to move in a particular direction.

In a specific implementation, the particular direction is a translational direction along a circular or curved path. In another aspect, the particular direction is a rotational direction so that the vehicle rotates in place. In yet another example, the particular direction is a combined translational and rotational direction so that the vehicle moves along a linear or curved path and rotates around an axis while moving along the path. In another aspect, the tilt of each hover engine is further selectable so as to cause the vehicle to maintain a position.

In another embodiment, the one or more controllers are further configured for individually controlling a rotational speed of each of the hover engines, and he rotational speed of each hover engine is also selectable so as to contribute to causing the vehicle to move in a particular direction. In a further aspect, controlling the tilt and rotational speed of each of the hover engines includes individually controlling a translational force generated by each hover engine.

In an alternative aspect, the one or more controllers are further configured to counter imbalances in one or more forces externally applied to such vehicle. In a further aspect, the forces externally applied to such vehicle cause a shift of a center of mass of the vehicle.

In another embodiment, the hover engines include a first, second, third, and fourth hover engines that each have a tilt axis about which it is tiltable by the one or more controllers. An angle between the tilt axes of the first and second hover engines is 90 degrees; an angle between the tilt axes of the third and fourth hover engine is 90 degrees; and the first hover engine is arranged opposite the third hover engine so as to have parallel tilt axes. In this aspect, the second hover engine is arranged opposite the fourth hover engine so as to have parallel tilt axes. In another embodiment, the first and second hover engines are adjacent to each other and have a first angle between their tilt axes and is between 0 and 180 degrees, and the first and third hover engines are opposite each other and have a second angle between their tilt axes that is equal to 180 degrees minus the first angle.

In a specific implementation, the hover engines each have a tilt axis about which it is tiltable by the one or more controllers, and wherein angles between all of the tilt axes differ from each other. In another aspect, the tilt of each hover engine are selectable as a function of time so as to cause the vehicle to move in different directions as a function of time so as to follow different linear and/or curved paths. In a further aspect, the tilt of each hover engine are selectable as a function of time so as to cause the vehicle to move in different directions as a function of time so as to follow different linear paths, including a first path in a first direction for a first time period and a second path in a second direction for a second time period that immediately commences after the first time period. In one aspect, the first path is perpendicular to the second path.

In a specific embodiment, the vehicle includes a plurality of actuators for tilting the hover engines. In a further aspect, at least one of the actuators is arranged to tilt more than one hover engine. In another aspect, the one or more controllers are configured to cause the actuators in combination with input from a rider of the vehicle to tilt one or more of the hover engines.

In one embodiment, the hover engines are arranged to tilt through a range of −10 to 10 degrees. In another embodiment, the hover engines are arranged to tilt through different ranges of angles. In another aspect, the one or more controllers are configured for individually controlling a tilt of each of the hover engines in response to commands received from a remote control device. In one example, the hover engines have tilt axes that are an equal distance from a center of mass of the vehicle. In another implementation, the one or more controllers are further configured for individually controlling a rotational speed of each of the hover engines, and the rotational speed of each hover engine is also selectably pulsed so as to contribute to causing the vehicle to move in a particular direction. In another feature, the vehicle includes one or more sensors for detecting a relative position and orientation of the vehicle, and the one or more controller are further configured for individually controlling the tilt and/or rotation of each hover engine based on the detected position and orientation as compared to a desired position and orientation.

### BRIEF DESCRIPTION OF THE DRAWINGS

The included drawings are for illustrative purposes and serve only to provide examples of possible structures and process steps for the disclosed inventive systems and methods. These drawings in no way limit any changes in form and detail that may be made to the invention by one skilled in the art without departing from the spirit and scope of the invention.

FIG. 1 shows two pairs of STARMs as an example of yaw control using motor RPM control in accordance with one embodiment of the present invention.

FIG. 2 shows two different persons controlling a hoverboard using a hand-held device to cause the vehicle to rotate in one direction or the opposite direction in response an input signal generated from the hand held device in accordance with a specific embodiment of the present invention.

FIG. 3 illustrates a hoverboard platform through which a protuberance extends in accordance with a specific implementation of the present invention.

FIG. 4 shows a top and side view of a STARM rotating above a conductive substrate approximately parallel to the substrate in accordance with one embodiment.

FIG. 5 illustrates a front and side view of a wheel and a side view of a STARM in accordance with a specific embodiment.

FIG. 6 shows a perspective view of a STARM and wheel.

FIG. 7 shows an example of magnets that are arranged around an outer edge of the STARM so that the lift is projected outwards in accordance with one embodiment of the present invention.

FIG. 8 illustrates an example embodiment having a polygonal shape as the conductive surface in accordance with one embodiment of the present invention.

FIG. 9 illustrates magnetic lift converted to rotation using a wheel and STARM with rotation direction control in accordance with an alternative embodiment.

FIG. 10 illustrates examples of a STARM with varying magnet configurations and polarity patterns in accordance with various embodiments of the present invention.

FIG. 11 is an illustration of a person riding a hoverboard in accordance with certain described embodiment.

FIGS. 12 and 13 are illustrations of eddy currents generated on a conductive plate in response to arrangements of magnets rotated above the plates in accordance with certain described embodiments.

FIG. 14A is a plot of lift and drag curves associated with an arrangement of rotating magnets in accordance with certain described embodiments.

FIG. 14B is a plot of lift associated with an arrangement of rotating magnets as a function of distance from a conductive substrate in accordance with certain described embodiments.

FIG. 14C is a plot of lift curves associated with an arrangement of rotating magnets as a function a thickness of a conductive substrate and RPM in accordance with certain described embodiments.

FIGS. 15A to 15C are illustrations of a hover engine in accordance with certain described embodiments.

FIGS. 16A, 16B, 17 and 18 are illustrations of STARMs tilted relative to a conductive substrate and associated forces which are generated in accordance with certain described embodiments.

FIGS. 19A to 19C are illustrations force imbalances resulting from tilting a hover engine in accordance with certain described embodiments.

FIGS. 20A to 20B are illustrations of two orientation control mechanisms for a hover engine in accordance with certain described embodiments.

FIG. 21A illustrates an embodiment with a lever arm coupled to a motor/STARM via a ball joint in accordance with certain described embodiments.

FIG. 21B illustrates an embodiment having foot pedals, which can be used to tilt hover engine including a motor and a STARM in accordance with a specific implementation of the present invention.

FIG. 22 is an illustration of a magnetically lifted device with four tiltable STARMs in accordance with certain described embodiments.

FIGS. 23A to 23C are illustrations of a magnetically lifted device with four tiltable STARMs tilted in various configurations in accordance with certain described embodiments.

FIG. 24 is an illustration of a magnetically lifted device with four tiltable STARMs and one fixed STARM in accordance with certain described embodiments.

FIGS. 25 to 27 are illustrations of block diagrams and equations associated with a guidance, navigation and control system in accordance with certain described embodiments.

FIGS. 28 and 29 are top and perspective views of a STARM including cubic magnets arranged in a circular pattern in accordance with certain described embodiments.

FIGS. 30 and 31 are top views of magnet configurations and polarity alignment patterns of magnets arranged in a circular pattern in accordance with certain described embodiments.

FIG. 32 is a top view of a magnet configuration and associated polarity alignment patterns, which include magnets that span across the axis of rotation of a STARM, in accordance with certain described embodiments.

FIG. 33 is a top view of a magnet configuration and associated polarity alignment patterns, which include magnets that span across the axis of rotation of a STARM for a reduced distance, in accordance with described embodiments.

FIG. 34 is a top view of a magnet configuration and associated polarity alignment patterns, which include magnets arranged in a cluster, in accordance with certain described embodiments.

FIG. 35 is a top view of a magnet configuration and associated polarity alignment patterns, which include magnets arranged in an alternative cluster, in accordance with certain described embodiments.

FIG. 36 is a top view of a magnet configuration and associated polarity alignment patterns, which include magnets arranged in an alternative cluster, in accordance with certain described embodiments.

FIGS. 37 to 39 illustrate top views of example magnet configurations and associated polarity alignment patterns, which include magnets arranged in multiple clusters, in accordance with certain described embodiments.

FIGS. 40 and 41 are top views of magnet configurations and associated polarity alignment patterns, which include magnets arranged in linear arrays, in accordance with certain described embodiments.

FIG. 42 illustrates predicted eddy current patterns for the magnet configuration shown in FIG. 28.

FIG. 43 illustrates predicted eddy current patterns for a gap introduced above the axis of rotation.

FIG. 44 illustrates predicted eddy current patterns for the magnet configuration shown in FIG. 34.

FIG. 45 illustrates predicted eddy current patterns for the magnet configuration shown in FIG. 37.

FIG. 46 illustrates predicted eddy current patterns for the magnet configuration shown in FIG. 40.

FIG. 47 illustrates predicted eddy current patterns for the magnet configuration shown in FIG. 41.

FIGS. 48 and 49 are plots of lift versus height which compare numerically predicted data and experimental data.

FIGS. 50, 51 and 52 are plots of numerical predictions of lift versus height for various magnet configurations.

FIG. 53 is a plot of numerical predictions of lift and thrust versus height as a function of tilt angle for a circularly arranged magnet configuration.

FIGS. 54 and 55 are plots of numerical predictions of lift and thrust force as a function of tilt angle for the magnet configuration in FIG. 28.

FIGS. 56 to 70 illustrate different magnet configurations and simulation results in accordance with various embodiments of the present invention.

FIG. 71 is a bottom of a battery powered hoverboard in accordance with certain described embodiments.

### DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

### Yaw Control Using Motor RPM Control

In this section, hardware and apparatus that can be used to provide yaw (and direction) control on a magnetically lifted vehicle are described. The method and hardware can enable a plurality of hover engines to be controlled at different RPM rates. The difference in the RPM rates between the engines can cause a torque to be generated which can affect a yaw position and yaw rate of the vehicle. The torque can be used to counter a rotation of a magnetically lifted device in a particular direction, such that the yaw rate is zero, or cause a rotation of a magnetically lifted device in a particular direction.

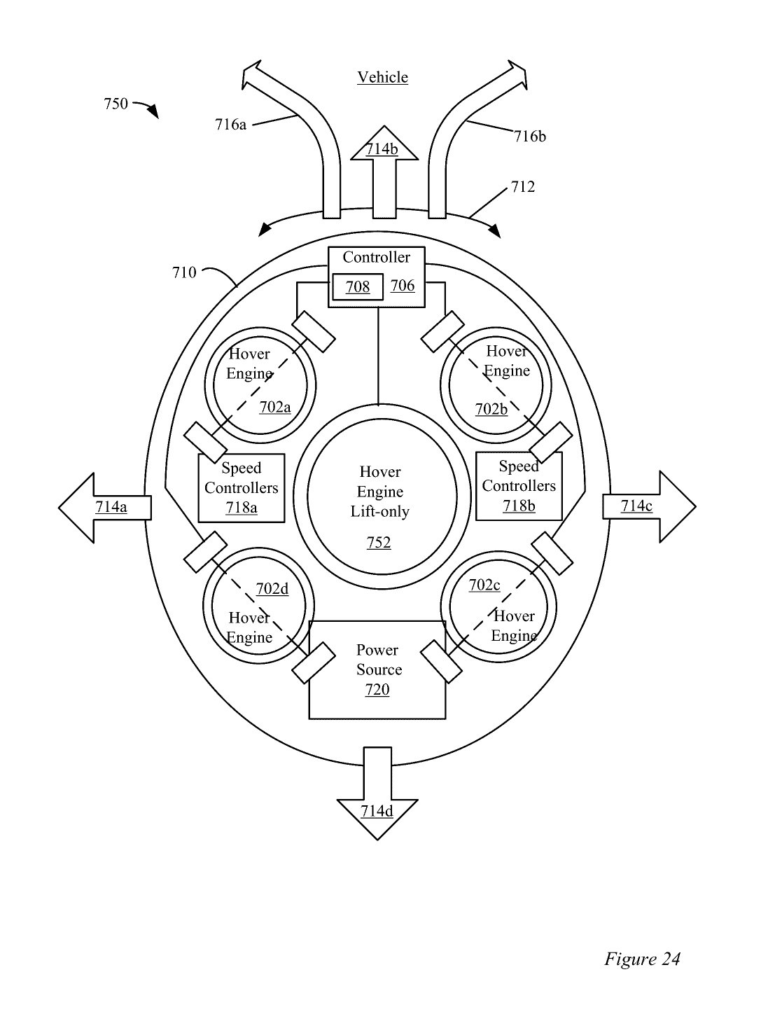

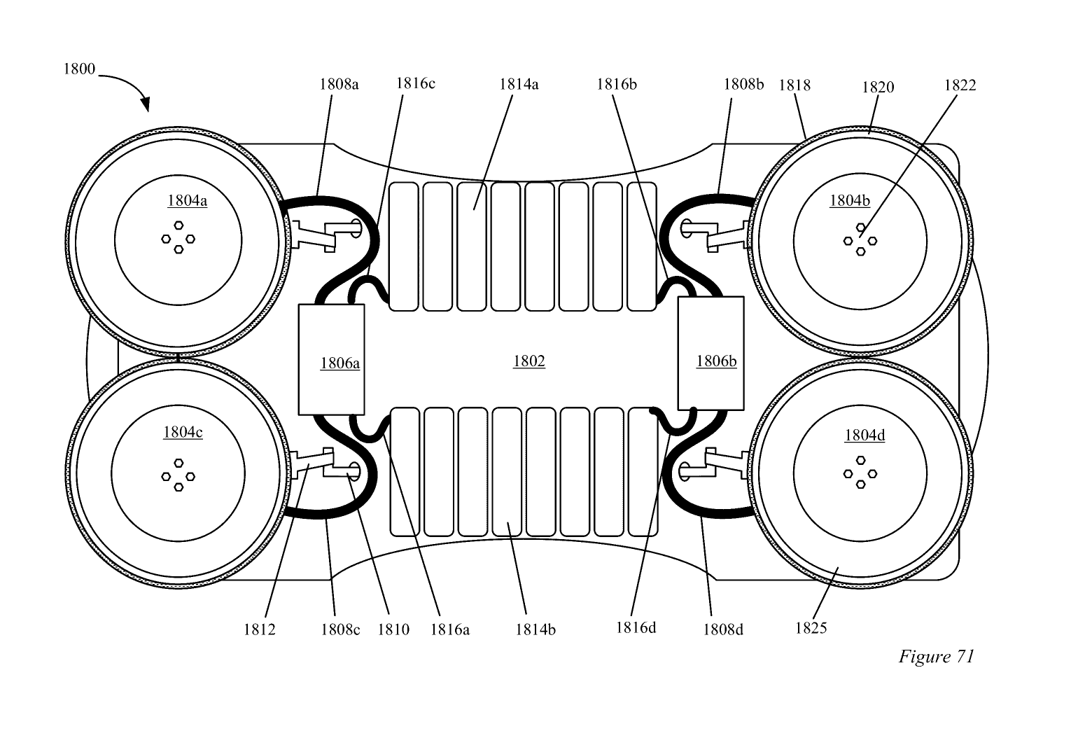

As examples, the yaw (and direction) control hardware and method can be applied to a first vehicle described below with respect to FIG. 22-24 in the section “Vehicle Configurations and Navigation, Guidance and Control (NGC)” and a second vehicle described below with respect to FIG. 71 in the section “Magnet Configurations and Performance Comparisons.” The two vehicles each include four hover engines. However, the methodology can be applied to vehicles with less than or more than four hover engines.

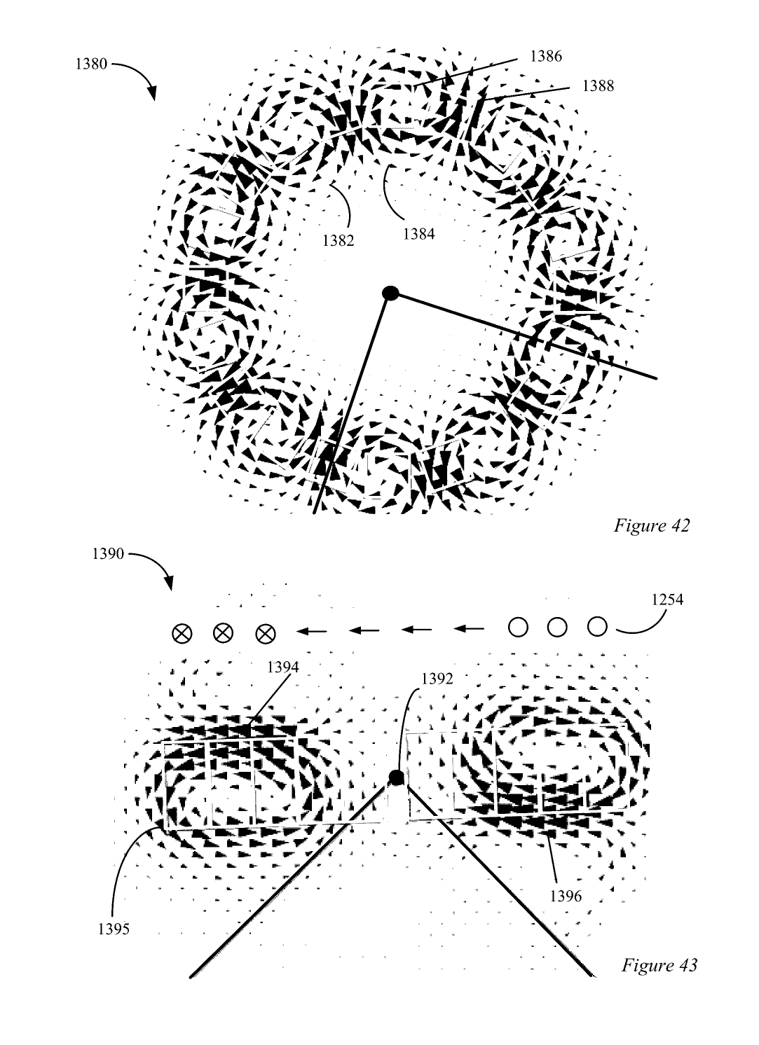

Another method of yaw control can include tilting a hover engine. This approach is described in detail with respect to FIGS. 35-37. In particular embodiments, yaw control using motor RPM control can be used alone or in combination with a hover engine tilting approach. For example, a first vehicle can be configured with hover engines that are not tiltable, and yaw control can be accomplished using only motor RPM control. In another embodiment, a second vehicle can be configured with one or more STARMs that are tiltable and yaw control can be accomplished at different times using only motor RPM control, using both motor RPM control and STARM tilt control or using only STARM tilt control.

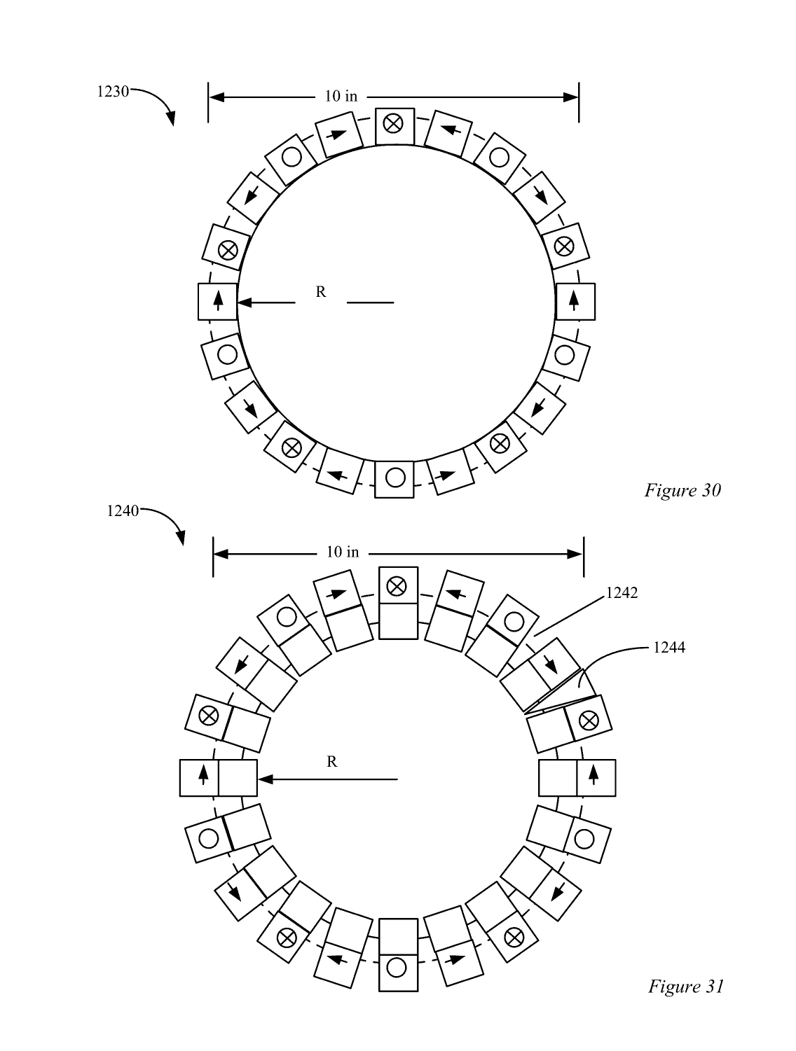

A control methodology including direction and yaw control using tiltable STARMs is described with respect to FIGS. 25-27. In particular embodiments, the methodology can be adapted to include yaw control using motor RPM control. In other embodiments, the control approach illustrated in FIG. 27 can be applied to determine RPM rates of motors for the purposes of yaw control.

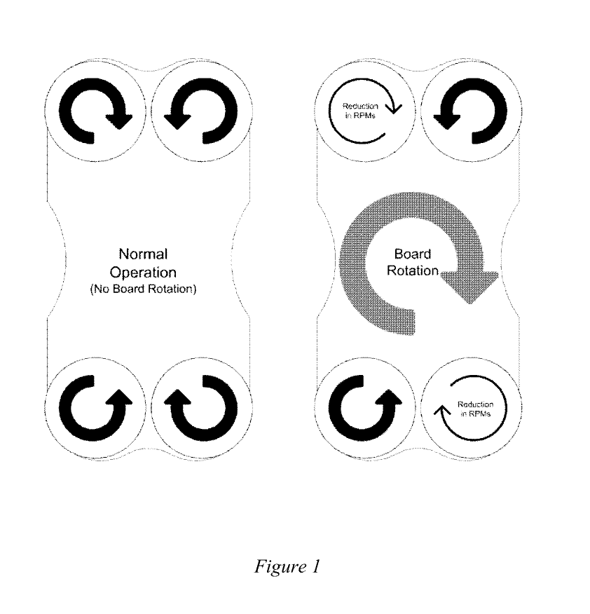

An example of yaw control using motor RPM control is shown above with respect to FIG. 1. The device in this example includes four STARMs The rotation directions of each of the STARMs is illustrated. In particular, one pair of STARMs situated diagonally across from another rotate clockwise and the other pair rotates counter clockwise.

In the example in FIG. 1 the device starts out with the STARMs all rotating at about the same rate and there is not any rotation about the center of mass of the vehicle. Then, the RPM rates of the STARMs which rotate clockwise are reduced from a first rate to a second rate and a yaw rotation in the clockwise direction is induced on the vehicle. To induce a yaw rotation in the other direction, the STARMs that rotate clockwise can be returned to the first rate and the RPM rate of the STARMs that rotate in the clockwise direction can be reduced relative to the STARM that rotates in the clockwise direction.

The net torque of the system is a function the difference in RPM rates of the different STARMs. The magnitude of the difference can affect the magnitude of the moment which is induced and cause the yaw rate to vary. The difference in RPM rates can be achieved via increasing or decreasing the RPM rates of some of the STARMs relative to the other STARMs. In operation, a controller can be configured to increase a rotation rate of one or more of the STARMs at some times or decrease the rotation rates of one or more of the STARMs to other times to cause a yaw of a vehicle to change.

In a particular embodiment, the RPM rates can be pulsed. For example, the RPM rates of one or more STARMs can be reduced relative to the other STARMs from a first rate to a second rate over a first time period and then returned to the first rate over a second time period. This pattern can then be repeated multiple times. In some instances, it was found that pulsing can generate a faster yaw rate then just reducing the one or more STARMs to the second rate and then holding it at the second rate.

In one embodiment, the RPM rates of the STARMs on opposite corners can be controlled as units. Thus, the RPM rates of each STARM in the pair can be approximately the same (FIG. 1 shows two pairs of STARMs). But, the RPM rates between the pairs can be different. In other embodiments, the RPM rates of each of the STARMs can be individually controllable.

In one embodiment, the yaw of a vehicle can be controlled automatically. In another embodiment, the yaw of a vehicle can be controlled in response to a manual input from a person. For example, a person can use a joy stick or other type of input device to generate an input signal to indicate a desired yaw in one direction or another direction. In yet other embodiments, a combination of automatic control and user control can be utilized.

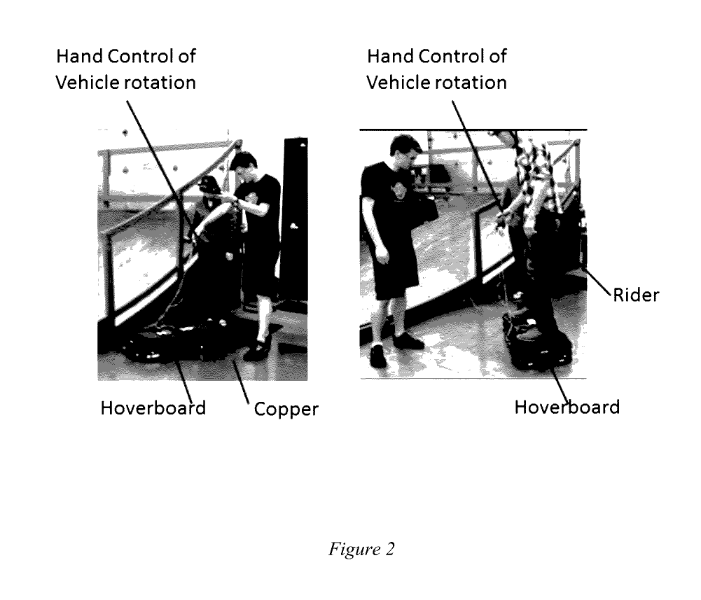

In FIG. 2, two different persons are shown controlling a hoverboard using a hand-held device to cause the vehicle to rotate in one direction or the opposite direction in response to an input signal generated from the hand held device. In one image, a first person is standing beside the hoverboard with the hand-held device while its yaw is controlled via the hand-held device. In another image, a second person is standing on the hoverboard with the hand-held device while its yaw is controlled via the handheld device.

In this example, the hand-held device is a two axis joy stick coupled via a wire to the hoverboard. In other embodiment, the hand-held device can be wirelessly coupled to the hoverboard. A MultiWii micontroller board is used to receive the input signals from the hand-held device. In response to receiving the input signals, the microcontroller can command one or more of the motors coupled to the STARMs to implement a particular RPM rate.

The microcontroller can also receive information associated with the motor such as a current RPM rate. In addition, the microcontroller can receive information from other sensors, such as multi-axis accelerometers and gyroscopes. These sensors can be used to determine a current position and trajectory of the hoverboard including a current rotation rate and direction. Using the sensor data, the microcontroller alone or in combination with an input from the hand-held device can be used to control a yaw rate of the vehicle and/or a yaw orientation of the vehicle via control of the RPM rates of the STARMs.

The yaw control can be affected by the location of the center of mass on the device. In a particular embodiment, the device can include sensors for determining a weight distribution on the device. For example, a device can include a payload platform, such as a rider platform. A number of weight detecting sensors, such as strain gauges, can be placed underneath the payload platform. Output signals from the strain gauges can be used to determine a weight distribution on the payload platform.

In some instances, a payload, such as person, may change position on a device while it is in flight. Thus, a center of mass location of the vehicle can change in flight. In other instances, the payload location may not change much and the center of mass location may remain relatively constant during flight.

In response to receiving data from the weight sensors, a microcontroller can be configured to determine the center of mass of the device. The center of mass can be used to determine the RPM rates for each STARM for the purposes of yaw control. The RPM rates determined using the center of mass can be sent to speed controllers, such as an electronic speed controller, to affect a change of the RPM rate of one or more of the STARMs.

In particular embodiments, the joy stick in FIG. 2 can also include a kill switch. The kill switch or kill button can be actuated by the rider to turn off the device. For example, if a rider is riding the device and falls off, the rider can hit the kill switch. In response, the device will shut down and land as opposed to continuing to hover and possibly translating away from the rider.

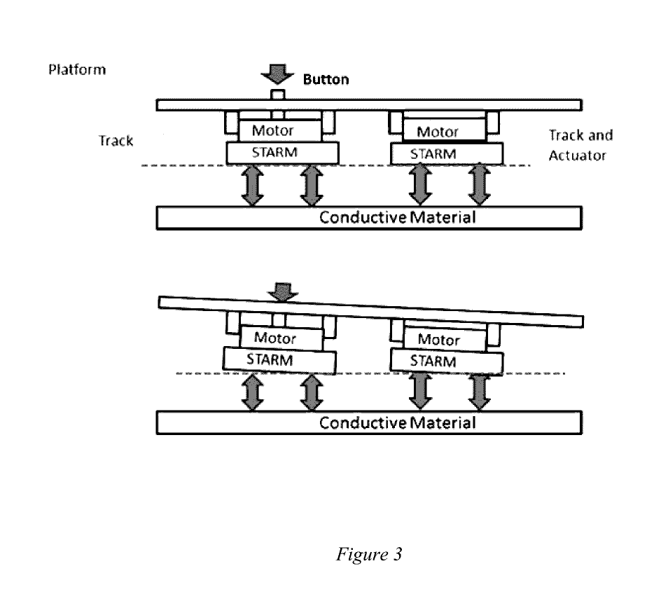

In an alternate embodiment, a control force via tilting can be achieved by allowing a STARM to move along a path, such as a curved or linear path. For example, as shown in FIG. 3, a hover engine including a motor and STARM can be coupled to a track that allows the hover engine to be moved along the path defined by the track from a first position to a second position. In response to an application of a force, the hover engine will move along the path.

As an example, the device in FIG. 3 includes a protuberance (e.g., “button”), which extends through a platform. A person can step on the protuberance to move the motor and STARM downward along the track. As another example, a second motor and STARM include a track and an actuator. The actuator can generate a force which moves the motor and STARM in one direction or in both directions along the track.

The motor and STARM can be coupled to a force restoring mechanism which returns to the motor and STARM to its original position when a force is removed. For example, in FIG. 3, as described above, a protuberance is shown on which a person can step. In response, the motor and STARM can be moved downwards along the track. The motor and STARM can coupled to a mechanism, such as a spring or a membrane which is stretched when the force is applied. When the force is removed, the spring or membrane can contract and return the hover engine to its original position.

In operation, when a hover engine is first moved downward along the track, the hover engine may move closer to the surface relative to the adjacent hover engine. This change in position can cause the lift and traction generated from the hover engine which is moved closer to the surface to temporarily increase. The relative increase in traction can induce a rotation in the device. The increase in lift can cause the device to rebound and push upwards. The upward movement can cause the board to tilt. When the board is tilted, the lift and drag from adjacent STARMs can be affected to generate additional control forces.

In particular embodiments, the position of a hover engine along a track can be controlled via a controller coupled to one or more actuators where the actuators move the hover engine along the track. The controller can be configured to change a position of a hover engine along the track based upon receive sensor data that describe such quantities as orientation, position, velocity, rotation rate, acceleration, and any combination thereof of the device. In addition, the controller can be configured to change a position of the hover engine in response to an input signal from an input device controlled by a user, alone or in combination, with the input signal from the user.

### Rotational Coupling Using Magnetic Lift

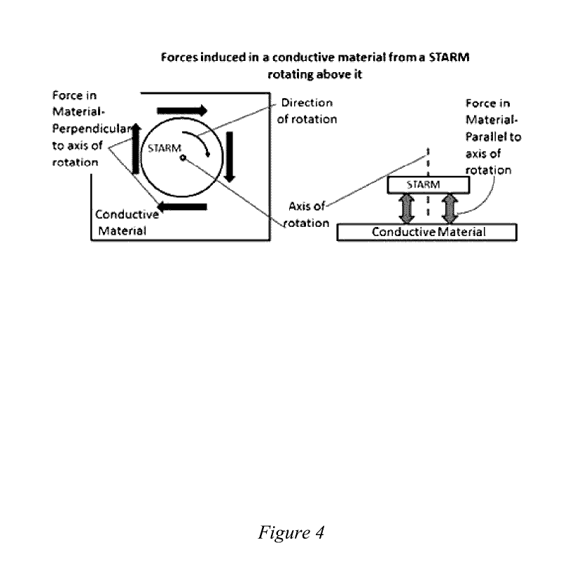

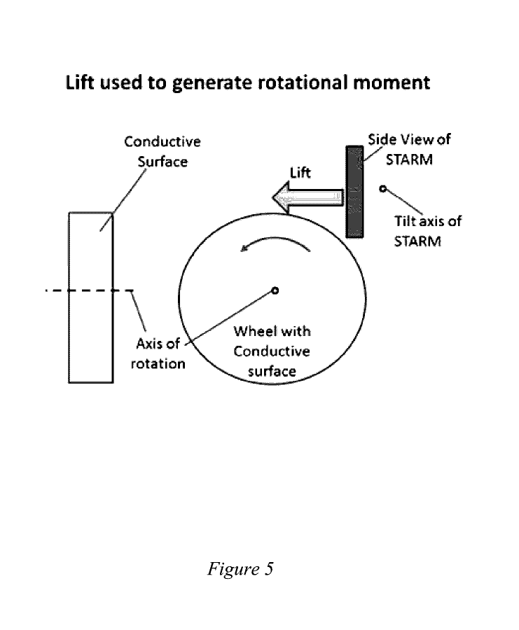

In this section rotational coupling using magnetic lift are described with respect to FIG. 4-8. In particular, forces induced in a conductive substrate from a rotating STARM, including lift and traction are discussed with respect to FIG. 4. Then, some configurations in which magnetic lift is used to induce rotations in a device are described with respect to FIGS. 5-8.

FIG. 4 shows a top and side view of a STARM rotating above a conductive substrate approximately parallel to the substrate. The STARM rotates about an axis of rotation in a particular direction. When rotating magnets in the STARM induce eddy currents in the conductive material, the interaction between the eddy currents cause traction and lift forces. The traction forces cause a moment which wants to rotate the conductive material about the axis of rotation. To generate the moment, the traction forces act primarily perpendicular to axis of rotation of the STARM. The lift forces want to push the conductive material away from the STARM. These lift forces act primarily parallel to the axis rotation.

Traditionally, traction forces have been applied to cause rotational coupling between a conductor and a magnet. For example, in an electric motor or generator, the traction forces between conductors and magnets, which act perpendicular to the axis of rotation of the motor, cause the conductors and magnets to rotate relative to one another. The conductors are located in stator and the magnets in a rotor or vice versa. In this configuration, the lift forces, which act parallel to the axis of rotation of the motor, do not perform any useful work. Hence, in a motor, it is advantageous to maximize the traction forces and minimize the lift forces.

In the examples that are described below, the lift forces (rather than the traction forces) are used to generate a rotation of a component about an axis. In some STARM configurations, the lift forces, which are transferred to a conductive material, can be significantly greater than the traction forces. Hence, it may be advantageous to use the lift forces to provide rotational coupling between a STARM and another rotatable object.

In FIG. 5, a front and side view of a wheel and a side view of a STARM are shown. The wheel includes a conductive surface in which eddy currents are induced from the rotation of the STARM. The axis of rotation of the STARM is not parallel to the axis of rotation of the wheel. In particular, it is perpendicular to the axis of rotation of the wheel. Other orientations between the axis of rotation of the STARM and the axis of rotation of the wheel are possible and this example is provided for the purpose of illustrations only.

The STARM includes a secondary tilt axis. The STARM can be tilted about the secondary tilt axis to bring the STARM closer or farther away from the conductive surface of the wheel. By varying the distance, the amount of lift force and, hence, the resulting rotational moment can be varied. In another embodiment, the STARM can be moved linearly along some vector to bring the STARM closer or move the STARM father away from the conductive material. The distance can be varied to control the force that is transferred to the conductive surface.

In other embodiments, the orientation of the STARM can be fixed. However, the rotation rate of the STARM can be varied to control the amount of lift that is induced and, hence, a magnitude of the rotational coupling. In yet other embodiments, the STARM can be both tilted and the rotation rate can be varied to vary lift and a magnitude of rotation coupling. In one embodiment, the STARM can be coupled to a motor where the STARM and motor are tilted as a unit. Similarly, the STARM and motor can be moved linearly as a unit.

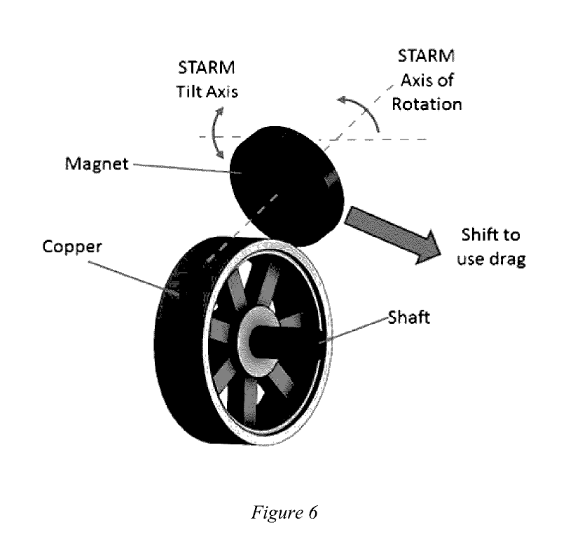

FIG. 6 shows a perspective view of a STARM and wheel. An outer portion of the wheel is formed from copper. The eddy currents are induced in the copper. The wheel is configured to rotate about a shaft. In one embodiment, the shaft can be used to transfer a rotational torque to another device. The axis of rotation of the shaft and the STARM are perpendicular to one another. The magnet configuration is for the purposes of illustration only and magnet patterns, such as those described in detail below, can be utilized.

If it is desirable to use the drag force, then the STARM can be shift relative to the center of the wheel such that there is more drag on side of the wheel as opposed the other side. For example, the STARM can be positioned such that the outer edge of the STARM is aligned with an edge of the wheel where the copper extends below the STARM. Thus, when the STARM is rotated the wheel will turn and a torque is transmitted to the wheel.

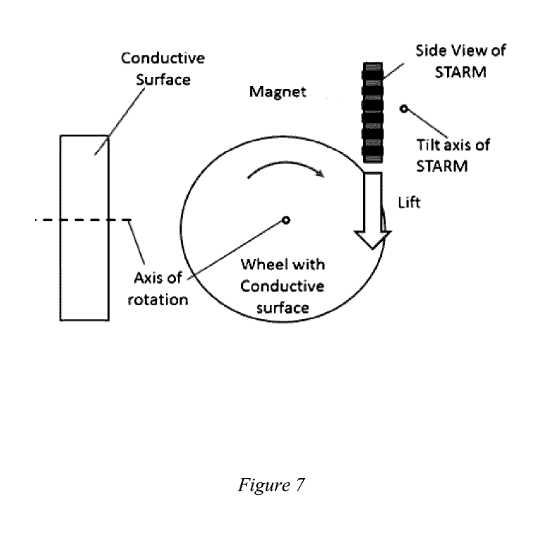

In an alternate embodiment, the lift can be orientated such that it is perpendicular to the axis of rotation of the STARM. An example of this configuration is shown in FIG. 7. In FIG. 7, the magnets are arranged around an outer edge of the STARM and the lift is projected outwards. When the lift force is greater than the drag force, more torque may be produced than using the drag alone.

In an additional embodiment (not shown), the wheel can include flaps or other structures which extend from the wheel. The structures can extend along a normal line from the surface or at an angle to the surface. For example, a paddle wheel or a gear with teeth are two shapes which might be used.

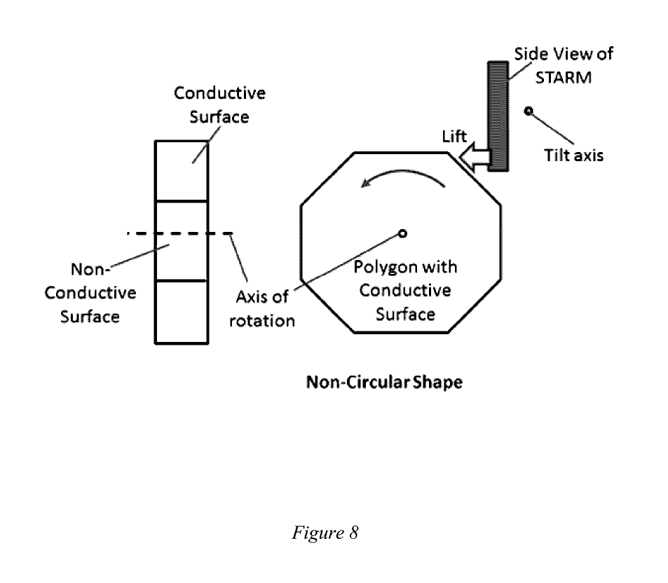

In various embodiments, the object that rotates and includes the conductive material can have any suitable shape, besides a circular shape. In the example shown in FIG. 8, the object is polygonal shaped. In addition, the conductive surface does not have to be continuous over the surface of the object that is rotated. For example, the surface can have portions that are conductive and portions which are not conductive.

In the example of FIG. 8, the STARM is orientated such that the lift vector is perpendicular to the gravity vector. In other embodiments, the lift vector can be orientated to oppose the gravity vector. In this configuration, the STARM can both rotate and lift an object.

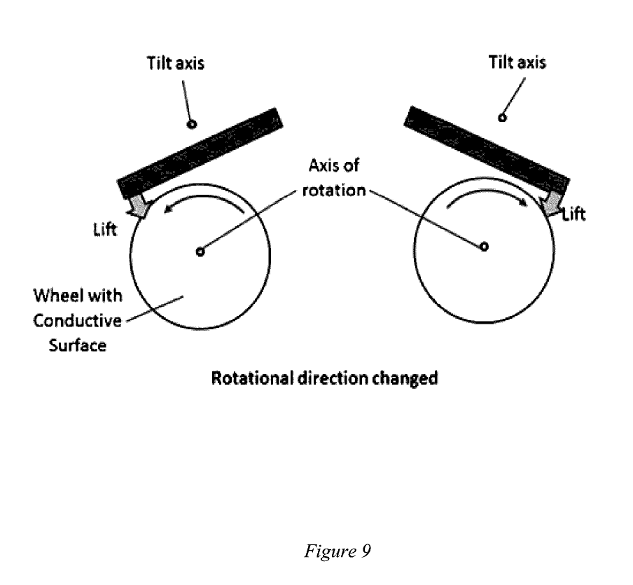

The size of the object, such as the circular object shown in FIG. 9, relative to the STARM can be varied. For example, in FIG. 9, the diameter of the wheel is smaller than the diameter of the STARM. When the STARM is tilted in one direction, it acts on one side of the wheel and induces a rotation in a first direction. When the STARM is tilted in the other direction, it acts on the other side of the wheel and induces a rotation in a second direction opposite the first direction.

### Magnet Configurations

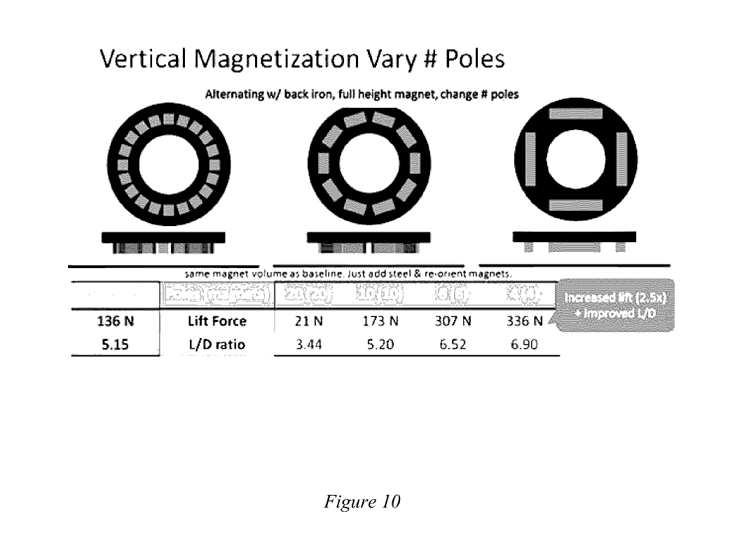

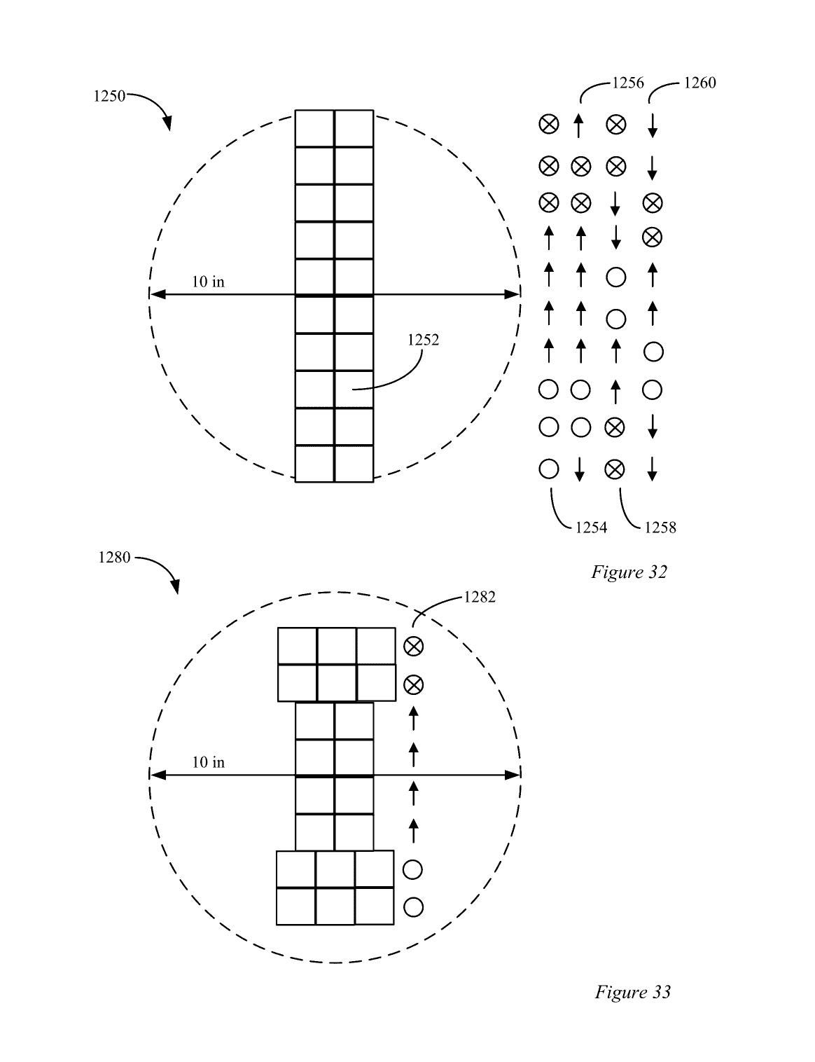

In FIG. 10, a STARM with a magnet configuration with a polarity pattern similar to FIG. 28 is shown. The magnets are adjacent to a washer of steel. In the first example, twenty cubic magnets are used with ten north and south facing poles (into and out of the page) like shown in FIG. 28.

In alternate embodiments, the amount of north and south facing poles is reduced, while the magnet volume and height are held constant. The combination of a fewer number of poles and a back iron provides a prediction of an increased amount of lift and increase in the lift forces relative to the traction forces. In this example, the number of poles is reduced by elongating the magnets from cubes into boxes.

The volume of each magnet in each configuration is the same. However, the volume and number of magnets varies from configuration to configuration as the poles are reduced. In alternate embodiments, magnets of different shapes other than boxes can be utilized. In addition, the volume of each magnet in a particular configuration can vary from magnet to magnet, and the volume of all the magnets can differ in a particular configuration. It is noted that this example is provided for illustrative purposes only.

### Magnetic Lift System Overview

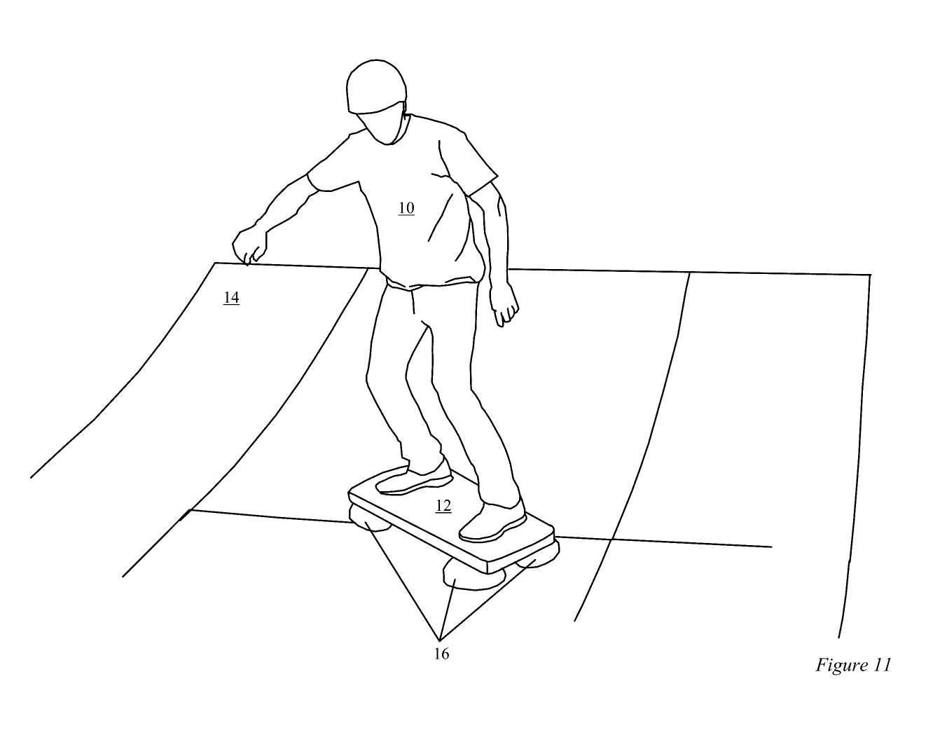

With respect to FIGS. 11 to 14C, some general examples and operating principles of a magnetic lift system are described. In particular, a hoverboard system configured to lift and propel a rider is discussed. The hoverboard system can include a hoverboard having hover engines and a substrate on which the hoverboard operates. The substrate can include a conductive portion in which eddy currents are induced. The electromagnetic interaction between the device which induces the eddy currents and the induced eddy currents can be used to generate electromagnetic lift and various translational and rotational control forces.

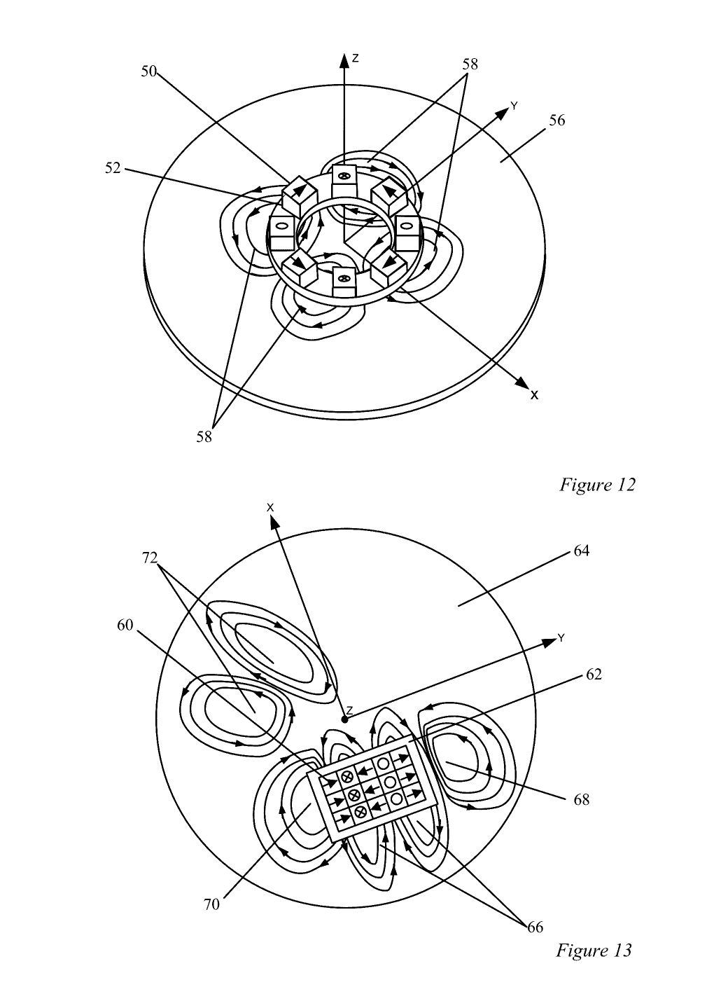

A hoverboard is one example of an electromechanical system which generates forces, such as lift, via an interaction between a moving magnetic field source (e.g., permanent magnets) and induced eddy currents. FIG. 11 is an illustration of a person 10 riding a hoverboard 12. In one embodiment, the hoverboard includes four hover engines, such as 16. The hover engines 16 generate a magnetic field which changes as function of time. The time varying magnetic field interacts with a conductive material in track 14 to form eddy currents. The eddy currents and their associated magnetic fields and the magnetic fields from the hover engine interact to generate forces, such as a lifting force or a propulsive force. Examples of eddy currents which can be generated are described with respect to FIGS. 12 and 13. Lift and drag associated with induced eddy currents is described with respect to FIGS. 4A-4C. Further details of magnet configurations, eddy current patterns, lift predictions and comparison to experimental data are described below with respect FIGS. 28 to 71.

In FIG. 11, the track 14 is formed from copper. In particular, three one eighth inch sheets of copper layered on top of one another are used. Other conductive materials and track configuration can be used. Thus, a track formed from copper sheets is described for the purposes of illustration only. Curved surfaces may be formed more easily using a number of layered thin sheets. For example, a half-pipe can be formed. In FIG. 11, a portion of a half-pipe is shown. The track 14 can include various sloped and flat surfaces and the example of half-pipe is provided for illustrative purposes only.

The thickness of the conductive material which is used can depend on the material properties of the conductive material, such as its current carrying capacity and the amount of magnetic lift which is desired. A particular hover engine, depending on such factors, as the strength of the output magnetic field, the rate of movement of the magnetic field and the distance of the hover engine from the surface of a track, can induce stronger or weaker eddy currents in a particular track material. Different hover engines can be configured to generate different amounts of lifts and, thus, induce stronger or weaker eddy currents.

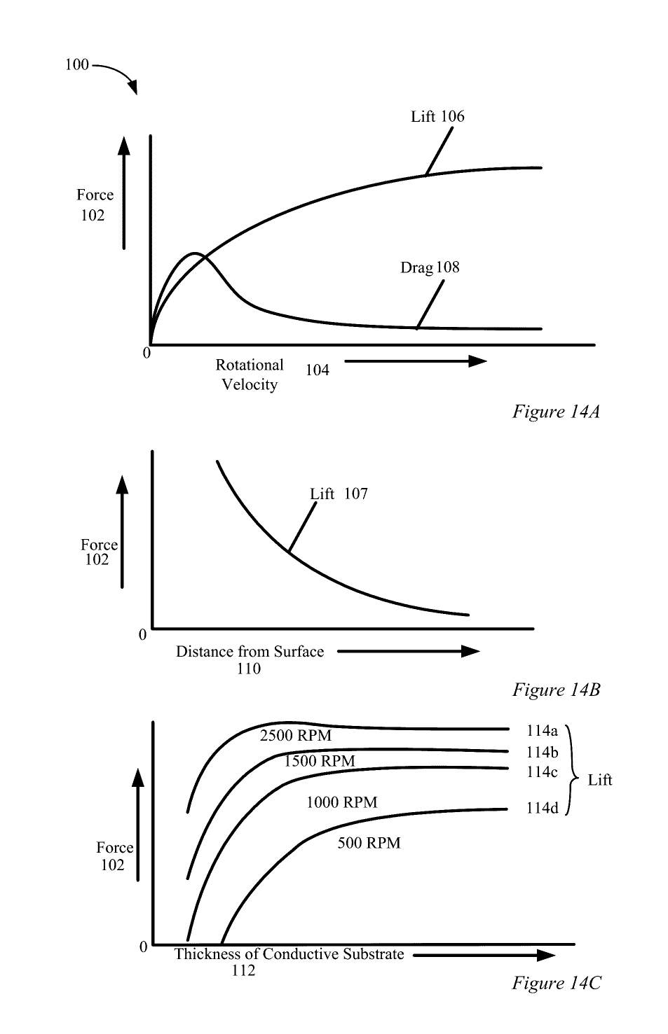

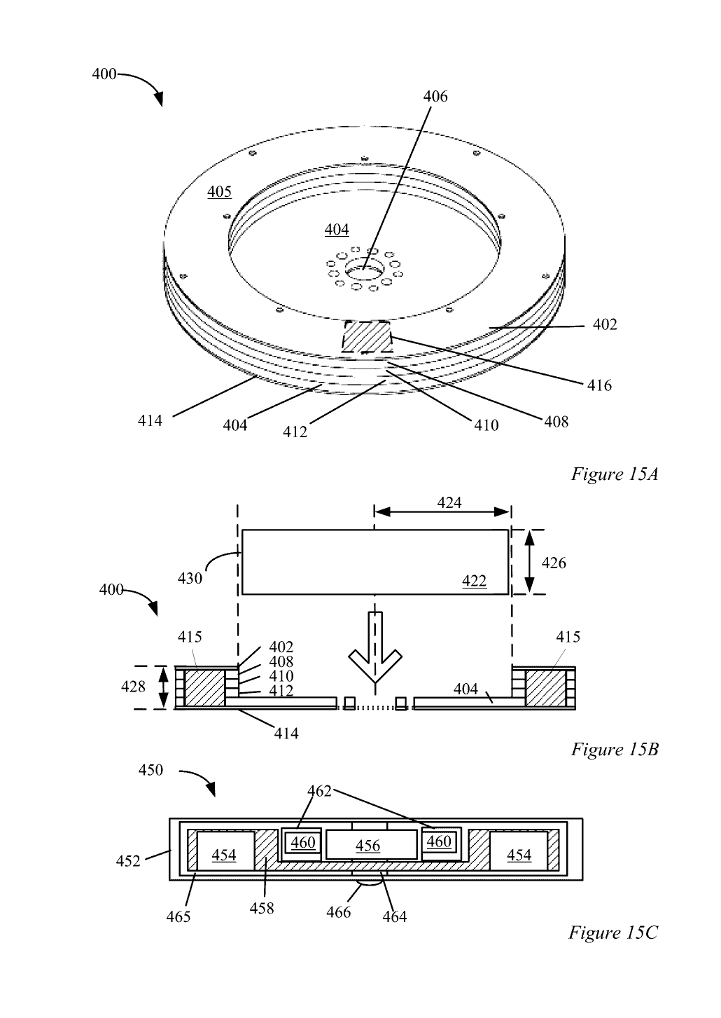

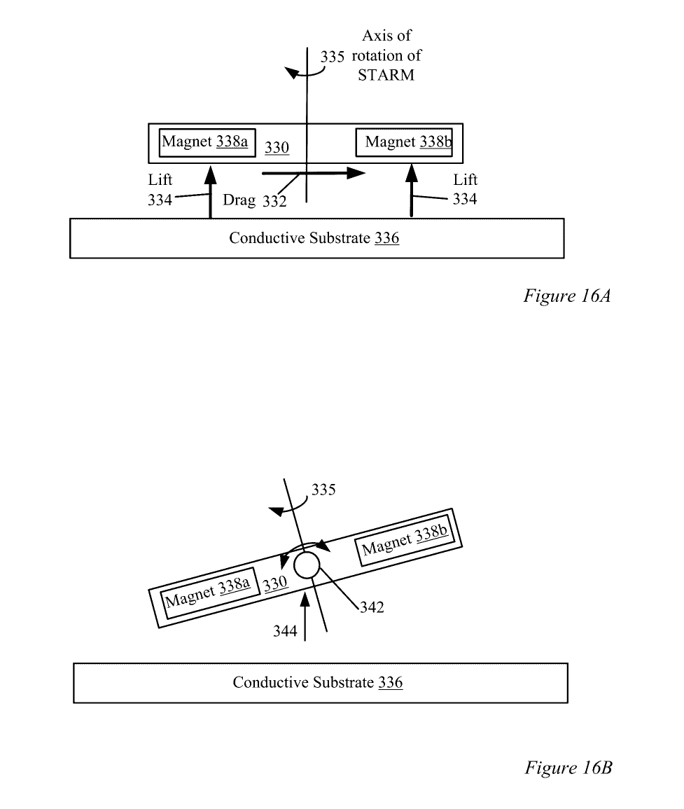

The current density associated with induced eddy currents in the material can be a maximum at the surface and then can decrease with the distance from the surface. In one embodiment, the current density which is induced at the surface can be on the order of one to ten thousand amps per centimeter squared. As the conductive material becomes thinner, it can reach a thickness where the amount of current potentially induced by the hover engine is more than the conductive material can hold. At this point, the amount of magnetic lift output from the hover engine can drop relative to the amount of lift which would be potentially generated if the conductive material was thicker. This effect is discussed in more detail with respect to FIG. 14C.

As the thickness of the material increases, the induced currents become smaller and smaller with increasing distance from the surface. After a certain thickness is reached, additional material results in very little additional lift. For the hover engines used for the hoverboard 12, simulations indicated that using ½ inch of copper would not produce much more lift relative to using ⅜ inch of copper.

For the device shown in FIG. 11, simulations predicted that using only ⅛ inch sheet of copper would significantly lower the lift versus using a half inch of copper. Finite element analysis to solve Maxwell's equations was used. In particular, Ansys Maxwell (Ansys, Inc., Canonsburg, Pa.) was used.

In various embodiments, the amount of copper which can be used varied depending on the application. For example, for a small scale model of a hoverboard configured to carry a doll, a ⅛-inch sheet of copper may be more than sufficient. As another example, a track with a thinner amount of conductive material can lead to less efficient lift generation as compared to track with a thicker amount of a more conductive material. However, the cost of the conductive material can be balanced against the efficiency of lift generation.

A substrate 14 can include a portion which is configured to support induced eddy currents. In addition, it can include portions used to add mechanical support or stiffness, to provide cooling and/or to allow a track portions to be assembled. For example, pipes or fins can be provided which are configured to remove and/or move heat to a particular location. In another example, the substrate 14 can be formed as a plurality of tiles which are configured to interface with one another. In yet another example, the portion of the substrate 14 that is used to support the induced eddy currents may be relatively thin, and additional materials may be added to provide structural support and stiffness.

In various embodiments, the portion of the substrate 14 used to support induced eddy currents may be relatively homogenous in that its properties are substantially homogeneous in depth and from location to location. For example, a solid sheet of metal, such as silver, copper or aluminum can be considered substantially homogenous in it's in depth properties and from location to location. As another example, a conductive composite material, such as a polymer or composite, can be used where the material properties on average are relatively homogeneous from location to location and in depth.

In other embodiments, the portion of the substrate 14 used to support the induced eddy currents can vary in depth but may be relatively homogeneous from location to location. For example, the portion of the substrate 14 which supports the eddy currents can be formed from a base material which is doped with another material. The amount of doping can vary in depth such that the material properties vary in depth.

In other embodiments, the portion of the substrate 14 that supports the eddy currents can be formed from layers of different materials. For example, an electric insulator may be used between layers of a conductive material, such as layers of copper insulated from one another. In another example, one or more layers of a ferromagnetic material can be used with one or more paramagnetic materials or diamagnetic materials.

In yet another example, the surface of the substrate 14 that supports the eddy currents can include a surface structure, such as raised or sunken dimples which affect induced eddy currents or some other material property. Thus, from location to location there may be slight variations in material properties but averaged over a particular area the material properties may be relatively homogeneous from location to location.

In one embodiment, the person can control the hoverboard 12 by shifting their weight and their position on the hoverboard. The shift in weight can change the orientation of one or more of the hover engines 16 relative to the surface of the track 14. The orientation can include a distance of each part of the hover engine from the track. The orientation of each hover engine, such as 16, relative to the surface of the track can result in forces parallel to the surface being generated.

The net force from the hover engines 16 can be used to propel the vehicle in a particular direction and control its spin. In addition, the individual may be able to lean down and push off the surface 14 to propel the hoverboard 12 in a particular direction or push and then jump onto to the hoverboard 12 to get it moving in a particular direction.

Next, a few examples of magnet arrangements, which can be used with a hover engine, are described with respect to FIGS. 12 and 13. FIGS. 12 and 13 are illustrations of eddy currents generated on a conductive plate in response to arrangements of magnets rotated above the plates. The conductive plate is the portion of the substrate that is configured to support induced eddy currents. The eddy currents and associated forces, which would be generated from a particular arrangement, were simulated using Ansys Maxwell 3D (Canonsburg, Pa.). In each of the simulations, an arrangement of magnets is rotated at 1500 RPM at 2 inches height above copper plates 56 and 64, respectively. The copper plates are modeled as ½ inch thick. The plate is modeled as being homogeneous in depth and from location to location. The width and length of the plate is selected such that edge effects that can occur when a STARM induces eddy currents near the edge of the plate are minimal.

The magnets are one-inch cube Neodymium alloy magnets of strength N50, similar magnets can be purchased via K and J magnetics (Pipersville, Pa.). The magnets weigh about 3.6 ounces each. Magnets of different sizes, shapes and materials can be utilized, and this example is provided for the purpose of illustration only.

In FIG. 12, eight one inched cube magnets, such as 50, are arranged with an inner edge about two inches from the z axis. The magnets are modeled as embedded in an aluminum frame 52. The arrow head indicates the north pole of the magnets. The polarities of four of the magnets are perpendicular to the z axis. The open circle indicates a north pole of a magnet and circle with an x indicates a south pole of a magnet. A polarity pattern involving four magnets is repeated twice.

In various embodiments, the polarity pattern of the magnets shown in the figure can be repeated one or more times. One or more magnets of different sizes and shapes can be used to form a volume of magnets which match a polarity direction associated with a polarity pattern. For example, two half inch wide rectangular magnets with a total volume of one cubic inch or two triangular magnets with a total volume of one cubic inch can be aligned in the same direction to provide a polarity direction in a polarity pattern. In the polarity pattern, a magnet with a polarity direction different than an adjacent magnet may touch the adjacent magnet or may be separate from the adjacent magnet.

For a given number of magnets of a particular cubic size, the distance from the z axis of the face of the magnets can be adjusted such that the magnet's edges are touching or are a small distance apart. With this example using eight magnets, an octagon shape would be formed. A configuration of 20 one-inch cube magnets arranged around a circle with the polarity pattern being described below. The inner edge of this arrangement of magnets is about 3.75 inches from the rotational axis.

When the magnets are brought together, the magnitude of the lift and drag that is generated per magnet can be increased relative to when the magnets are spaced farther apart. In one embodiment, trapezoidal shaped magnets can be utilized to allow the magnets to touch one another when arranged around a rotational axis. A different trapezoidal angle can be used to accommodate different total number of magnets, such as four magnets (90 degrees), eight magnets (45 degrees), etc.

A combination of rectangular and triangular shaped magnets can also be used for this purpose. For example, triangular magnets can be placed between the cubic magnets shown in FIG. 12. In one embodiment, the polarity pattern for groups of four trapezoidal magnets or combinations of rectangular and triangular magnets can be similar to what is shown in FIG. 12.

When the arrangement of eight magnets is rotated above the copper plate, eddy currents are induced in the copper. In the example of FIG. 12, the simulation indicates four circular eddy currents 58 are generated. The four eddy currents move in alternating circular directions and are approximately centered beneath the circulating magnets.

An electromagnetic interaction occurs where the circulating eddy currents generate a magnetic field which repels the arrangement of magnets such that lifting forces and drag forces are generated. As described above, the center positions of the eddy currents rotate as the magnets rotate (This rotation is different from the rotation of the circulating current which forms each eddy current). However, the eddy currents are not directly underneath the four magnets aligned with the z axis. Thus, the eddy currents can generate a magnetic field which attracts one of the poles of permanent magnets to which it is adjacent. The attractive force can act perpendicular to the lift to produce drag, which opposes a movement of the magnets. The drag can also be associated with a torque. The drag torque is overcome by an input torque supplied by a motor coupled to the arrangement of magnets.

In a simple example, a current circulating in a circular coil generates a magnetic field that looks like a magnetic field of a bar magnet in which the orientation (north/south) depends on the direction of the current. The strength of the magnetic field that is generated depends on the area of the circular coil and the amount of current flowing through the coil. The coil constrains the locations where the current can flow.

In this example, there are not well defined eddy current circuits. Thus, one eddy current can interact with an adjacent eddy current. This interaction causes the magnitude of the current to increase at the interface between eddy currents such that magnitude of the current varies around circumference of each eddy current. Further, the current also varies in depth into the material with the greatest current per area occurring at the surface and then decreasing in depth in to the surface.

In addition, unlike circuits with a fixed position, the center of the eddy currents rotate as the magnets inducing the currents rotates. Unlike when a magnetic is moved linearly over a conductive material, separate eddy current forms in front of and behind the magnet. In this example, the four poles (magnets with north and south perpendicular to the surface of the plate) are close enough such that the eddy current formed in front of one pole merges with the eddy current formed behind the next adjacent pole. Thus, the number of eddy currents formed is equal to the number of poles, which is four in this example. In general, it was observed for this type of configuration that the number of eddy currents which formed is equal to the number of poles used in the magnet configuration.

Further, material interfaces can affect the induced eddy currents such that an amount of lift and drag that is generated is different near the interfaces, as opposed to away from the interfaces. For example, a surface on which eddy currents are induced can have edges where the material that supports the induced eddy currents ends. Near the boundaries, when a STARM approaches an edge, the eddy currents tend to get compressed, which affects the resultant lift and drag.

In another example, a surface can have interfaces through which there are discontinuities in the conductivity. For example, edges of two adjacent copper sheets used to form a surface may not touch, may partially touch or may be conductively insulated from one another. The discontinuous conductivity can lessen or prevent current from flowing across the interface, which affects the lift and drag generated from the induced eddy currents.

In one embodiment, a substrate which supports induced eddy currents can be formed from a number of sheets which are stacked in layers, such ⅛-inch copper sheets stacked on top of one another. A discontinuity may be formed in one layer where two adjacent sheets meet, such as small gaps between the two sheets, which reduce the current that flows from a first sheet to an adjacent second sheet. The gaps may allow for thermal expansion and simplify the assembly process. To lessen the effect of the discontinuity, adjacent edges between sheets can be staggered from layer to layer. Thus, the discontinuity at particular location may occur in one layer, but not the other adjacent layers.

In some instances, a conductive paste can be used to improve the conductivity between sheets. In another embodiment, adjacent sheets can be soldered together. In yet another embodiment, flexible contacts, which can compress and then expand, can be used to allow current to flow between different sheets.

In FIG. 13, a three row by five column array of one-inch cube magnets, such as 60, is rotated above a copper plate. The arrays could also be using a single magnet in each row. The magnets are modeled as surrounded by an aluminum frame 62. The magnets in this example are configured to touch one another. A magnet pattern for each row of five magnets is shown. In alternate embodiments, a five magnet pattern of open circle, left arrow (pointing to open circle), circle with an “x”, right arrow (pointing away from circle with an x) and open circle can be used. This compares to the left arrow, circle with an “x”, left arrow, open circle and right arrow pattern shown in the Figure.

The magnet pattern is the same for each row and the magnet polarity is the same for each column. In various embodiments, a magnet array can include one or more rows. For example, a magnet array including only one row of the pattern shown in FIG. 13 can be used.

Multiple arrays with one or more rows can be arranged on a rotating body, such that the rotating body is balanced. For example, magnet arrays of two, three, four, etc. arrays of the same number of magnets can be arranged on a rotating body. In another embodiment, two or more pairs of magnet arrays with a first number of magnets and two or more pairs of magnets arrays with a second number of magnets can be arranged opposite one another on a rotating body.

In the example of FIG. 13, two eddy currents, 66, are generated under the magnet array and two eddy currents 70 and 68 are formed ahead and behind the array. These eddy currents move with the array as the array rotates around the plate. As the array is moved over the plate 64, eddy currents, such as 72 spin off. The eddy currents 66, 68 and 70 generate magnetic fields, which can cause magnetic lift and drag on the array. When two of these types of arrays are placed close to one another, the simulations indicated that the eddy current induced from one array could merge with the eddy current induced from the other array. This effect diminished as the arrays were spaced farther apart.

In the examples of FIGS. 12 and 13, the simulations indicated that more lift force was generated per magnet in the configuration of FIG. 13, as compared to the configuration of FIG. 12. Part of this result is attributed to the fact that a portion of the magnets in FIG. 13 is at a greater radius than the magnets in FIG. 12. For a constant RPM, a greater radius results in a greater speed of the magnet relative to the conductive plate, which can result in more lift.

The lift per magnet can be total lift divided by the total magnet volume in cubic inches. For one-inch cube magnets, the volume is one cubic inch. Thus, the total number of magnets is equal to the volume in cubic inches. The use of total lift divided by the magnet volume of a magnet arrangement provides one way of comparing the lift efficiency of different magnet arrangements. However, as noted above, the speed of the magnet relative to the substrate, which is a function of radius and RPM, affects lift and, hence, may be usefully considered when comparing magnet configurations.

In FIGS. 12 and 13, a portion of the magnet poles in the magnet polarity pattern are aligned such that the poles are parallel to an axis of rotation of the STARM (The poles labeled with “x” or “o” in the Figures). When the bottom of a STARM is parallel to a surface that supports the induced eddy currents, the portion of the magnet poles and the axis of rotation are approximately perpendicular to the surface.

In this configuration, to interact with a surface, a STARM can be rotated on its side, like a tire riding on a road, where the axis of rotation is approximately parallel to the surface. In particular embodiments, a mechanism, such as an actuator, can be provided so as to dynamically rotate one or more of the magnet poles (again, “x” and “o” labeled magnets) during operation. For example, the magnet poles shown in FIGS. 12 and 13 may be rotatable such that they can be moved from an orientation where they are perpendicular to the surface as shown in FIGS. 12 and 13 to an orientation where they are parallel to the surface and back again. When the magnets are turned in this manner, the amount of lift and drag that are generated can be reduced. In additional embodiments, fixed magnet configurations can be utilized so that the magnet poles shown in FIGS. 12 and 13 are rotated by some angle between zero and ninety degrees relative to their orientation in the FIGS. 12 and 13.

FIG. 14A includes a plot 100 of lift 106 and drag 108 curves associated with an arrangement of rotating magnets in accordance with certain described embodiments. The curves are force 102 versus rotational velocity 104. The curves can be determined via experimental measurements and/or simulations. It is noted the magnetic lift and drag is separate from any aerodynamic lift and drag that may be associated with the rotation of the magnet arrangement associated with a hover engine.

Although not shown, an amount of torque can be determined and plotted. As shown in FIG. 12, an array of magnets can be radially symmetric. In some instances, such as when a radially symmetric array is parallel to the conductive substrate, the net drag force may be zero. Nevertheless, a torque that opposes the rotation of the array is generated. The rotational input from a motor can be used to overcome this torque.

As shown in FIG. 14A, the magnetic drag increases as velocity increases from zero, reaches a peak, and then starts to decrease with velocity. In contrast, the magnetic lift continues to increase with velocity. The velocity can be the velocity of the magnets relative to the surface, which induces the eddy. When the magnets are rotating, this velocity is the product of distance from the axis of rotation times the angular velocity. The velocity can vary across a face of a magnet as distance from the axis of rotation varies across the face of the magnet.

In various simulations of a magnet configuration shown in FIG. 13, the most drag was observed to occur between 250 and 350 RPM. However, the amount of drag including its peak can depend on such variables as the size and the shape of the magnets, a distance of the magnets from the substrate in which the eddy currents are induced, a speed of the magnets relative to the substrate which changes as a function of radius and a thickness of the substrate, and a strength of the magnets. Also, for an arrangement of a plurality of magnets, the arrangement of their poles and spacing relative to one another can affect both the lift and drag that is generated. Thus, the lift's and drag's value range is provided for the purposes of illustration only.

FIG. 14B is a plot of force 102 associated with an arrangement of rotating magnets as a function of distance 110 from a conductive substrate. In this example, a configuration of magnets similar to shown in FIG. 13 was simulated. The plot is based upon a number of simulations at a constant RPM. The lift force 107 appears to follow an exponential decay curve as the distance from the surface 110 increases.

FIG. 14C is a plot of lift curves associated with an arrangement of rotating magnets as a function a thickness of a conductive substrate and RPM. In this example, a configuration similar to what is shown in FIG. 13 was used. The conductive substrate is copper and thickness of the copper is varied between 0.05 and 0.5 inches in the simulation.

The simulations predicted that the amount of generated lift increases before a certain threshold thickness of copper is reached and is relatively constant above the threshold. The location of the threshold varies as a function of RPM. It may also vary according to the magnet configuration. In one simulation, negative lift was predicted, i.e., an attractive force was generated when the thickness was thin enough.

### Hover Engine Example

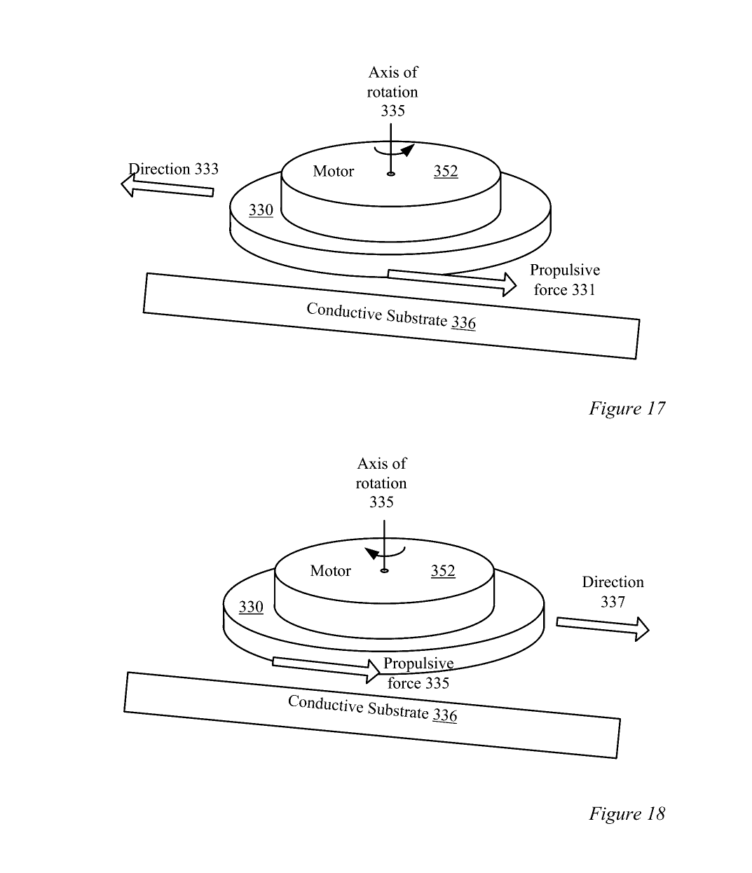

Next, an example hover engine is described with respect to FIGS. 15A-15C. FIG. 15A is a perspective view of a STARM 400. The STARM 400 is 10 inches in diameter. In various embodiments, the STARMs used on a device, such as a hoverboard can be between four and fourteen inches in diameter. However, for other devices, larger or smaller diameter STARMs may be used.

Generally, the size of the STARM will depend on the volume of magnets to be accommodated and the arrangement of magnets used. As will be described in more detail below, different magnet configurations allow for and require different packaging schemes. The total volume of magnets that are used will depend on a desired maximum payload weight to be lifted and an operating height. Once, the total volume of magnets is determined, it can be distributed among one or more hover engines in selected configurations. Based upon the volume of magnets used in a hover engine and a selected magnet configuration, i.e., the distribution of the magnet volume on the STARM and polarity directions utilized, appropriate motors needed to rotate the STARM can be selected where a motor may turn one or more STARMs. As an example, the volume of magnets on a hoverboard, which can be distributed among one or more STARMS, can be between thirty and eighty cubic inches.

In general, various ratios of motors to STARMs can be utilized in a hover engine. For example, a hover engine can include one motor which turns one STARM. As another example, a hover engine can include one motor that drives two or more STARMs. In another example, a hover engine can include two motors that drive one STARM. In general, one or more motors can be paired with one or more STARMs where the number of motors can be less than equal to or greater than the number of STARMs. Thus, the example of a hover engine including one motor and one STARM is provided for the purposes of illustration only and is not meant to be limiting.

Returning to FIG. 15A, the STARM includes a raised outer ring 405. A distance from a bottom of the STARM 400 to a top of the outer ring is about 1.13 inches. This height allows one inch cubed magnets to be accommodated. In one embodiment, 20 one-inch cube magnets are arranged within the outer ring. To accommodate more cubic magnets arranged in a circle, such as four more magnets to provide an additional repetition of the polarity pattern, a larger outer ring can be used. Using less cubic magnets, a smaller radius may be employed. Different shaped magnets and different polarity patterns can allow for different packaging schemes. Thus, this example, where the magnets are arranged in a ring is provided for the purposes of illustration only and is not meant to be limiting.

In one embodiment, the STARM 400 including the outer ring 405 can be formed from a number of layers, 402, 408, 410, 412, 404 and 414, from top to bottom, respectively. Layers 402 and 414 form a cover over the top and bottom portions of the magnets in the outer ring. In one embodiment, layers 402 and 408 are about 0.065 of an inch thick. In alternate embodiment, one or both of layers 402 and 408 can be eliminated. In one embodiment, the top and bottom layers can be formed from a material such as aluminum. In another embodiment, the top layer 402 can be formed from a material with magnetic properties, such as mu-metal, iron or nickel.

Layers 408, 410, 412, 404 each include twenty apertures to accommodate twenty magnets. More or less magnets and, hence, more or less apertures can be utilized, and this example is provided for illustrative purposes only. The total thickness of the layers is one inch and each layer is 0.25 inch thick. In one embodiment, two layers are formed from polycarbonate plastic and two layers are formed from aluminum. The polycarbonate plastic can reduce weight. In various embodiments, the thickness of each layer, the material used for each layer, and the number of layers can be varied. For example, different metals or types of plastics can be used. As another example, a single material can be used for each of the layers.

When the layers are aligned, the one-inch cube magnets can be inserted through the layers. For different shaped or different size magnets (such as rectangular shaped magnets, trapezoidal shaped magnets or 1.5 cubic inch magnets) a different aperture shape or size can be used. In one embodiment, an adhesive can be used to secure the magnets in place, such as super glue. When secured, the bottoms of the magnets are approximately flush with the bottom of layer 404. This feature can maximize the height between the bottom of the magnets and the substrate when a vehicle using the STARM design 400 is hovering.

One or more layers can include apertures, such as 416, that allow fasteners to be inserted. The fasteners can secure the layers together. In another embodiment, an adhesive can be used to secure one or more of the layers to one another. In alternate embodiment, the layers 404, 408, 410 and 412 can be formed as a single piece.

FIG. 15B is a side view of STARM 400 with an embedded motor 422. The cross sections of two magnets, 415, are shown within the outer ring 405. The tops of the magnets 416 are flush with the outer top of layer 408 and the bottom of the magnets is flush with the bottom of layer 404. In various embodiments, the STARM 400 can be configured to receive magnets between 0.5 and 2.5 inches of height.

In one embodiment, the top of the magnets may extend above the top of layer 408. Thus, the outer ring 405 may only extend partially up the sides of each magnet. This feature may allow the magnets to be secured in place while reducing weight.

In alternate embodiments, using different magnet configurations, the magnets may be positioned beneath the motor. Further, the motor does not necessarily have to be directly above the STARM 400. For example, a belt, gearing or some other torque transmission mechanism may be used to place the motor to the side of the STARM 400. Further, in some embodiments, a motor may drive multiple STARMs. In addition, the motor rotational axis and the axis of rotation of the STARM can be in a position that is non-parallel to one another. For example, the motor rotational access can be angled to the axis of rotation of the STARM, such as perpendicular to the axis of rotation. Then, a belt and/or gearing system can be used to transfer and change the direction of the torque output from the motor.

The inner radius 424 of the outer ring 405 is greater than a radius of the motor 422. Thus, the motor can be inserted within the outer ring and secured to layer 404 such that the STARM 400 can be rotated when the motor is operated. Thus, the outer ring extends along the side 430 of the motor. An advantage of mounting the motor in this manner is that the overall height profile of the hover engine may be reduced as compared to mounting the motor 422 at a height above the top of the outer ring.

In various embodiments, the height 428 of the outer ring may be less than the height of the motor 426, such that the outer ring extends partially up the side 430 of the motor 422. In another embodiment, the height 428 of the outer ring 405 can be approximately equal to the height of the motor. In yet another embodiment, the height 428 of the outer ring can be greater than the height of the motor. In another example, the height of the outer ring can be less than the height of the motor.

It may be desirable to increase the height 428 to accommodate taller magnets. Taller magnets may be used to increase the amount of magnetic lift that is generated when the magnets, such as 415, are at a greater distance from a substrate. The volume of a magnet including its height can affect the strength of the magnetic field at a particular distance that extends from a magnet.

In various embodiment, a trade-off can be made between the distributing the magnets over a greater height range or over a greater area on the bottom of the STARM. For given volume of magnets, the foot print on the bottom of the STARM can be reduced by using taller magnets. Reducing the foot print may allow a smaller radius STARM to be used. However, a height of the hover engine may be increased.

Alternatively, the volume of magnets can be spread out over a larger area to provide a larger foot print of magnets on the bottom of the STARM. The larger foot print allows the maximum height of the magnets to be reduced and possibly allows the maximum height of the hover engine to be reduced. However, a larger foot print may require a STARM with a larger radius.

The motor, such as 422, used to rotate a STARM can be electric or combustion based. In general, any type of motor that outputs a suitable amount of torque can be used. An electric motor requires a power source, such as battery or a fuel cell, to supply electricity. A combustion motor requires a fuel which is combusted to operate the motor. Battery types include but are not limited to batteries with a lithium or zinc anode, such as lithium ion, lithium polymer or a zinc-air system.

An electric motor can be configured to output torque about a rotational axis. The electric motor can include a configuration of wire windings and a configuration of permanent magnets. Current is provided through the windings to generate a magnetic field which varies as a function of time. The magnetic field from the windings interacts with magnetic field from the permanent magnets to generate a rotational torque. AC or DC motors can be utilized, such as an induction motor or a DC brushless motor.

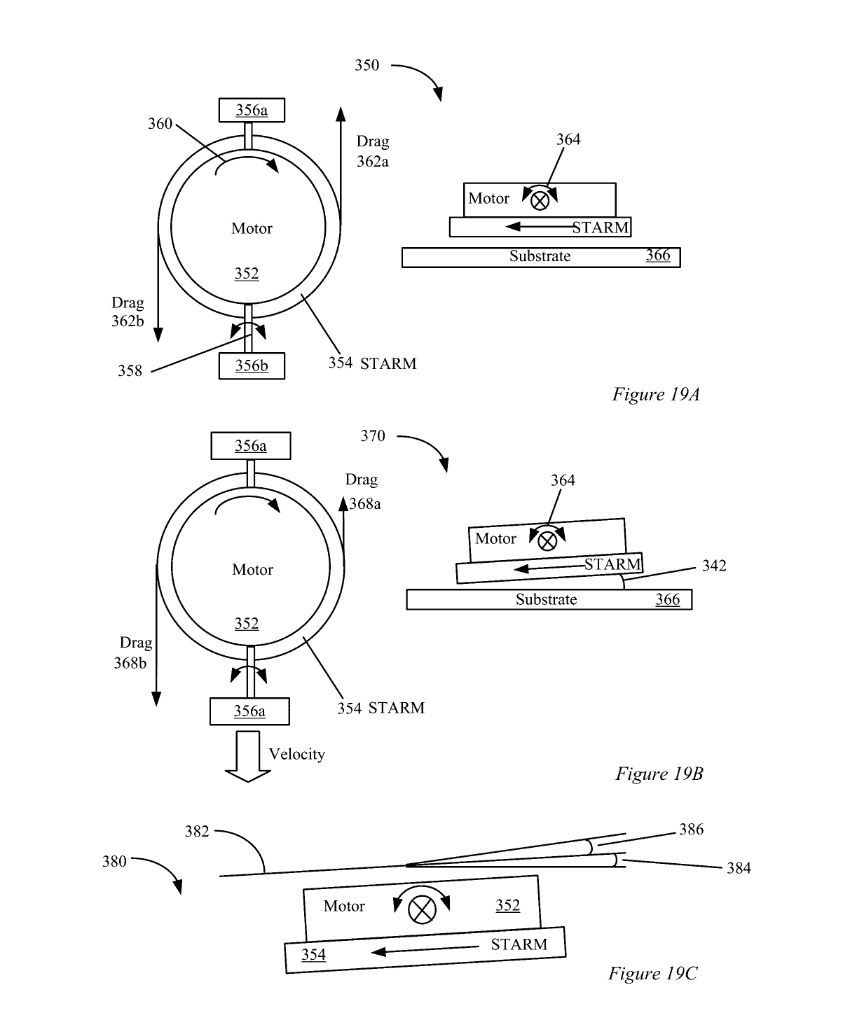

In various embodiments, the windings can be configured to rotate while the magnets remain stationary or the magnets can be configured to rotate while the windings remain stationary. An interface, such as a shaft, can be provided which couples the rotating portion of the motor to the STARM 400. In FIG. 16A, the STARM 400 is configured to interface with the motor at 406.

The non-rotating portion of the motor 422 can be integrated into a motor housing which surrounds the magnets and the windings. The motor housing can include an interface which enables it to be attached to one more structures associated with a device. In another embodiment, the non-rotating portion of the motor can include an interface which allows it to be directly attached to one or more structures associated with the magnetically lifted device.

In a particular embodiment, the core of the motor 422 can be stationary where both the magnets associated with the motor and the magnets associated with the STARM rotate around the stationary core. One non-rotating support structure can extend from the core which allows the motor and STARM to be coupled to the device. A second non-rotating support structure can extend from the core which provides support to a portion of a shroud which is interposed between a bottom of STARM and the substrate which supports the induced eddy currents (see FIG. 15C).

The arrangement of magnets in the motor 422 can include poles that are substantially perpendicular to the axis of rotation of the motor (often referred to as a concentric electric motor) or can include poles that are substantially parallel to the axis of rotation of the motor (often referred to as an axial electric motor). In one embodiment, a winding configuration, such as the winding configuration associated with an axial motor, can be used to induce eddy currents in a substrate. In these embodiments, there are no rotating parts and the STARM and the magnets associated with an electric motor are eliminated. As part of a hover engine, the windings can be tilted relative to a device to generate control forces in a manner previously described herein.

In yet another embodiment, the magnets associated with the motor 422 can be removed and a motor winding can be designed which interacts directly with the magnets in the STARM. For example, a winding can be placed above magnets 415 to interact with the magnetic flux above the magnets, or a winding can be placed around the outside of magnets 415 or around the inside of magnets 415. A current applied to the winding can cause the STARM to rotate. As described herein, rotation of the STARM can cause eddy currents to be induced in a portion of a substrate.

As an example, the motor 422 can include an outer ring configured to rotate. The STARM 400 can be mounted to the outer ring of the motor 422, instead of to a shaft extending from the center of the motor. This type of motor design can be referred to as an outboard design. This feature may allow the portion of layers 404 and 412 within the inner radius 424 of the outer ring 405 to be removed such that the bottom of the motor is closer to the bottom of the outer ring 405. One advantage of this approach is that the overall height of the STARM 400 and motor 422 may be reduced.

In a particular embodiment, the outer ring 430 of the motor and the outer ring 405 of the STARM may be formed as an integrated unit. For example, the outer ring of the motor 422 can have a layer extending outwards from the motor's side 430. The layer extending from the side 430 can include a number of apertures through which magnets can be inserted. Optionally, one or more layers with apertures, such as layers 408, 410 and 412, can be placed over the magnets.

In general, in a hover engine, the support structures associated with the STARM, the stator of the motor, the shroud, and housing can be integrated with one another. For example, an enclosure for the motor and STARM can include an integrated shroud. In another example, the structure forming the rotor for the motor can be integrated with the structure for the STARM. In another example, all or a portion of the structure forming the stator of the motor can be integrated with a housing and/or shroud associated with the hover engine.

FIG. 15C is a side view of a hover engine 450 having a STARM 465 integrated with a motor in accordance. The hover engine 450 includes a stationary core 456 with windings configured to interact with and rotate magnets 460. The core is attached to the support structure 464. The support structure 464 can provide a first interface to attach the hover engine to a hoverboard. In addition, the support structure 464 can be coupled to a housing 452 that surrounds both the motor and the STARM 465. The support structure 464 may be used to help maintain a gap between the bottom of the STARM 465 and the housing 452.

In one embodiment, a small protuberance 466 may be provided at the bottom of support structure 464. The small protuberance 466 can be formed from a metal or a material with a low friction coating, such as a Teflon coated material. The small protuberance can provide a small stand-off distance when the hover engine is near the ground, such as during take-off and landing. It can help prevent the STARM 465 from impinging the ground. In particular embodiments, the protuberance 466 can be coupled to a portion of the hover engine which rotates or a portion which remains static during operation. In alternative embodiments, more than one protuberance may be provided at the bottom of the support structure 464.

The STARM 465 includes a structure 458 surrounds the magnets 454. As described above, the structure 462 surrounding magnets 460 and the structure 458 surrounding magnets 454 can be formed as a single piece. The magnets 454 and 460 may be shaped differently and have different sizes relative to one another.

In various embodiments, bearings (not shown) can be provided between the support structure 464 and the structure 458 to allow the STARM 465 to rotate about the stationary core. In lieu of or in addition to bearings between the STARM structure 458 and the support structure 464, bearings can be provided at one or more locations between the housing 452 and the structure 458. For example, bearings may be placed between the bottom of the STARM 465 and the housing 452 to help maintain the spacing between the housing 452 and the STARM 465 on the bottom of the STARM. In another example, a bearing may be placed between the side of the STARM and the side of the housing 452 to maintain the spacing between the inner side of the housing 452 and the side of the STARM.

In one embodiment, the height of the hover engine can be less than three inches. In another embodiment, the height of the hover engine can be less than two inches. In yet another embodiment, the height of the hover engine can be less than one inch. The magnets are packaged between a top and a bottom height of the hover engine. Thus, in each of these examples, the maximum height of the magnets will be at most the same as the height of the hover engine. Typically, the maximum height of the magnets will be less than the height of the hover engine.

### Magnetic Lift and Propulsion

Next, some details involving propulsion of a vehicle including one or more STARMs are described. In particular embodiments, an orientation of one or more STARMs relative to a substrate can be used to generate propulsive and/or control forces. Other mechanisms of propulsion are possible, alone or in combination with controlling the STARM orientation to generate propulsive and directional control forces. Thus, these examples are provided for the purpose of illustration only and are not meant to be limiting. For example, as described above, the rotation rate of one or more STARM can be varied to provide yaw control.

In FIG. 16A, a STARM 330 is shown in a neutral position. The STARM includes magnets, such as 338a and 338b. In the neutral position, the lifting forces 334 on average over time are equal across the bottom surface of the STARM 330. Further, the net drag forces 332 acting on the STARM 330 are balanced (While rotating, the STARM generates a magnetic field which is moved through the conductive substrate 336. The eddy currents formed in the substrate as a result of the moving magnetic field resist this movement, which can act as a drag force 332 on the STARM 330). With lift and drag balanced, the STARM 330 will substantially remain in place over the conductive substrate.

Small imbalances may exist, which cause the STARM to move in one direction or another. For example, local variations in material properties in the conductive substrate 336 can cause small force imbalances. As another example, the dynamic vibration of the STARM 330, such as from adding or removing loads can cause small force imbalances. However, unless the small force imbalances are biased in a particular direction, the STARM will remain relatively in the same location (i.e., it might move around a particular general location in some manner).

If the rotational momentum is not balanced, the STARM may rotate in place. A vehicle can include multiple STARMs which are counter rotating to balance the rotational forces. Further, as will be described below in more detail, the orientation of a STARM can be controlled to generate a moment around a center of mass of a vehicle, which allows the rotation of a vehicle to be controlled.

FIG. 16B shows the STARM 330 in a tilted position. The STARM 330 has been rotated around an axis 342 which is perpendicular to the axis of rotation 335 of the STARM 330. When the STARM 330 is tilted, more drag is generated on the side of the STARM 330 closest to the substrate 336. As is described in more detail below, the drag typically increases when the magnets are brought closer to the substrate. The drag imbalance on the different sides of the STARM causes a thrust to be generated mostly in the direction of the tilt axis 342, i.e., into or out of the page. For some magnet and system configurations, the lift 344 can remain relatively constant or even increase as a function of tilt angle, i.e., lift 344 can be greater than lift 334. The amount of thrust may increase when the tilt angle is first increased. The amount of tilt that is possible can be limited to prevent the STARM 330 from hitting the substrate 336.

FIG. 17 shows an example of a hover engine including STARM 330 and motor 352 climbing an inclined substrate 336. The hover engine is tilted to generate a propulsive force 331 which moves the hover engine in direction 333 up the inclined surface. In one embodiment, the magnitude of the propulsive force 331 can be sufficient for a hover engine to lift a payload in a vertical direction. For example, the conductive substrate 336 can be aligned vertically and the hover engine can be configured to climb vertically and carry its weight and a payload up the wall.

FIG. 18 shows an example of a hover engine braking as it descends down an incline. In FIG. 18, the hover engine, which includes motor 352 and STARM 330, is moving down a sloped substrate in direction 337. The hover engine is outputting a propulsive force 335, which is pushing the hover engine up the incline opposite the direction of movement 337. The braking force slows the descent of the hover engine down the inclined substrate. In a particular embodiment, a hover engine can be configured to output a sufficient force to allow it to hold its position on an inclined surface, i.e., the force output from the hover engine balances the gravitational forces. In general, hover engines can be configured to output forces in a direction of movement for propulsion or opposite the direction of movement for braking.

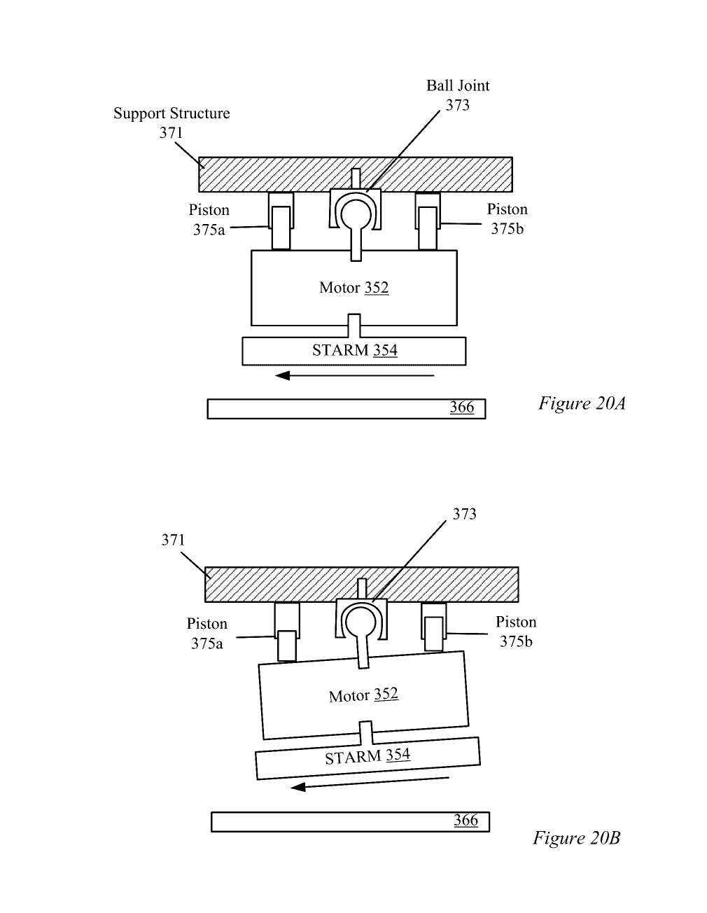

FIGS. 19A, 19B and 19C are block diagrams which are used to discuss more details associated with hovering and propulsive effects from rotating arrangements of magnets used in a hover engine. In FIG. 19A, a hover engine includes a motor 352 coupled with a STARM 354 and a rotatable member 358. The rotatable member 358 is coupled with anchors 356a and 356b. The combination of the rotatable member 358 and the anchors 356a and 356b can be configured to constrain a range of rotation of the rotatable member. For example, the rotatable member 358 may be allowed to rotate through some angle range 364 around its axis.

The rotatable member 358 can be configured to receive and input torque from some mechanism. For example, in one embodiment, a mechanical linkage can be provided which allows a user to supply a force. The force can be converted into torque which causes the rotatable member 358 and, hence, the motor 352 and the STARM 354 to rotate.

In another embodiment, an actuator can be used to supply the torque to rotate rotatable member 358. An actuation of the actuator can cause the motor 352 and STARM 354 to tilt relative to the substrate 366. The actuator can include a servo motor which receives control commands from a controller. In one embodiment, the actuator can include its own controller which receives control commands from a separate processor, which is part of the control system.

In yet another embodiment, a hover engine can be configured to receive an input force from a user and can include an actuator. The actuator can be used to change a position of the STARM, such as returning it to a designated position after a user has tilted it. In another operation mode, the actuator can be used to provide automatic control around some tilt position initiated by user via an input force.

It yet another embodiment, the actuator can be used to provide automatic controls that may be used to correct a control input from a user. For example, if the control system detects the magnetically lifted device is in an unstable position as a result of a user input, the control system can control one or more STARMs to prevent this event from remaining in an unstable position (or going to such position). A magnetic lifting device, such as hoverboard, can include one or more on-board sensors used to make these corrections.

A magnetically lifted device may also include one or more weight sensors for determining a weight distribution of a payload. The weight distribution associated with the device and payload can affect the response of the device in response a command to change an orientation of the device via some mechanism, such as a tiltable hover engine. For example, the weight distribution associated with a payload can affect the magnitude of rotational moments. Thus, knowledge of the weight distribution may be used to more finely tune the commands used to control the orientation of the STARM, such as selecting which STARM to actuate and an amount to actuate it.

When the STARM 354 and motor 352 are rotating, a rotation of the rotatable member 358 changes the angular momentum of the STARM and the motor. Such rotation can also change the magnetic forces acting on the STARM 354 as the magnetic forces vary with the distance of the magnets in the STARM 354 from the substrate 366. Therefore, the amount of torque needed to rotate the member 358 can depend on the moment of inertia associated with the STARM 354 and motor 352, how fast the STARM 354 and motor 362 are spinning, and the height of the STARM 354 above the substrate 366. The height of the STARM above the substrate can depend on 1) its rotational velocity, which affects how much lift is generated, 2) a payload weight, and 3) how the payload weight is distributed on the device. The height of the STARM above the substrate can vary for different portions of the STARM and from STARM to STARM when a device includes multiple STARMs.

In the example of FIG. 19A, the STARM 354 is approximately parallel to the substrate 366. The magnetic drag, such as 362a and 362b, opposes the rotation of the STARM 354. The motor 352 is configured to rotate in the clockwise direction 360. Thus, the drag torque is in the counter clockwise direction. Power is supplied to the motor 352 to overcome the drag torque.

When the STARM is parallel to the substrate 366, the magnetic drag is balanced on all sides of the STARM 354. Thus, there is no net translational force resulting from the magnetic drag.

As is described with respect to FIG. 16B, a net translational force is generated when the STARM 354 and its associated magnets is tilted relative to the substrate. In FIG. 19B, the STARM 354 is in a titled position 370. Thus, one side of STARM 354 is closer to the substrate 366, and another side of the STARM 354 is farther away from the substrate 366. The magnetic interaction between the magnets in the STARM 354 and substrate decreases as a distance between the magnets in the STARM and substrate 366 increases (As shown in the Figures below, the magnitude of the interactions vary non-linearly with the distance from the substrate.) Thus, in tilted position 370, the drag force 368b is increased on one side of the STARM 354 and the drag force 368a is reduced on the opposite side of the STARM 354 as shown in FIG. 19B. The drag force imbalance creates traction, which causes a translational force to be generated approximately in the direction of the axis of rotation of the rotational member 358.

When the STARM 354 is initially tilted, the translational force can result in an acceleration of the STARM 354 in the indicated direction and, hence, a change in velocity in the indicated direction. In particular embodiments, with one or more STARMs configured to generate translational forces, a device can be configured to climb. In another embodiment, the device may be configured to maintain its position on a slope while hovering such that the gravitational forces acting on the device are balanced by the translational forces generated by the device and its associated hover engines.

A configuration and operational mode where a position of a device, such as a hoverboard, is maintained on a sloped substrate may be used as part of a virtual reality system where a user wears a virtual reality headset. Via the headset, the user may only see images generated by the headset or may see images generated by the headset in conjunction with the local surrounding visible to the user. A virtual reality headset may be used to generate images of a user moving through some terrain, likes a snowy slope, while the hovering device on which the user is riding moves side to side and forward and back on the sloped substrate. The sloped substrate may provide the user with the feeling of moving on a tilted slope while the virtual reality images may provide the visual imagery associated with movement. Fans may be used to add an additional sensation of movement (e.g., the feeling of wind on the user's skin).

The device can have sufficient propulsive ability to allow it to hold its position on the slope against the force of gravity. For example, the device can be moved side to side while it maintains its position on the slope. Further, the device may be able to move downwards on the slope and then climb upwards on the slope against gravity. In some instance, the climbing can be done while the device's orientation remains relatively unchanged, i.e., the device does not have to be turned around to climb. This maneuver can be accomplished by changing an orientation of the hover engines relative to the substrate which supports the induced eddy currents. These control functions will be discussed in more detail as follows.

Returning to FIGS. 19A and 19B, the amount of tilt in a particular direction can affect the amount of force imbalance and, hence, the magnitude of the acceleration. Because the magnetic drag is a function of the distance of the magnets from the substrate, the magnetic drag increases on the side closer to substrate and decreases on the side father away from the substrate. As the magnetic forces vary non-linearly with the distance of the magnets from the surface, the amount of translational forces that are generated may vary non-linearly with the tilt position of the STARM.

After a STARM 354 (or both the STARM 354 and motor 352) has been rotated via member 358 in a counter clockwise direction and the STARM has started translating in a first direction, an input torque can be provided which tilts the STARM in a clockwise direction to reduce the amount of translational force which is generated by the STARM. When the STARM is tilted past the horizontal in the clockwise direction, the STARM may generate a translational force that is in an opposite direction of the first direction. The translational force opposing the direction of motion can slow the STARM and bring it to rest. If desired, the translational force can be applied such that the hoverboard stops and then the STARM can begin to translate in an opposite direction.

FIG. 19C is a side view of a hover engine 380 coupled to a tilt mechanism in a tilt position. The hover engine includes a motor 352 and a STARM 354, which can be positioned over the substrate 366. In one embodiment, the mechanism can include a minimum tilt offset angle 384. The minimum tilt offset angle 384 in this example is between the horizontal and line 382. The tilt range angle 386 is the angle amount through which the hover engine may rotate starting at the minimum tilt offset angle 384. The tilt mechanism can include one or more structures which constrain the motion of the tilt mechanism to the tilt angle range.

When the minimum tilt offset angle 384 is zero and the STARM 354 is parallel to the substrate 366, the STARM 354 may not generate a net translation force. A device to which a STARM is coupled can be tilted. Therefore, the angle of the STARM relative to the substrate can depend on the orientation of the STARM relative to some reference system associated with the device and the orientation of the device relative to the substrate where both orientations can change as a function of time. Thus, in some instances, a translation force can be generated even when the minimum tilt offset is zero. When the minimum tilt offset angle is greater than zero, the STARM may generate a net translational force at its minimum position in a particular direction. When the minimum tilt offset angle is less than zero, then the magnitude of the force may be go to zero and the direction of the force which is generated can also change within the tilt angle range.

In some embodiments, the net minimum force generated by one hover engine can be balanced in some manner via translational forces associated with other hover engines. For example, as shown, two hover engines can be tilted to generate forces in opposite directions to cancel one another. Thus, although the net force for a single hover engine may be greater than zero at its minimum tilt offset angle position, it can be balanced by forces generated from another STARM such that the net force acting on the device is zero.

The forces that are generated from a tilted STARM can vary non-linearly with angle of the hover engine relative to the substrate. Thus, the change in force that is generated as a function of a change in angle can vary non-linearly. By utilizing a minimum tilt angle offset, the hover engine can be configured to output more or less force in response to a change in a tilt angle over a selected tilt angle range. In this manner, the control characteristics of the device can be adjusted.

In one embodiment, the tilt mechanisms can include an adjustable tilt offset mechanism that allows the minimum tilt offset angle to be manually set. For example, a rotatable member with a protuberance can be provided where the protuberance is configured to impinge on a screw at one end of its range of rotation. As the screw is unscrewed, the range of rotation of the rotatable member can be decreased and the minimum tilt offset angle can be increased and vice versa. Using the adjustable tilt offset mechanism, a user or operator may be able to manually adjust the handling characteristics of the device.

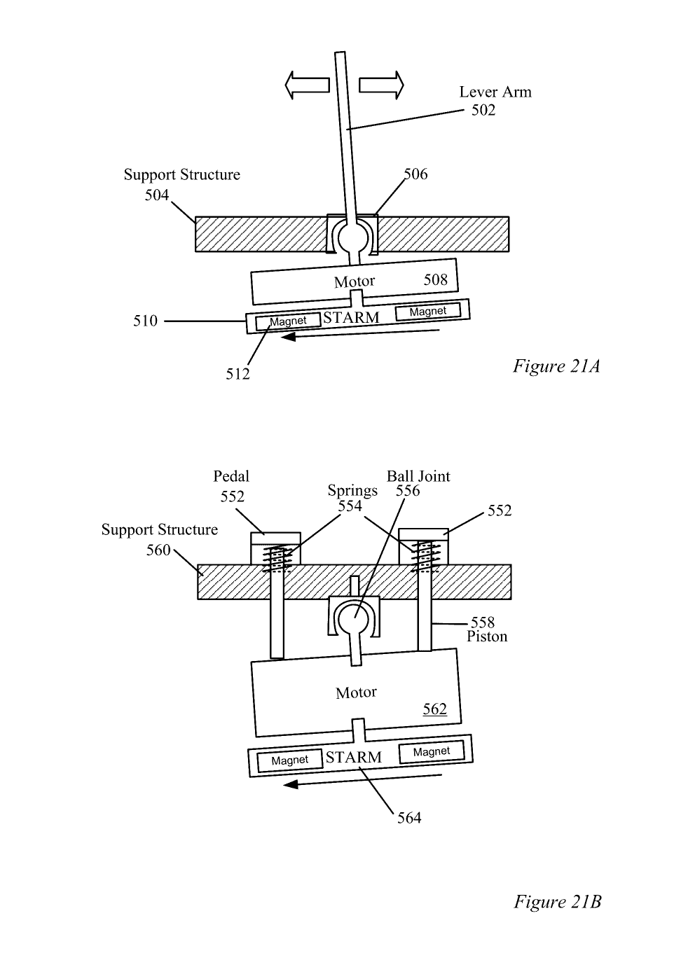

Next, another example of a STARM which can be tilted through multiple degrees of freedom is described. In FIG. 20A, hover engine including a STARM 354 coupled to a motor 352 is shown. The hover engine is coupled to a support structure 371 via a ball joint 373. Two pistons, 375a and 375b, are shown, which are coupled to the hover engine and the support structure 371. The pistons, 375a and 375b, can be used to push the hover engine downward and change a tilt angle of the STARM 354 relative to a substrate 366. A plurality of different pistons can be used to tilt the motor in a plurality of different directions. Other types of actuators can be used which generate a downward force on the hover engine to tilt the STARM 354, and the example of a piston for the purposes of illustration only.

In FIG. 20B, a first piston 375a is shown extended downwards, which tilts the motor 352 and STARM 355 downwards on one side. To bring the motor 352 back to a horizontal position, the second piston 375b can be extended downwards, which causes the first piston to shorten 375a. To tilt the motor 352 and STARM 354 in the opposite direction, the second piston 375b can be extended a greater amount, which forces the first piston to shorten 375a. In various embodiments, multiple pairs of pistons can be used to tilt the motor in different directions and change a direction in which a force is generated as a result of tilting the STARM. The pistons can be coupled to the motor and/or the support structure via an appropriate joining mechanism that may possess some rotational degrees of freedom.

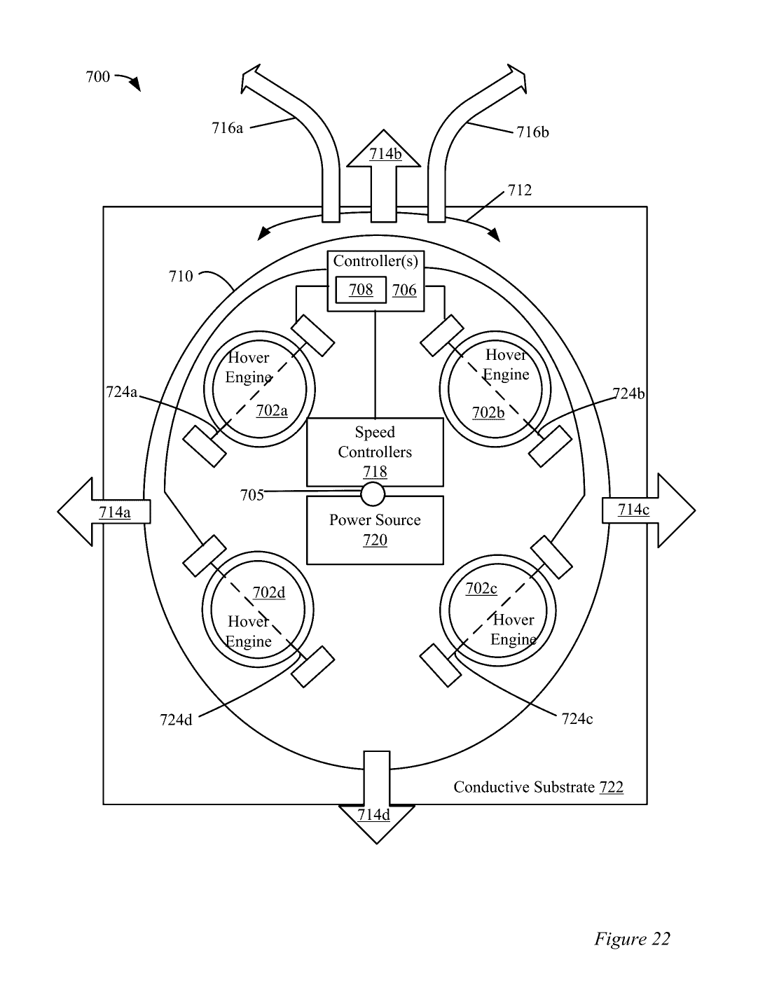

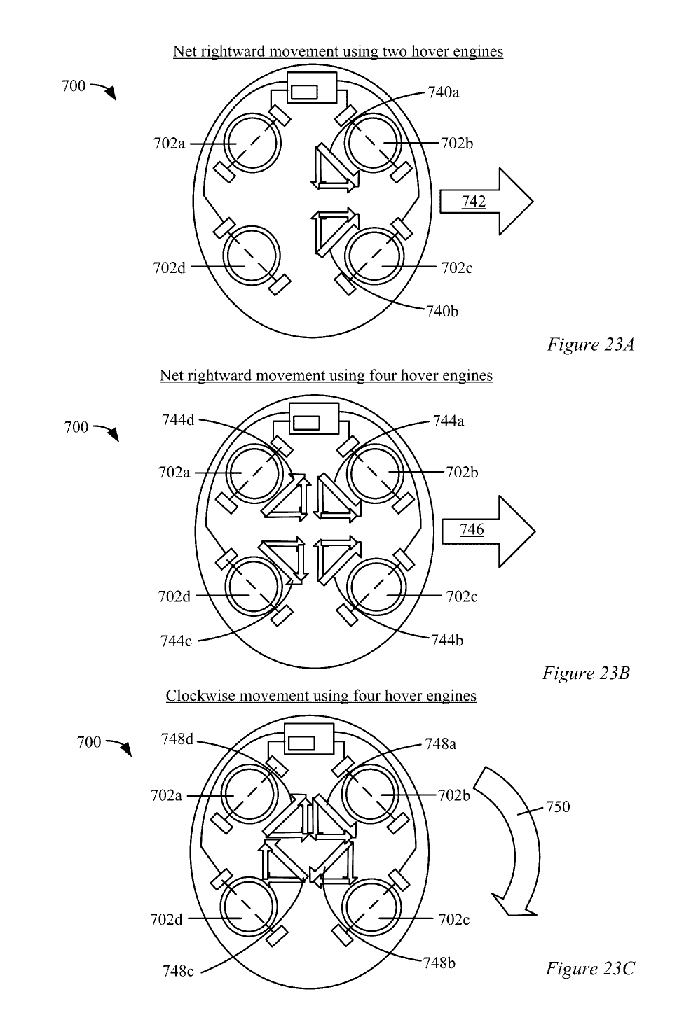

In FIG. 21A, a lever arm 502 is coupled to a motor/STARM via a ball joint 506. When hovering, a movement of the lever arm 502 from side to side can cause the STARM 510, which includes an arrangement of magnets 512, to tilt relative to a conductive surface such that a vehicle including the hover engine moves forward and backward. The amount of side to side tilt can affect the speed at which a vehicle moves in these directions. A movement from front to back can cause the STARM 510 to tilt such that the vehicle moves either left or right. A combination of a left or right movement and a front or back movement of the lever 502 can tilt the STARM such that the vehicle moves in various directions along different lines. A change in the lever direction as a function of time can change the direction vector of the force that is generated as a function of time and, hence, the vehicle can move along an approximately curved path.

In various embodiments, a mechanical linkage can be used that causes one or more hover engines to be tilted in response to a movement of the lever arm 502. For example, two hover engines can be coupled to a common rotational member such that both hover engines are rotated in response to a torque applied to the rotational member. In addition, digital controls can be used where a movement of the lever arm 502 is detected by one or more sensors. The sensor data can be received in an on-board processor. The on-board processor can generate one or more commands based on various factors such as an amount of movement, a direction of movement, and a rate of movement of the lever arm 502, as well as a current orientation and direction of motion of the vehicle. The commands can be sent to one or more actuators via wired or wireless communications. The actuators can include logic devices (e.g., controllers) which enable communications with the on-board processor and interpreting of commands from on-board processor.

The one or more actuators can be coupled to a single hover engine or a plurality of different hover engines. In response to receiving the commands, the actuator controller can cause the actuator to output a force or a torque. The force or torque can cause the hover engine to change its position in some manner, such as, but not limited to, a tilt position.

In some embodiments, the on-board processor can send commands, which cause a rotation rate of a STARM associated with a hover engine to go to a particular RPM value. The motor commands, which can be received by motor 508, can be generated in conjunction with the actuator commands. The RPM value can affect the amount of force that is generated from the hover engine after its position has been changed. The motor 508 can include one or more controllers for 1) communicating with the on-board processor (wired or wirelessly), 2) processing the commands received from the on-board processor, and 3) generating commands to control mechanisms associated with the motor. Such control mechanisms implement the command, for example, via an amount of power delivered to the motor.

FIG. 21B shows foot pedals, 552, which can be used to tilt hover engine including a motor 562 and a STARM 564. When a single foot pedal, 552, is pressed downwards, the STARM 564 can generate a force, perpendicular to the page, which can cause the vehicle to move forward. When the other foot pedal is pressed downwards, the STARM 564 can generate a force, which can cause the vehicle to move backwards. The amount each pedal is depressed can be used to control a speed of the vehicle in a particular direction. When a first pedal is pressed to move the vehicle in one direction, removing pressure from the first pedal and applying pressure to the second pedal can act as a brake to slow the vehicle.

A pedal control mechanism can be provided with each foot pedal so as to generate a restoring force. The mechanism can also be used to affect how much force needs to be applied to a pedal to move the pedal. Further, the mechanism can limit how far the pedal can move. In FIG. 21B, the pedal control mechanism is in the form of a spring. The mechanism can generate a force that is approximately linear and/or non-linear with the amount of displacement of the foot pedal. In particular embodiments, one or more mechanisms that generate a restoring force can also be used with the lever arm shown in FIG. 21A. Again, as described above, one or more foot pedals can be used as part of a digital control system.

### Vehicle Configurations and Navigation, Guidance and Control (NGC)

Next, various configurations of magnetically lifted devices, including multiple hover engines, are described. In particular, arrangements of hover engines and then their actuation to provide movement are described. In addition, Navigation, Guidance and Control (NGC) functions, which can be applied to magnetically lifted devices are discussed.

FIG. 22 shows a top view of a vehicle 700 configured to operate over a conductive substrate 722. The vehicle 700 includes four hover engines, 702a, 702b, 702c and 702d. Each hover engine includes a STARM and a motor and a mechanism which enables a propulsive force to be output from each hover engine. In one embodiment, each of the hover engines 702a, 702b, 702c and 702b can be tilted around an axis, such as 724a, 724b, 724c, 724d, via control of an actuator. In particular embodiments, the hover engines can each be individually actuated so that the direction and amount of the tilt angle as a function of time can be individually changed for each of the four engines.

In alternate embodiments, two or more hover engines can be controlled as a unit. For example, two or more hover engines can be mechanically coupled to a single actuator. The single actuator can move both hover engines simultaneously. In another example, the two or more hover engines can be digitally coupled such that the two or more hover engines are always moved together simultaneously, i.e., a movement of one hover engine specifies some specific movement of another hover engine, such as both being tilted in the same manner. When independently controlled, the movement of one hover engine can affect the movements of other engines, such as to implement GNC functions. However, a second hover engine may not be always constrained to a specific control movement in response to the movement a first hover engine, as in the case when two hover engines are controlled digitally and/or mechanically controlled as unit.

The actuators associated with each hover engine can be coupled to one or more controllers 706 and an IMU 708 (Inertial Measurement Unit). The actuators can each also have a separate controller that responds to commands from the controller 706. The controller 706 can also be coupled to a power source 720 and one or more speed controllers 718. The one or more speed controllers 718 can be mechanical or electronic speed controllers. The power source can be on-board or off-board. The hover engines are secured via a housing and associated support structure 710.

The center of mass of the vehicle is indicated by the circle 705. The center of mass affects the moments generated when each of the four hover engines are actuated. In particular embodiments, the vehicle can include a mechanism which allows the center of mass to be adjusted in flight, such as a mechanism for moving a mass from one location to another. For example, in an airplane, fuel can be moved from one tank to another to affect the center of mass characteristics.

An IMU 708 works by detecting the current rate of acceleration using one or more accelerometers, and detects changes in rotational attributes like pitch, roll and yaw using one or more gyroscopes by way of example. It may also include a magnetometer, to assist calibrate against orientation drift. Inertial navigation systems can contain IMUs which have angular and linear accelerometers (for changes in position). Some IMUs can include a gyroscopic element (for maintaining an absolute angular reference).

Angular accelerometers can measure how the vehicle is rotating in space. Generally, there is at least one sensor for each of the three axes: pitch (nose up and down), yaw (nose left and right) and roll (clockwise or counter-clockwise from the cockpit). Linear accelerometers can measure non-gravitational accelerations of the vehicle. Since they can move in three axes (up & down, left & right, forward & back), there can be a linear accelerometer for each axis.

A processor can continually calculate the vehicle's current position. First, for each of the six degrees of freedom (x, y, z and θx, θy and θz), the sensed acceleration can be integrated over time, together with an estimate of gravity, to calculate the current velocity. Then, the velocity can be integrated to calculate the current position. These quantities can be utilized in the GNC system.

Returning to FIG. 22, as described above, the forces generated from changing a tilt of a rotating STARM relative to the substrate 722 are directed primarily along the tilt axes when the vehicle is parallel to the substrate 722. For example, a tilt of hover engine 702a can generate a force which is primarily parallel to axis 724a.

With the tilt axes arranged at an angle to one another as shown in FIG. 22, a combination of STARMs can be actuated to generate a net linear force in any desired direction. Further, the STARMs can be actuated in combination to cancel moments or, if desired, induce a desired rotation in a particular direction. In addition, different combinations of STARMs can be actuated as a function of time to generate a curved path in a desired direction(s) as a function of time. Yet further, a combination of STARMs can be actuated so that the vehicle moves along linear or curved path and rotates around an axis while moving along the path.

The tilt control can be used alone or in combination with rotational velocity control of each hover engine. The translational and lifting forces that are generated can vary as a function of the rotational velocity and a hover height. A rotational speed of a hover engine can be varied relative to other hover engines or in combination with other hover engines to change the magnitude of lifting and drag forces which are generated by the one or more hover engines. For example, the rotational velocity control may be used to counter imbalances in forces, such as resulting from a shifting center of mass. For an electric motor, the one or more controllers 706 can control the speed controllers 718 to change the rotational velocity of a hover engine.

In the example of FIG. 22, angles can be defined relative to the tilt axes. For example, the angle between tilt axis 724a and 724b is approximately ninety degrees. The angle between tilt axis 724c and 724d is approximately ninety degrees. In one embodiment, the tilt axes of the hover engines opposite one another (724a and 724c; 724b and 724d) can be parallel to one another, i.e., an angle of one hundred eighty degrees.

In an alternative example, the angle between the tilt axes of the hover engines adjacent to one another do not have to be equal. In particular, the angle between tilt axes 724a and 724b can be a first angle and the angle between tilt axes 724a and 724c can be one hundred eighty degrees minus the first angle where the first angle is between zero and one hundred eighty degrees. For example, the angle between tilt axes 724a and 724b can be ten degrees and the angle between tilt axes 724a and 724c can be one hundred seventy degrees. In general, the angles between all of the tilt axes, 724a, 724b, 724c and 724d can be different from one another.

In FIG. 22, the hover engines can be tilted to generate various movements, such as left, 714a, right 714b, forward 714b and back 714b. Further, the hover engines can be tilted as a function of time to cause the vehicle 700 to follow a curved path, such as 716a and 716b. In addition, the hover engines can be tilted to cause the vehicle 700 to rotate in place in a clockwise or counterclockwise rotation 712. For example, without rotating, the vehicle 700 can be controlled to move in a first straight line for a first distance, and then move in a second straight line perpendicular to the first straight line for a second distance. Then, the vehicle 700 can rotate in place.

A vehicle with a configuration similar to vehicle 700 was constructed. The vehicle is cylindrically shaped with a diameter of 14.5 inches and a height of 2.125 inches. The vehicle weighs 12.84 pounds unloaded. Tests were performed during which the vehicle carried more than 25 pounds of payload beyond its unloaded weight.

This vehicle includes four hover engines. Each hover engine includes a STARM which is 4.25 inches in diameter. Sixteen ½ inch cube magnets are arranged in each STARM in a circular pattern. The arrangement is similar to the configuration shown in FIG. 28 which employs 20 magnets. N52 strength Neodymium magnets are used.

One motor is used to turn each STARM. The motors were Himax 6310-0250 outrunners. The motors each weigh 235 grams. The optimum working range for the motors is 20 to 35 Amps with a max current of 48 Amps. The motors are cylindrically shaped with a length of 32 mm and a diameter of about 63 mm. The motor power is about 600 Watts and the motor constant, Kᵥ, is about 250.

Electronic speed controllers were used for each motor. In particular, Phoenix Edge electronic speed controller (Edge Lite 50, Castle Creations. Inc. Olathe, Kans.) were used. The speed controllers are coupled to batteries. In this embodiment, two VENOM 50C 4S 5000MAH 14.8 Volt lithium polymer battery packs are used (Atomik RC, Rathdrum, Id.)

Four Hitec servos were used (HS-645MG Ultra Torque, Hitec RCD USA, Inc. Poway, Calif.) as actuators. The servos put out a maximum torque of 133 oz-in and operate between 4.8 and 6V. Depending on the size of the hover engine that is acutated, different servos with varying torque output capabilities may be used. This example is provided for illustrative purposes only.

In addition, one actuator is shown per motor. In alternative embodiments, a single actuator can be used to tilt more than one hover engine. In yet other embodiments, a plurality of actuators can be used to change an orientation of a STARM and/or motor. In further, embodiments, one or more actuators in combination with an input force provided from a user can be used to change an orientation of a STARM and/or motor.

The servos are used to tilt a motor and a STARM in unison. The control system is configured to independently tilt each hover engine including the motor and STARM. In a particular embodiment, the motor and STARM are configured to tilt through a range of −10 to 10 degrees. Ranges, which are greater or smaller than this interval can be used, and this example is provided for the purposes of illustration only.

In one embodiment, the same tilt range can be implemented for each hover engine. In other embodiments, the tilt range can vary from hover engine to hover engine. For example, a first hover engine can be tilted between a range of −15 to −15 degrees, and a second hover engine can be tilted between −5 and 10 degrees.

A Hobbyking KK2.1.5 Multi-rotor LCD Flight Control Board with 6050MPU and an Atmel 644PA was used for control purposes. The board is 50 mm×50 mm×12 mm and weighs 21 grams. The input voltage is 4.8-6V. The gyro/accelerometer is a 6050MPU InvenSense, Inc (San Jose, Calif.). It has a MEMS 3-axis gyroscope and a 3-axis accelerometer on the same silicon die together with an onboard Digital Motion Processor™ (DMP™) capable of processing complex 9-axis Motion/Fusion algorithms.

The vehicle was able to climb up sloped surfaces. In a test on a flat track, an acceleration of 5.4 ft/sec² was measured, which is about 0.17 g's. The acceleration depends on the thrust force which is output, the overall weight of the vehicle, the tilt angle of the STARMs and the STARM magnet configuration. This example is provided for the purposes of illustration only.

In particular embodiments, a vehicle can be controlled via a mobile control unit. The mobile control unit can be coupled to a vehicle via a wireless or wired communication link. The mobile control unit can include one or more input mechanisms, such as control sticks, a touch screen, sliders, etc.

The mobile control can receive inputs from the input mechanisms and then send information, such as commands, to the vehicle. A command could be move in some direction or rotate in place. The GNC system on the vehicle can receive the command; interpret it; and then in response generate one or more additional commands involving controlling the actuators and/or hover engines to implement the commands. For examples, one or more of the actuators on the vehicle can be controlled to implement a received movement or rotation command.

In one embodiment, the mobile control unit can be a smart phone, with a touch screen interface. An application executed on the smart phone can generate an interface on the touch screen, which is used to input control commands. In addition, the application can be configured to output information about the vehicle's performance to a display, such as speed, orientation, motor RPM, flight time remaining, etc. The smart phone can be configured to communicate with the vehicle via a wireless communication interface, such as but not limited to Bluetooth.

In another embodiment, a hand-held control unit, such as one used to control a quad copter or radio controlled car can be used. Hand-held control units can include multiple channels, a channel switch, a digital display, an antenna, control sticks, trims, and an on/off switch. One example is a Spektrum DX6i DSMX 6-Channel transmitter (Horizon Hobby, Inc., Champaign, Ill.).

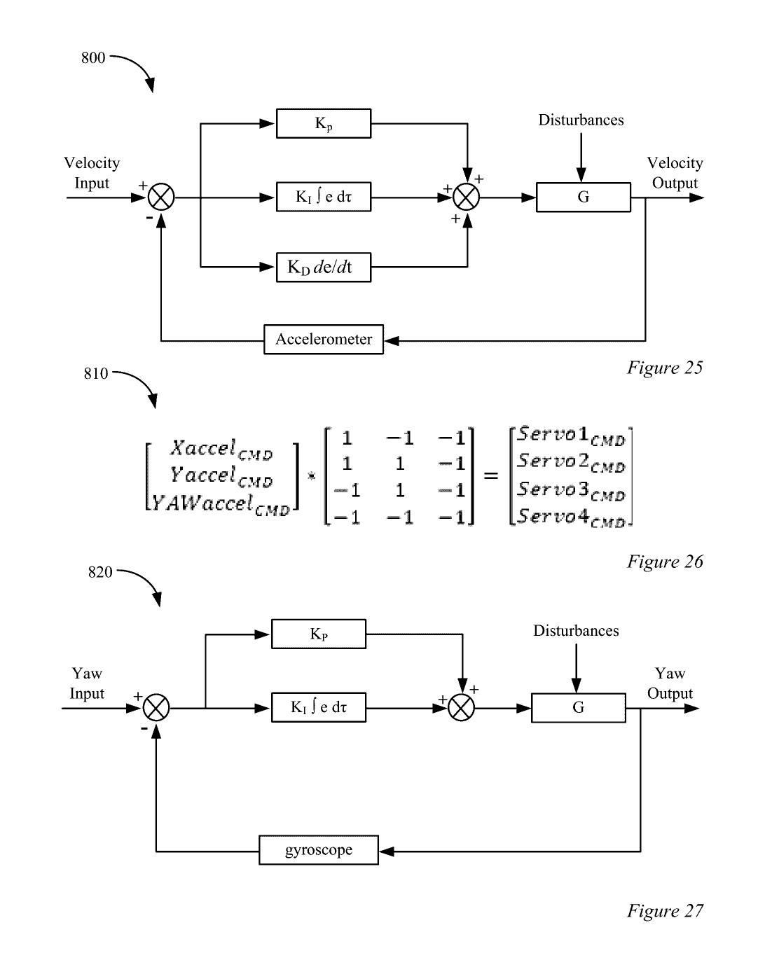

Next, some details of tilting a STARM to control a vehicle are described. FIGS. 23A, 23B and 23C, show some examples of actuating different combination of hover engines to produce a movement or rotation. In FIG. 23A, two hover engines 702b and 702c, which are shaded, are actuated to produce a net rightward force 742, which causes the vehicle to move to the right 742. The direction of the net force generated by each of the two hover engines is shown by the adjacent arrows, 740a and 740b. Hover engine 702b generates a net force 740a with a downward and rightward force component. Hover engine 702c generates a net force 740b with upwards and rightward components.

The upward and downward translational forces cancel when the two hover engines are actuated to generate the same magnitude of force, which results from the eddy currents induced in the substrate. The rightward force components of the two activated engines are additive and produce a net translational force to the right. When the two hover engines are an equal distance from the center of mass of the vehicle, the moments generated from the two hover engines cancel one another and thus rotational stability can be maintained.

The hover engines, even when identical, may be actuated by different amounts. For example, the vehicle 700 can be tilted such that one of hover engine 702b and 702c is closer to the substrate. The distance of the hover engine to the substrates affects the force output from the hover engine as a result of its tilt. Hence, different tilt angles may be required to balance the forces output from each hover engine.

Further, when the vehicle 700 is loaded, the center of mass can shift depending on how the weight of the payload is distributed. Thus, the center of mass can shift from the unloaded state to the loaded state and the two hover engines may no longer be an equal distance from the center of mass of the vehicle. In this instance, when a pair of hover engines each generates the same amount of net force, a net moment may be present because the two hover engines are different distances from the center of mass. Thus, the combination of hover engines that are used and the amount of actuation of each hover engine may have to be adjusted to account for the shifting center mass due to payload shifts or the overall orientation of the vehicle 700 relative to the substrate over which it is operating.

The magnitude of the effects resulting from changes in the center of mass will depend on how much the center of mass shifts from the loaded to unloaded state. Further, in some instances, the center of mass can shift during operation if the payload is allowed to move during operation or if the payload is decreased. For example, if a fuel is consumed during operation of the vehicle, the center of mass of the vehicle may change due to the fuel being consumed. As another example, if one or more persons is riding on a vehicle and can move around, the center of mass may change. Thus, in particular embodiments, the center of mass may be changing dynamically during operation, and the GNC system can be configured to account for the shifts in the center of mass of the vehicle when maintaining rotational and translational control.

In FIG. 23B, a net rightward movement is generated using four hover engines. In this example, all four hover engines, 702a, 702b, 702c and 702d are actuated to generate a net force 746 in the rightward direction. In general, the hover engines can be actuated to generate a net translational force which is substantially in the rightward direction. In particular, the hover engines are actuated to cancel translational forces in other than rightward directions.

Further, hover engines can be actuated such that the net moment acting on the vehicle is zero. As described above, to rotate the vehicle, a net moment can be generated that rotates the vehicle in a clockwise or counter-clockwise direction.

In FIG. 23C, the four hover engines, 702a, 702b, 702c and 702d, are shown actuated in a manner that causes a net moment in the clockwise direction. The translational forces associated with the four hover engines cancel one another. Thus, the vehicle can rotate in place.

In the example of FIGS. 23A, 23B and 23C, all four hover engines' tilt axes are orientated about the edges of a rectangle. This configuration allows the vehicle to move upward/downward or left/right on the page with equal ease. In other embodiments, the hover engines tilt axes can be located around the perimeter of a parallelogram. Thus, the hover engine may more easily generate a translational force in particular directions, such as left/right on the page versus up/down on the page. Further, in some embodiments, as described above, mechanisms can be provided which allow the direction of a tilt axes to be changed on the fly. Thus, it may be possible to change the configuration of the hover engine tilt axes on the fly.

In the example of FIGS. 23A, 23B and 23C, the force vector generated by each hover engine is assumed to be an equal distance from the center of mass of the vehicle. In other embodiments, the hover engines can be different distances from the center of mass of the vehicle. For example, a pair of two hover engines can each be a first distance from the center of mass and a second pair of hover engines can each be a second distance from the center of mass.

Further, even when the hover engines are the same distance from the center of mass, the hover engines can be configured to output different levels of propulsive forces. For instance, one hover engine may use a greater volume of magnets than another hover engine to output more force. In another example, the rotational velocities of two identical hover engines can be different, which can cause the hover engines to output different levels of propulsive forces relative to one another. In one embodiment, multiple hover engines used on a vehicle can be identical and operated at a similar rotational velocity so that they each output a similar amount of force.

In general, when a plurality of actuatable hover engines are used, each hover engine can be positioned at a different distance from the center of mass or combinations of hover engines may be positioned at the same distance from the center of mass. Further, the size of each hover engine, the magnet configurations used on each hover engine, and the resultant force output by each hover can vary from hover engine to hover engine on a vehicle. However, combinations of hover engines within the plurality of hover engines can be selected with equal force generating capabilities. A GNC system can be designed that accounts for differences in hover engine placement location on a vehicle and force generation capabilities that may differ between hover engines. In addition, the GNC system can be configured to account for dynamic loading and dynamic orientation changes of a vehicle, which affect the forces and moments output from each hover engine.

In the examples above, the STARMs that are part of the hover engines are configured to generate lift, propulsive, and rotational forces. In other embodiments, it may be desirable to customize or specialize the hover engines. For example, a first hover engine can be configured to primarily generate lift and may be not actuatable for generating propulsive forces. Then, additional hover engines can be configured to generate some portion of the lift and can be actuatable to generate propulsive and rotational forces as well, which can be used to control and direct a vehicle. Some magnet configurations may be more suitable for generating propulsive forces as compared to lifting forces. Hence, when multiple hover engines are used on a vehicle, the magnet configurations may be varied between the hover engines.

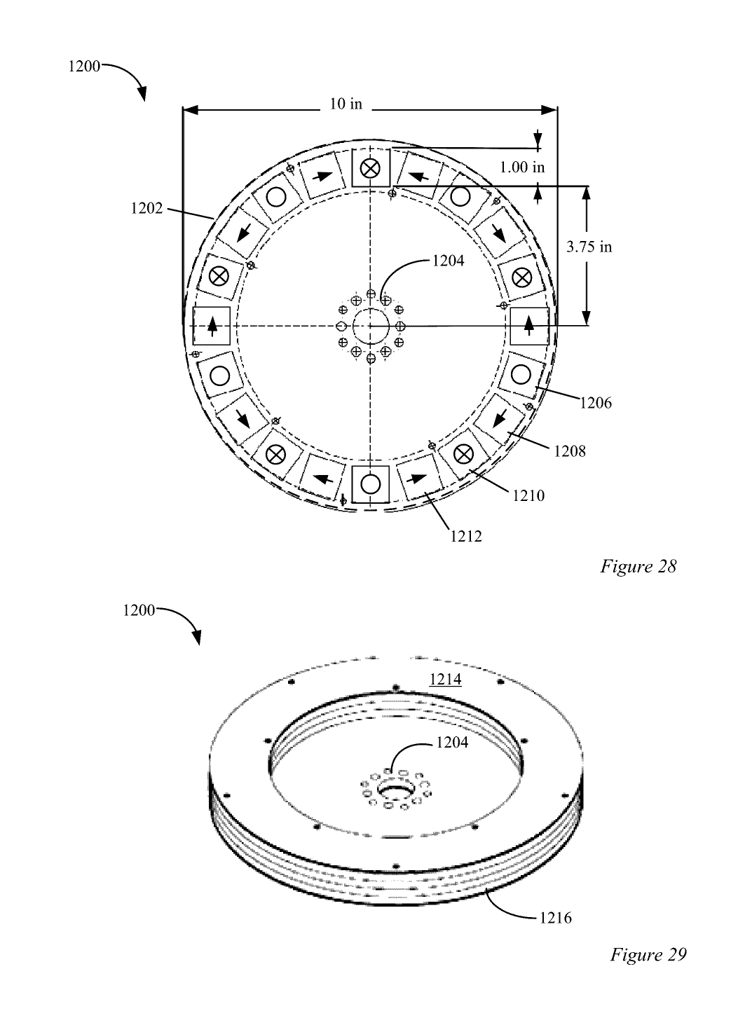

FIG. 24 shows an example of vehicle 750 with five hover engines. Four of the hover engines are configured in the manner described above with respect to FIG. 22. However, a fifth hover engine 752 located in the center of the vehicle is configured to generate lift only and is non-actuatable, whereas four hover engines, similar to what was previously described, can be actuated to generate the propulsive, rotational and control forces.

In particular embodiments, the four hover engines, 702a, 702b, 702c and 702d, may not be able to hover the vehicle alone. For example, in one embodiment, the four STARMs may not be able to hover an unloaded vehicle and may require some lift to be generated from the lift-only engine. In another embodiment, four STARMs may be able to hover the vehicle while it is unloaded. However, if the vehicle carries some amount of payload, then operating the lift only hover engine may be needed.

In one embodiment, the height above the surface of the bottom of the magnets in the propulsive hover engines and height above the surface of the bottom of the magnets in the lift only hover engine can be offset from one another when the STARMs in the propulsive hover engines and the lift only hover engines are parallel to the surface. For example, the height of the bottom of the magnets in the propulsive STARMs can be positioned at a distance farther away from the surface than the height of the bottom of the magnets in the lifting STARM. The amount of force needed to tilt a STARM in a hover engine relative to the surface can increase as the STARM gets closer to the surface. The amount of force increases because magnetic forces are generated non-linearly and increase when the magnets are closer to the surface. Thus, by keeping the propulsive STARMs farther away from the surface than the lifting STARMs during operation, it may be possible to utilize less force to tilt the propulsive STARMs. STARMs with less magnet volume on the propulsive STARMs as compared to the lifting STARMs can also lessen the force output from the propulsive STARMs and, hence, require less force to tilt than the lifting STARMs.

In one embodiment, a mechanism can be provided, separate from the tilt mechanism, which can be used to control a distance of a hover engine, such as the propulsive STARM from the surface. For example, the mechanism can be configured to move the hover engine in the vertical direction closer or farther away from the surface. This capability can also be used when the vehicle is first started. For example, while at rest, the bottom of the vehicle can rest on the ground and the hover engines can be pulled up into the vehicle enclosure. Then, the hover engines can be started. After the hover engines reach a certain velocity the hover engines can be moved relative to the vehicle such that the hover engines are closer to a bottom of the vehicle.

Since the propulsive hover engines may not be needed to carry the full lift load, in some embodiments, it may be possible to use smaller propulsive and control STARMs than if the control and propulsive STARMs are also used to carry the entire lift load. One advantage of using this approach is that if the control and propulsive STARM can be made smaller (e.g., a smaller radius and moment of inertia), the amount of force used to actuate the STARMs can be smaller. Thus, it may be possible to use smaller, lighter and less expensive actuators.

Another advantage of using hover engines specialized for lift or control is that the operating conditions of the hover engine used to generate lift most efficiently can be different than the operating conditions used to generate the propulsive and control forces most efficiently. Thus, when some of the hover engines are used primarily for lift only, these hover engines may be operated at different conditions, as compared to the hover engines configured to generate control forces. For example, to generate relatively more propulsive forces, a control hover engine can be operated at a rotational velocity that is near peak drag, i.e., a lower lift to drag ratio as compared to a higher rotational velocity. In contrast, a lift-only hover engine may be operated at a higher rotational velocity to minimize drag and maximize lift because, as described above, after peak drag the drag force on a hover engine can decrease and the lift to drag ration can increase as the rotational velocity increases.

Next, the navigation, guidance and control (NGC) system, which can be used to control a hover engine configuration to move a magnetically lifted vehicle, is described. First, each of the functions of an example NGC are briefly discussed. These functions can be incorporated as logic for an NGC system implemented as circuitry on a magnetically lifted device. For example, the NGC system can be a component of the controller 706 in the previous figures.

First, navigation includes figuring out a current position and orientation relative to a defined reference frame. For example, where you are could be in your car in the driveway, and your orientation is that the trunk of the car is pointed towards the curb. In this example, the reference frame is a flat earth.

Second, guidance involves figuring out a path to take. In particular, guidance is figuring out how to get where you want to go based on where you are. Guidance comes after navigation, because if you don't know where you are, it is difficult to figure out which way to go. Guidance has potentially a very large number of solutions. However, rules and constraints can be imposed to limit the solution size.

As an example, you know you are in your driveway with your backside towards the curb. How do you get to the store? A rule can be imposed that you have to follow the predefined system of roadways. This limits your guidance options. You might also include rules about obeying speed limits and stop signs. This shrinks the solution space further. You may also have vehicle limitations. For example, a four-cylinder Corolla might not have the same acceleration capability as a Ferrari. This notion can be applied to different configurations of hover engines, which can have different performance characteristics.

When the rules and limitations are combined, a guidance solution that defines orientation, velocity, and acceleration as functions of time can be obtained. In the guidance space, there can be flexibility to impose or relax the rules to achieve the performance that is desired. For instance, per the example above, when one is trying to reach a destination very quickly, one may choose to ignore speed limits for some period of time.

Control is getting the vehicle to perform as the guidance solution instructs it to perform. This means accelerating, decelerating, maintaining velocity, etc. so that the vehicle follows the guidance solution as closely as desired. In the current example, the driver is the control system. Thus, he or she monitors the speed and acceleration and can make minute adjustments to maintain the desired conditions. In the examples above, the NGC system can make adjustments to the tilt angles of the hover engines to maintain the desired conditions.

Thus, the combination of navigation, guidance, and control allows a magnetically lifted vehicle to be moved in a desired way. As disturbances do enter the system, it may be important to regularly update the navigation, guidance, and control solutions. A system updated in this manner can form a closed loop system. The closed loop system may allow for more accurate motion of the vehicle under GNC.

In alternate embodiments, an open-loop controller, also called a non-feedback controller, can be used. An open-loop controller is a type of controller that computes its input into a system using only the current state and its model of the system. A characteristic of the open-loop controller is that it does not use feedback to determine if its output has achieved the desired goal of the input. Thus, the system does not observe the output of the processes that it is controlling.

For a magnetically lifted vehicle, the GNC can include combinations of 1) velocity control, 2) waypoint management, 3) acceleration/de-acceleration curves (profiles), 4) velocity profiles, 5) free path, which combines acceleration/de-acceleration profiles and velocity in route, and 6) navigation. Navigation can include utilizing one or more of a) dead reckoning, b) an indoor positioning system, c) retro-reflectors, d) infrared, e) magnetics, f) RFID, g) Bluetooth, f) ultrasound, and g) GPS. An indoor positioning system (IPS) is a solution to locate objects inside a building, such as a magnetically lifted vehicle, using radio waves, magnetic fields, acoustic signals, or other sensory information collected by appropriate sensors. Various types of sensors that are sensitive to different types of energies can be used in a navigation solution. These examples are provided for the purpose of description and are not meant to be limiting.

A method of GNC can involve establishing acceleration/de-acceleration profiles (curves, limits, etc.), which may include establishing velocity acceleration/de-acceleration profiles (curves, etc.). Next, a route can be created. The route can be converted into x and y path points on a surface.

In one embodiment, waypoints can be added. Typically, start and end are waypoints by default. What happens at waypoints (null, stop, specific velocity, etc.) can be defined. Path segments can be defined by waypoints.

Next, the orientation for each path segment (relative to velocity direction, relative to fixed point, spinning profile, etc.) can be defined. With the path segments defined, the GNC system can maneuver the vehicle along each path segment according to user defined velocity/acceleration profiles and orientations. Finally, the current position (x, y) of the vehicle can be monitored relative to a preplanned route with regular navigation updates. As the vehicle moves, a current position and desired position can be compared based upon the sensor data. Then, the system can be configured to correct for errors.

In some embodiments, the hover height of a vehicle can be controlled. Thus, the system can be configured to determine a height profile of a vehicle along a path segment. Then, while the vehicle is maneuvered along the path segment, the system can receive sensor data which is used to determine a height of the vehicle. The system can be configured to compare the measured height from the desired height and then correct for errors.

Next, an embodiment of a GNC system used to control the vehicle described with the respect to FIGS. 25, 26 and 27 is discussed. In this example, a wireless controller is used to control the vehicle. The wireless controller can generate input signals in response to user commands.

A proportional-integral-derivative controller (PID controller) is a control loop feedback mechanism (controller) often used in industrial control systems. A PID controller can calculate an error value as the difference between a measured process variable and a desired set point. The controller can attempt to minimize the error by adjusting the process through use of a manipulated variable.

The translational motion control for the vehicle can use a PID control system for lateral acceleration control. Two lateral acceleration inputs can be received from the user via the wireless controller. These inputs can be fed into their own individual PID control loops, as diagrammed in FIG. 25.

Inside the control loop, the input can be differenced with the acceleration output feedback measured by the accelerometer. The resulting difference is the error. The error can be fed into the PID controller, which can have three components: the proportional control, the integral control, and the differential control.

The proportional element multiplies the error by a proportional gain, Kₚ. The integral element computes the sum of the errors over time, and multiplies this by the integral gain, K_{I}. The differential control differences the current input with the previous input and multiples this difference by the differential gain, K_{D}. The proportional, integral, and differential elements are then summed and sent to the mixing logic as shown in equation 810 of FIG. 26.

The outputs from the mixing logic are sent into the plant, G. The resulting translational acceleration is the output from the plant. The vehicle's translational acceleration is measured by the accelerometers. This measured acceleration is fed back to the beginning of the PID control loop.

The spin control for the vehicle can use a PI (Proportional-Integral) control system for yaw speed control, as shown in the block diagram in FIG. 27. A yaw acceleration input is received from the user via an RC controller. This yaw input can be differenced with the yaw output feedback measured by the gyroscope. The resulting difference is the error. This error can be fed into the PI controller, which has two components: the proportional control and the integral control. The proportional element multiplies the error by a proportional gain, Kₚ.

### Magnet Configurations and Performance Comparisons

In this section, various magnet configurations which can be used in STARMs are described with respect to FIGS. 28-71. Prior to describing the magnet configurations, some terminology is discussed. Typically, a permanent magnet is created by placing the magnet in an outside magnetic field. The direction of the outside magnetic field is at some orientation relative to the geometry of the permanent magnet which is being magnetized. The direction of the outside magnetic field relative to the geometry of the permanent magnet, when it is magnetized, determines the poles of the permanent magnet where the north and south poles describe the polarity directions of the magnet.

In the examples below, a STARM will have an axis of rotation. A first group of magnets can be referred to as “poles.” Poles can have a polarity direction that is approximately parallel to the axis of rotation of the STARM. Although, in some embodiments, magnets can be secured in the STARM such that there is an angle between the polarity direction of the magnet and the axis of rotation of the STARM. In addition, as described above, mechanisms can be provided so as to allow an orientation of a permanent magnet to be dynamically changed on a STARM.

A second group of magnets can be referred to as “guides.” The guides can be secured in a STARM such that the angle between the polarity direction of the guides and the axis of rotation is approximately ninety degrees. However, the angle between the guide magnets and the axis of rotation can also be offset by some amount from ninety degrees. When pole magnets are secured in a STARM with alternating polarity directions, the magnetic field lines emanating from the north pole of one pole magnet can bend around to enter into the south pole of an adjacent pole magnet, and the magnetic field lines emanating from the south pole of one pole magnet can bend around to enter into the north pole of an adjacent magnet. Typically, the guide magnets can be placed between the poles. The “guide” magnets can guide the path of the magnetic fields that travel between the pole magnets.

The combination of pole magnets and guide magnets can be secured in a STARM to form a configuration of polarity regions. On a STARM, this configuration can be referred to a polarity arrangement pattern. In some of the examples below, a polarity arrangement pattern of the STARM can be formed from a first polarity arrangement pattern that is repeated. For example, the polarity arrangement pattern can be formed from a first polarity arrangement pattern that is repeated two, three, four, five times, etc. In other embodiments, the polarity arrangement pattern of a STARM can be formed from a first polarity arrangement pattern and a second polarity arrangement pattern where the first polarity arrangement pattern or the second polarity arrangement pattern is repeated one or more time.

A polarity region in a polarity arrangement pattern can have a common polarity direction. The polarity region can be formed from one or more magnets polarized in the common direction associated with the polarity region. In the examples that follow, single magnets, such as one inch cubic magnets, are described as forming a polarity region. However, multiple magnets of a smaller size can be used to form a polarity region. For example, a one-inch cube polarity region can be formed from 8 half inch cubed magnets or 16 one quarter inch cube magnets that are all arranged in the same direction. Thus, the examples below are provided for the purposes of illustration only and are not meant to be limiting.

An overall polarity arrangement pattern generated on a STARM using permanent magnets can form a magnetic field with a particular shape and density of magnetic field lines. The strength of the field at different locations can depend on the volume distribution of magnets and their associated strength.

Magnetic fields are generated when current is moved through a wire. For example, current passing through a wire coil generates a magnetic field that approximates a bar magnet. A magnet constructed in this manner is often referred to as an “electromagnet.” In various embodiments, the magnetic field shapes and density of magnetic field lines from an arrangement of permanent magnets can be approximated by using arrangements of wires and passing current through the wires. Thus, the example of permanent magnets is provided for the purposes of illustration only and is not meant to be limiting.

A STARM can have a top side and a bottom side. When eddy currents are generated, a bottom side can face the conductive substrate in which eddy currents are induced by the rotation of the STARM. Often, when permanent magnets are used, the permanent magnets can have at least one flat surface. As examples, cubic shaped magnets have six flat surfaces, whereas cylindrically shaped magnets have two flat surfaces which are joined by a curved surface. In some embodiments, at least one flat surface on each of the permanent magnets on a STARM can be secured on a common plane, which can reside close to the bottom side of the STARM.

In alternate embodiments, a STARM can be curved or angled. For example, the STARM can be convex or concaved shape and/or include other curved portions. The bottom of magnets of the STARM can be arranged to follow the bottom surface of the STARM including curved surfaces. The magnets can have flat bottoms, such as cubic magnets. However, in other embodiments, the magnets can be formed in curved shapes to help confirm to the curvature of the STARM.

As an example, a hover engine can be configured to operate within a pipe or a trough where the inner surface of the pipe includes a conductive substrate. The STARM of the hover engine can be bowl shaped and bottom of the magnets on the STARM can be arranged to follow outer surface of the bowl shape. When a STARM is placed next to a curved surface, a larger proportion of the magnets on the STARM can be closer to the inner surface of the pipe as compared to if the magnets were arranged in a common plane, such along the bottom of a flat disk.

Next, some magnet and STARM configurations are described. FIG. 28 shows a STARM 1200. The STARM 1200 has a ten-inch outer diameter. Twenty one-inch cube magnets are arranged around the circumference of a circle. In particular, one inner radial side of each of the 20 one-inch cube magnets is approximately tangent to a 3.75 inch radius circle.

The inner radial distance provides a small gap between each magnet. The gap between magnets increases as the radial distance increases. A minimum inner radial distance allows the magnets to approximately touch one another. The inner radial distance can be increased, which for the same amount of magnets increases the minimum gap between the magnets.

A structure of about 0.25 inches thick is provided between the outer radial edge of the magnets and the outer diameter 1202 of the STARM. In one embodiment, the center of the STARM can include a number of mounting points, such as 1204. The mounting points can be used to secure the STARM 1200 to a rotatable member, such as a rotatable member extending from a motor.

The polarity arrangement pattern of the STARM includes ten pole magnets and ten guide magnets. The polarity arrangement pattern is formed from a first polarity arrangement pattern as exemplified by magnets 1206, 1208, 1210 and 1212. In this example, the first polarity arrangement pattern is repeated four times. In other embodiments, the first polarity arrangement pattern can be used once on a STARM or can be repeated two, three four times, etc. Further, more than one ring of magnets can be provided, which utilize the first polarity pattern. For example, the first polarity pattern can be repeated twice in an inner ring and then four times in an outer ring as shown in FIG. 28.

In the example above, the volume of each pole and guide magnet is the same. In other embodiments, the volume of the pole magnets and the guide magnets can vary from magnet to magnet while still maintaining the overall polarity arrangement pattern. For example, the volume of the pole magnets can be half the volume of the guide magnets. In another example, the volume of the pole magnets can be double the volume of the guide magnets.

The shape of pole and guide magnets is cubic with a one cubic inch volume for each magnet. In other embodiments, the volume of each polarity region can be maintained but a different shape can be used. In yet other embodiments, the polarity arrangement pattern can be maintained but different volume size can be used for each polarity region. For example, a single cubic magnet, with a 0.125 inch, 0.25 inch, 0.5 inch, 0.75 inch, 1 inch, 2 inch, 3 inch, 4 inch, 5 inch or more side can be used to provide each polarity region.

When twenty smaller cubic magnets are used, it is possible to arrange them around a smaller radius circle. When twenty larger cubic magnets are used, a larger radius circle is required. When the first polarity arrangement pattern is repeated more times and the magnet size is the same as in FIG. 28, a larger radius STARM is required. When the first polarity arrangement pattern is repeated less times and the magnet size is the same, a smaller radius STARM can be used. However, the magnets can also be arranged around the same radius but with a larger gap between magnets.

In FIG. 28, the pole and guide magnets which form the polarity arrangement pattern are arranged around a circle. In other embodiments, the magnets can be arranged around other shapes, such as a square or an oval. Some examples of using the first polarity arrangement pattern, but arranging the magnets around a different shape are described with respect to the Figures that follow.

In the FIG. 28, the bottoms of the twenty magnets are arranged in a plane which is near the bottom of the STARM 1200. The area of the bottom of the magnets is approximately twenty cubic inches, and the volume of the magnets is approximately twenty cubic inches. In various embodiments, the area of the bottom the magnets closest to the bottom of STARM 1200 divided by the Volume^{2/3} is greater than or equal to one, i.e., Area/Volume^{2/3}≧1.

For STARM 1200, the Area/Volume^{2/3} equals about 2.71. In other embodiments, this ratio can be greater than or equal to two. In yet other embodiments, the ratio can be greater or equal to three. In further embodiments, this ratio can be greater than or equal to four. In yet other embodiments, this ratio can be greater than or equal to five.

In FIG. 29, STARM 1200 is shown secured in an enclosure with top piece 1214 and a bottom piece 1216. The enclosure is formed from a number of the layers. In this example, layers of aluminum and polycarbonate plastic are used where layers 1214 and 1216 are formed from aluminum. Other materials are possible, and these examples are provided for the purposes of illustration only.

In one embodiment, the center region of the STARM 1200 can provide a large enough space such that a motor can fit in this region. In other embodiments, a motor can be mounted above the top side 1214 such that a top side of the magnets is beneath the motor. In yet other embodiments, a motor can be mounted to the side of the STARM 1200 and a transmission mechanism can be provided, such as a mechanism including belts and gears, to transfer a torque used to turn STARM 1200. If the STARM 1200 is bowl shaped, then the motor might fit partially or entirely below a top lip of the bowl.

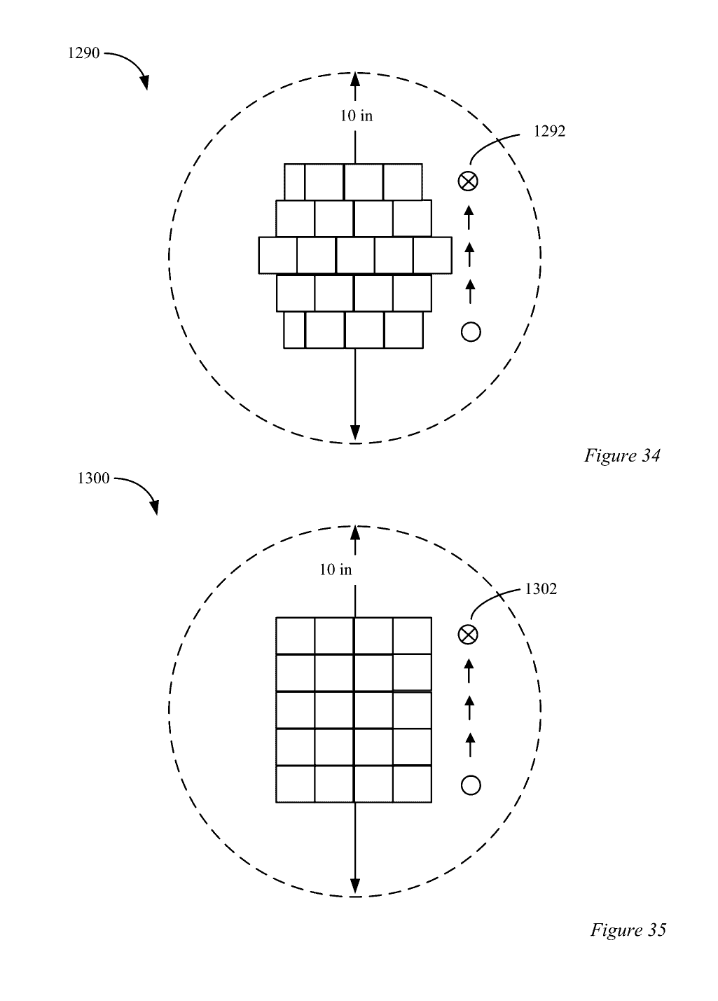

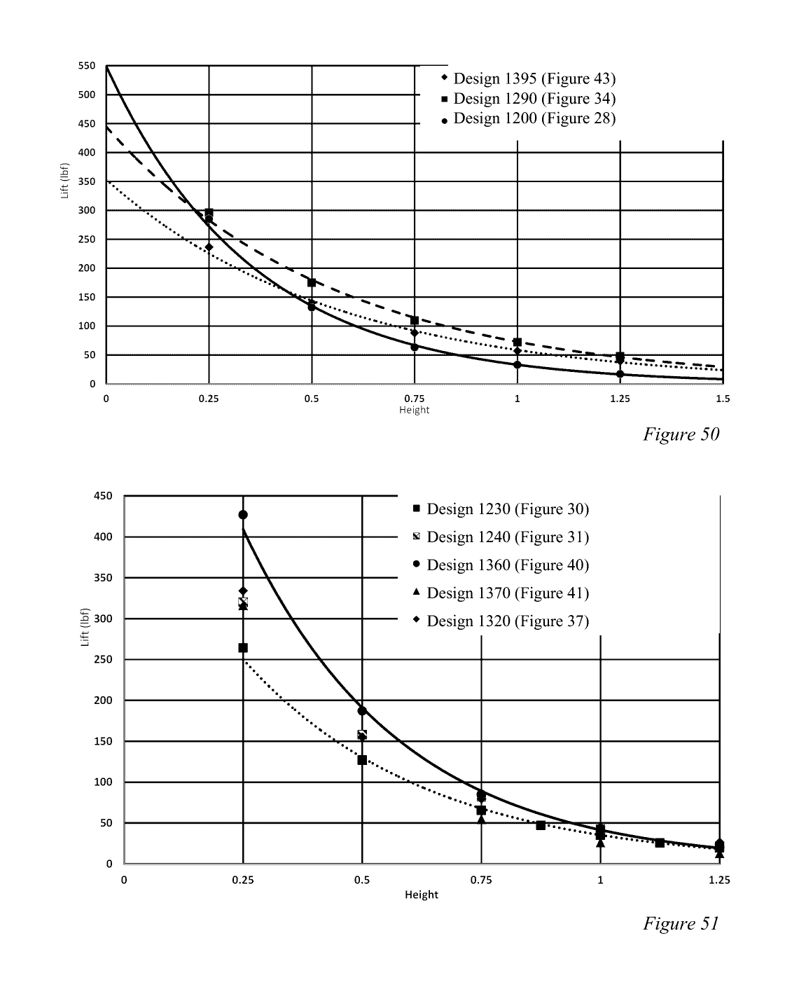

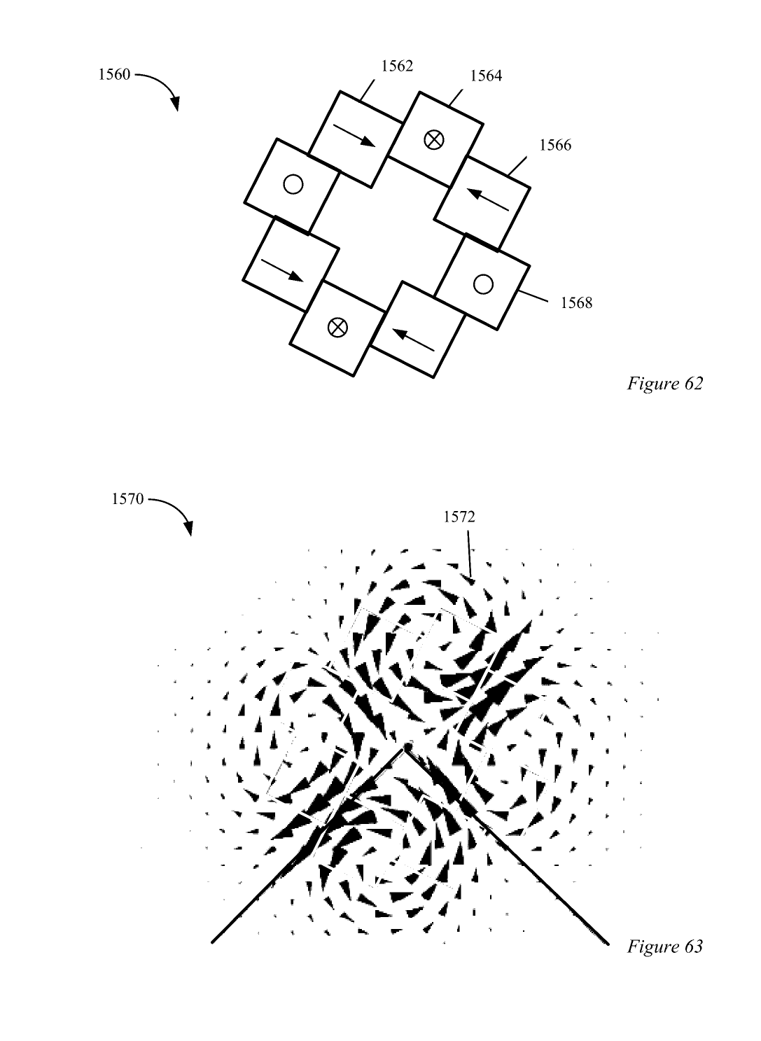

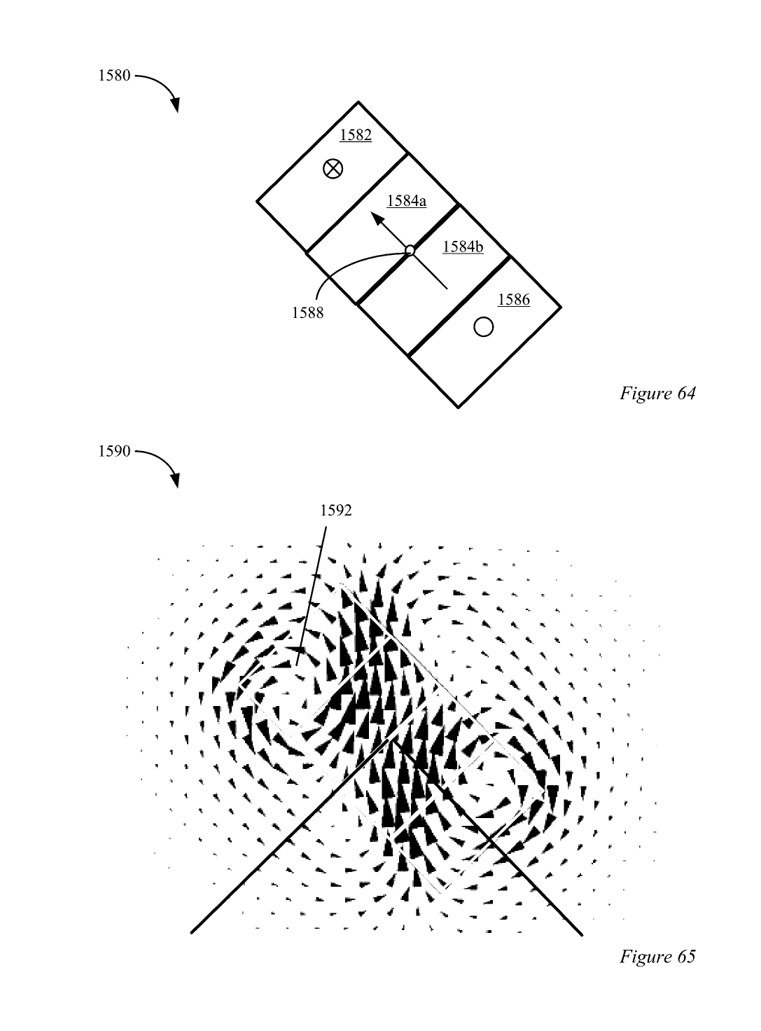

With respect to FIG. 29, a model was built and tested experimentally. In addition, the results were simulated using Ansys Maxwell. A comparison of the experimental and numerical results is shown in FIG. 48. A number of other designs were also simulated. These designs are described with respect to FIG. 30-41. In addition, numerical results are compared to one another in FIGS. 50 and 51. Finally, the numerical results predict eddy current patterns that are induced from the rotating the STARM. Some examples of these eddy current patterns for a number of different designs are illustrated in FIGS. 42 to 47.

In FIG. 30, a variation 1230 of the design 1200 in FIG. 28 is illustrated. In 1230, the number of magnets is twenty and the magnet volume is twenty cubic inches. The number of magnets is arranged around a larger circle as compared to design 1200. In particular, the radius of the circle is 4.25 inches, instead of 3.75 inches. The increased circle radius results in a larger spacing between adjacent magnets. In one embodiment, design 1230 is configured in a STARM with an outer diameter often inches. A numerical prediction of lift for this design is shown in FIG. 51.

A second variation 1240 of design 1200 is shown in FIG. 31. In 1240, the number of magnets is twenty and the magnet volume is twenty cubic inches. However, magnets with half the height are used. The magnets are two inches by 1 inch by ½ inch (L×W×H). The magnets are arranged with the same starting position as shown in FIG. 28. However, each of the magnets extend radially outward an extra inch. To accommodate the additional radial length of the magnets, the radial distance of a STARM can be increased. A numerical prediction of lift for this design is shown in FIG. 51.

The bottom area of the magnets is forty cubic inches. The area divided by the total volume^{2/3} is about 5.43. In alternate embodiments, while maintaining a constant volume, this ratio can be increased by lowering the height of the magnets and extending their radial length. For example, in FIG. 31, the height of the magnets can be lowered to ⅓ inches and the length can be extended to three inches radially. For this design, the bottom area of the magnets is sixty square inches and the area divided by total volume^{2/3} is about 8.14.

In 1240, a gap 1242 is shown between each magnet. In one embodiment, a magnet, such as triangle shaped magnet 1244 can be inserted in the gap. In one embodiment, the polarity of the gap magnet can be selected to match the polarity of the adjacent guide magnet or pole magnet. For example, the polarity of the adjacent guide magnet can be selected for all of the gap magnets, or the polarity of the adjacent pole magnet can be selected for all the gap magnets. In another embodiment, two triangular shaped magnets can be placed in the gaps where one of the magnets' polarities matches the adjacent pole magnet and the other matches the adjacent guide magnet. In yet another embodiment, the twenty magnets can be custom shaped such that the magnets fit together with minimal gaps.

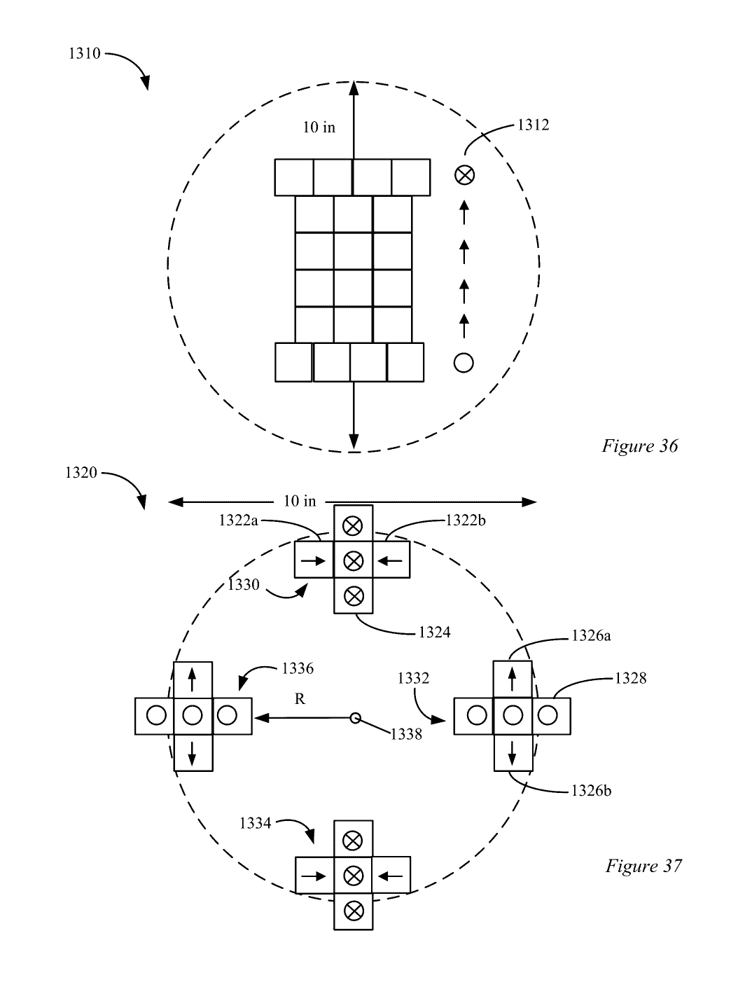

In FIG. 32, a different magnet arrangement 1250 with a number of different polarity arrangement patterns is shown. In 1250, twenty one-inch magnets, such as 1252, are provided which span through an axis of rotation of a STARM. The twenty magnets are arranged in a two by ten array. The magnets are arranged to induce two large eddy currents. The two induced eddy currents generally extend inwards towards the axis of rotation which is in the center of the circle.

Four different polarity arrangement patterns, 1254, 1256, 1258 and 1260, that produce the two eddy current pattern are shown. For the conditions simulated, pattern 1254 generated the most lift. However, significant lift is predicted for the other patterns. Pattern 1258 was predicted to generate the least amount of lift.

In one embodiment, a ferrite top was added to the design and simulated. In general, a material with a high magnetic permeability can be utilized. Some examples of these materials have been previously described. The numerical simulations predicted an increase in lift when a ferrite top is added to design 1250.

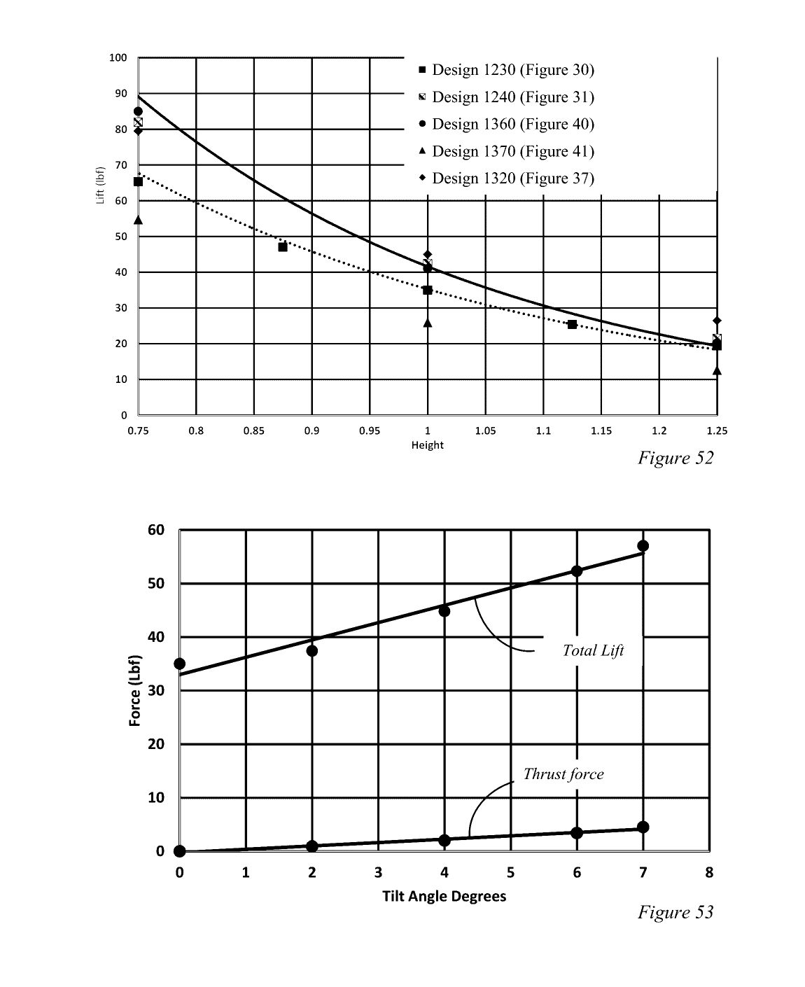

In another embodiment, a space can be introduced above the axis of rotation. This space can allow for an attachment of a rotational member to the STARM. Eddy currents patterns which are predicted for this design (with the spacing at the center) are shown in FIG. 43. The predicted eddy current patterns in FIG. 43 are similar to the eddy current patterns for design 1250.

In the example above, one cubic inch magnets do not have to be employed. For example, three magnets can be used to form polarity arrangement pattern 1254 where first and second magnets at the ends are three inches by two inches by one inch and a third magnet in the center is four inches by two inches by one inch. When fewer magnets are used, the assembly process may be simplified.

In FIG. 32, a total volume of guide magnets to pole magnets varies from two thirds (patterns 1254 and 1258) to 1.5 (patterns 1256 and 1262). The ratio of the volume of guide magnets to pole magnets can be varied outside of this range to optimize the lift generated for a particular volume of magnets and polarity arrangement pattern. In this example, the area of the bottom of the magnets is twenty inches and the volume is twenty inches. Like the design previously described with respect to FIG. 31, the area of the bottom of the magnets can be increased, while the volume is held constant by reducing the height of the magnets and spreading them out over a larger area.

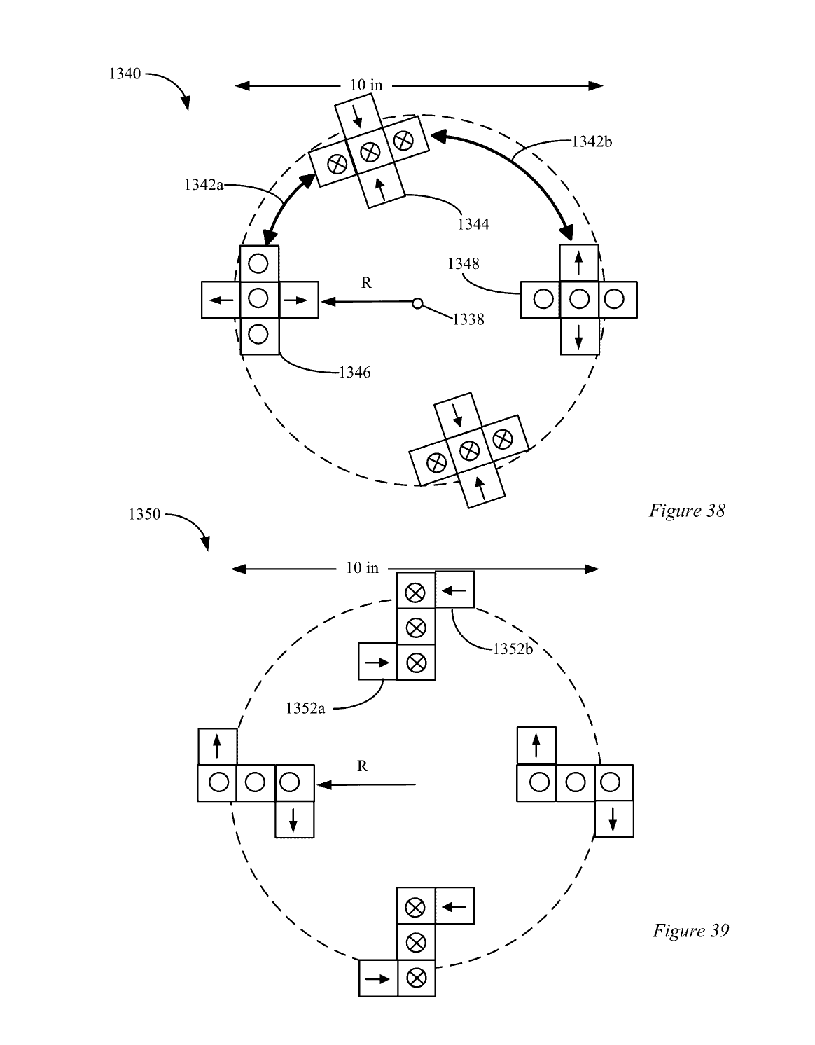

An alternate 1280 to design 1250 is shown in FIG. 33. The magnet volume is held constant between the designs. Further, the guide magnet to pole magnet ratio is the same as polarity arrangement pattern 1254, i.e., forty percent. However, the distance the design extends from the axis of rotation in the center of the circle is reduced.

In design 1280, the magnets extend about four inches from the axis of rotation, as compared to the design 1250 in FIG. 31. Further, the number of magnets per row is no longer constant. A reduction in the maximum distance the magnets extend from the centerline may allow the design to be formed on a smaller radius STARM. The numerical simulations predicted a similar amount of lift for designs 1250 and 1280.

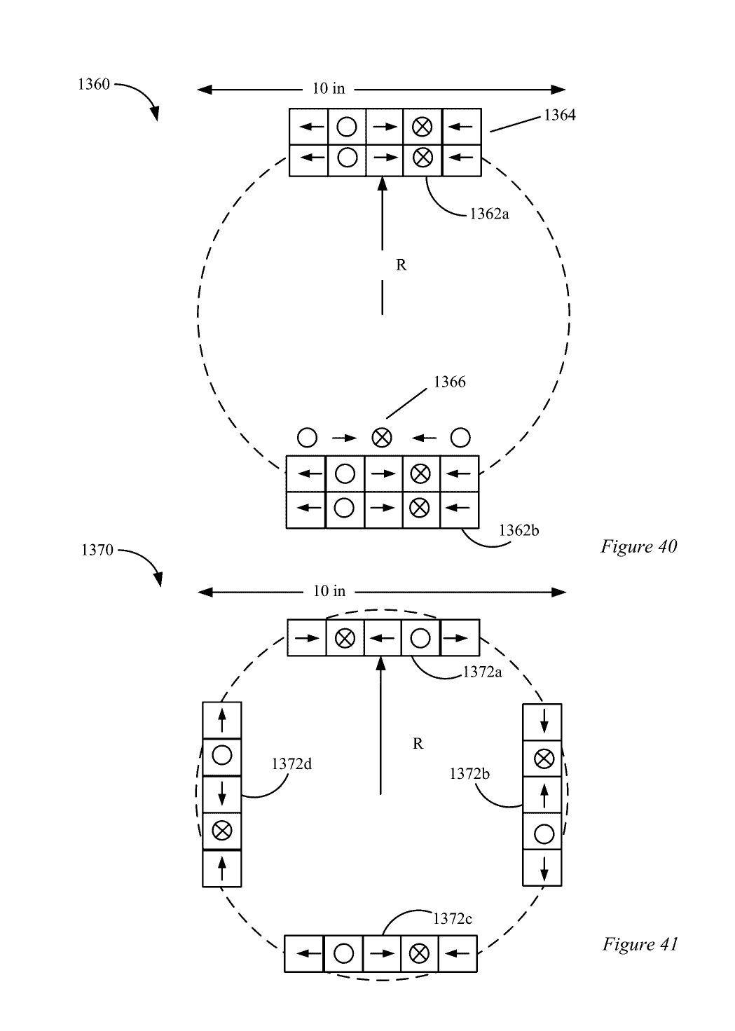

Yet another alternate to designs 1250 and 1280 is shown in FIG. 34, in which the number of rows is reduced to five. Five rows enable the magnets to fit in approximately a three-inch radius circle. A circle with a twenty-inch area has a radius of 2.52 inches, which is the smallest radius which can be used. Thus, design 1290 is approaching this limit, while employing rectangular shaped magnets.

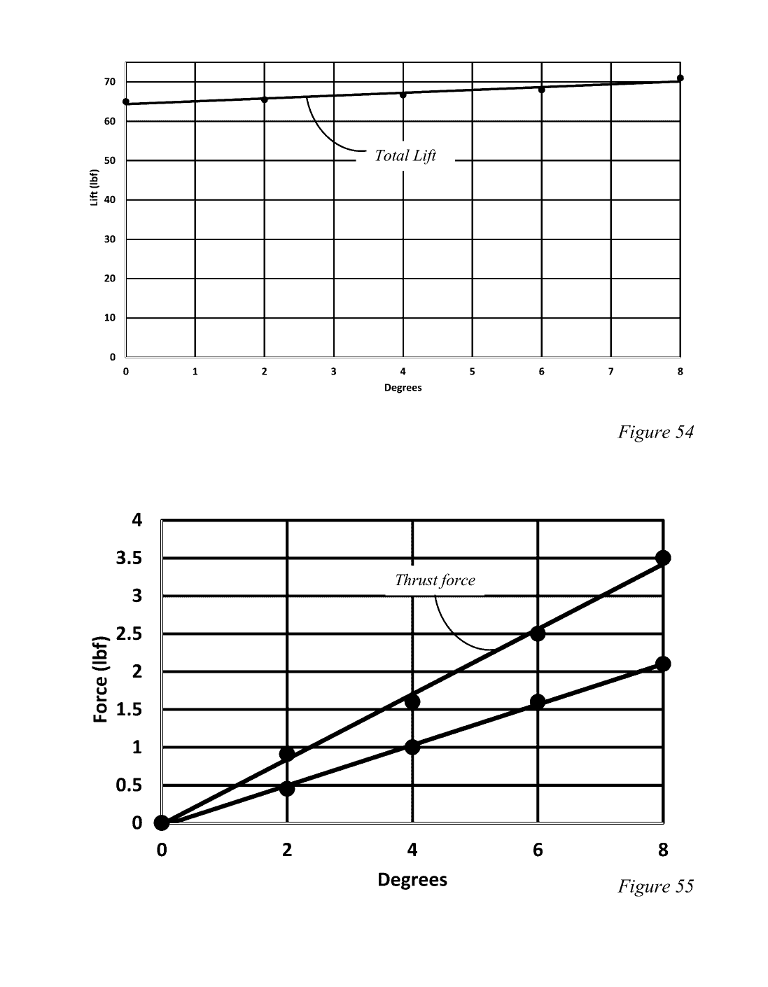

The polarity arrangement pattern 1292 is used for design 1290. Two poles and a single guide magnet polarity are used. The ratio of guide magnet volume to pole magnet volume is 1.86. A prediction of the eddy current patterns for design 1290 is shown in FIG. 44 and a prediction of the lift is shown in FIG. 50.

Yet another alternate 1300 to designs 1250, 1280 and 1290 is shown in FIG. 35. In design 1300, a five inch by four inch array of magnets is used. The polarity arrangement pattern 1302 is employed. The ratio of the guide magnet volume to the lift magnet volume is about 1.5. The lift and eddy current patterns predicted for design 1300 are similar to design 1290.

In FIGS. 34 and 35, in one embodiment, a small space in the magnet configurations can be provided near the axis of rotation to allow a rotation member to extend through the space and attach to the structure of the STARM. In another embodiment, a structure can be provided which extends over the top and sides of the magnets, and a rotational member can be secured to this structure.

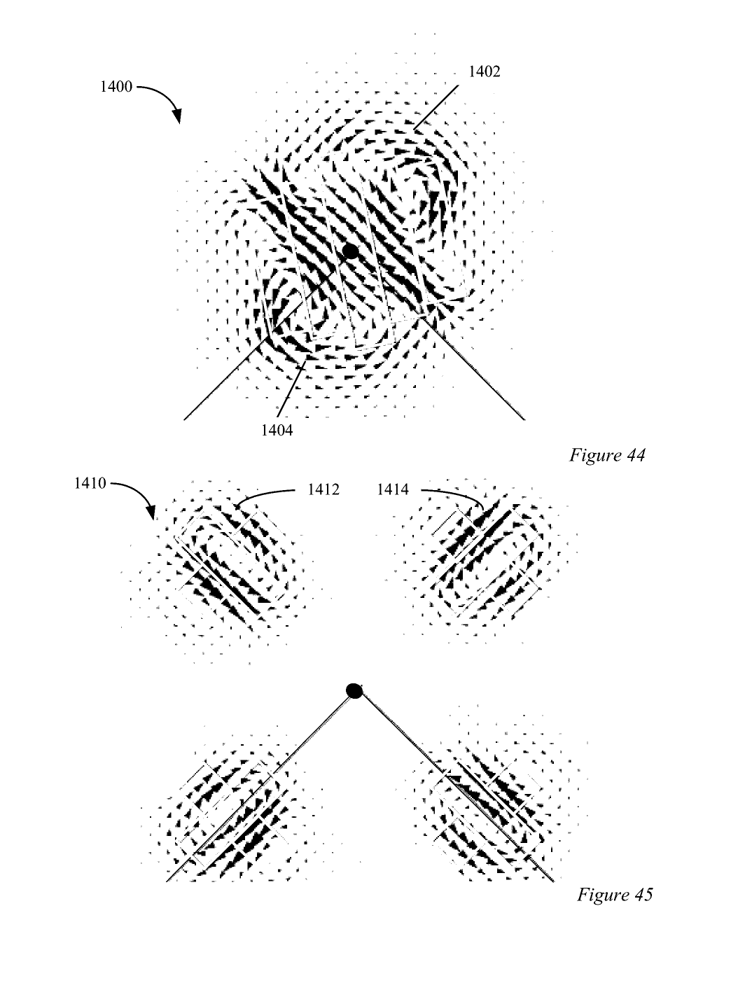

In FIG. 35, three rows of guide magnets and two rows of pole magnets are used. In design 1310 in FIG. 36, four rows of guide magnets are used and two rows of pole magnets are used. The volume of the magnets in the pole magnet rows is different than the volume of magnets in the guide magnet rows (four cubic inches as compared to three cubic inches). The addition of the extra row of magnets did not significantly affect lift predictions for design 1310 as compared to design 1300 shown in FIG. 35.

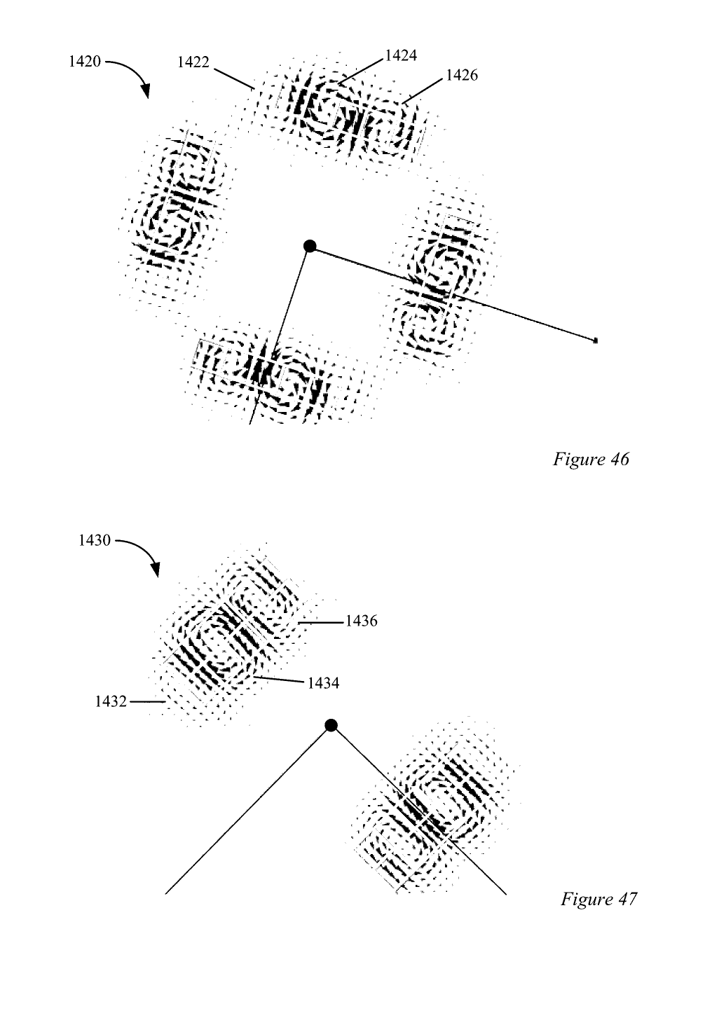

Another magnet configuration 1320 is shown in FIG. 37. Again, twenty one-inch cube magnets are shown. The magnets are arranged in four clusters, 1330, 1332, 1334 and 1336, each with five cubic inches of magnets. Each cluster includes pole and guide magnets.

As an example, cluster 1330 includes a pole section 1324 with three cubic inch magnets. The magnets in the pole section are arranged in along a radial line. The pole section 1324 is orientated to point into the page. Two guide magnets 1322a and 1322b point towards the center of the pole. The ratio of the guide magnet volume to pole magnet volume is ⅔.

Cluster 1332 includes pole section 1328. The pole section includes three one-inch cube magnets aligned along a radial line from the axis of rotation 1338. The polarity of the magnets in the pole section 1328 is out of the page, i.e., the open circles represent a north poles and the circles with “X” inside represent a south pole. Two guide magnets 1326a and 1326b are provided. The polarity of the guide magnets is away from the pole section 1328.

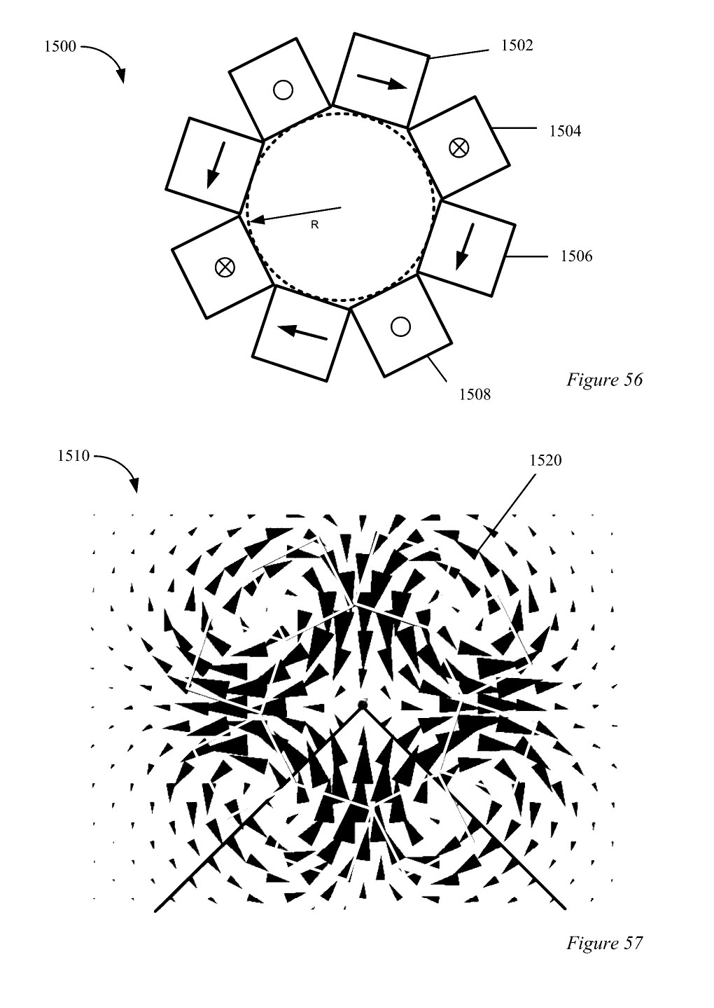

The clusters 1330 and 1332 provide a polarity arrangement pattern. This pattern is repeated with clusters 1334 and 1336. In various embodiments, a STARM can be formed with only clusters 1330 and 1332 or the polarity arrangement pattern can be repeated once, twice, three, four times, etc. A prediction of the eddy currents for design 1320 are presented in FIG. 45 and prediction of lift for the design are presented in FIG. 51.

In various embodiments, the ratio of the guide magnet volume to pole magnet volume can be varied. Further, each individual cluster can be rotated by some angle. For example, the pole section can be aligned perpendicularly to a radial line from the axis of rotation 1338. In addition, the volume of magnets in each cluster can be varied. Also, the radial distance of the magnets from the center axis of rotation 1338 can be varied.

Yet further, the shape of the pole sections, such as 1324 and 1328, can be varied. For example, the pole sections 1324 and 1328 can be formed as a single cylindrically shaped magnet with a volume of three cubic inches, such as a one-inch high cylinder with a radius of about a 0.98 inches or a ½ inch high cylinder with about a 1.38 inch radius. In the example of design 1320, the guide magnets in each cluster are arranged along a line. In other embodiments, the guide magnets do not have to be arranged along a line. The shape of the guide magnets can also be varied.

A variation 1340 of design 1320 is shown in FIG. 38. In 1340, the clusters, such as 1344 and 1346, are rotated ninety degrees as compared to design 1320 such that the pole sections in each cluster are arranged perpendicularly to a radially line from the axis of rotation 1338. In addition, the distances between clusters, such as the distance 1342a between clusters 1344 and 1346 or the distance 1342b, can be varied.

In design 1320 in FIG. 37, the distances were equal. In this example, distance 1342a is less than distance 1342b. Simulations indicated that bringing adjacent clusters together can result in an interaction between the eddy currents produced by the clusters. For the conditions simulated, this interaction produced an increase in overall lift, as compared to when the clusters were equally spaced as shown in FIG. 37. The interactions are non-linear. Thus, this result may not hold for all conditions.

Another variation 1350 of design 1320 is shown in FIG. 39. In design 1350, like design 1320, the pole sections are arranged along a radial line from the axis of rotation. However, the guide magnets are no longer arranged along a single line. In particular, the guide magnets 1352a and 1352b are arranged at the ends of the pole sections. Simulations predicted that this polarity arrangement pattern provide about the same amount of lift as design 1320.

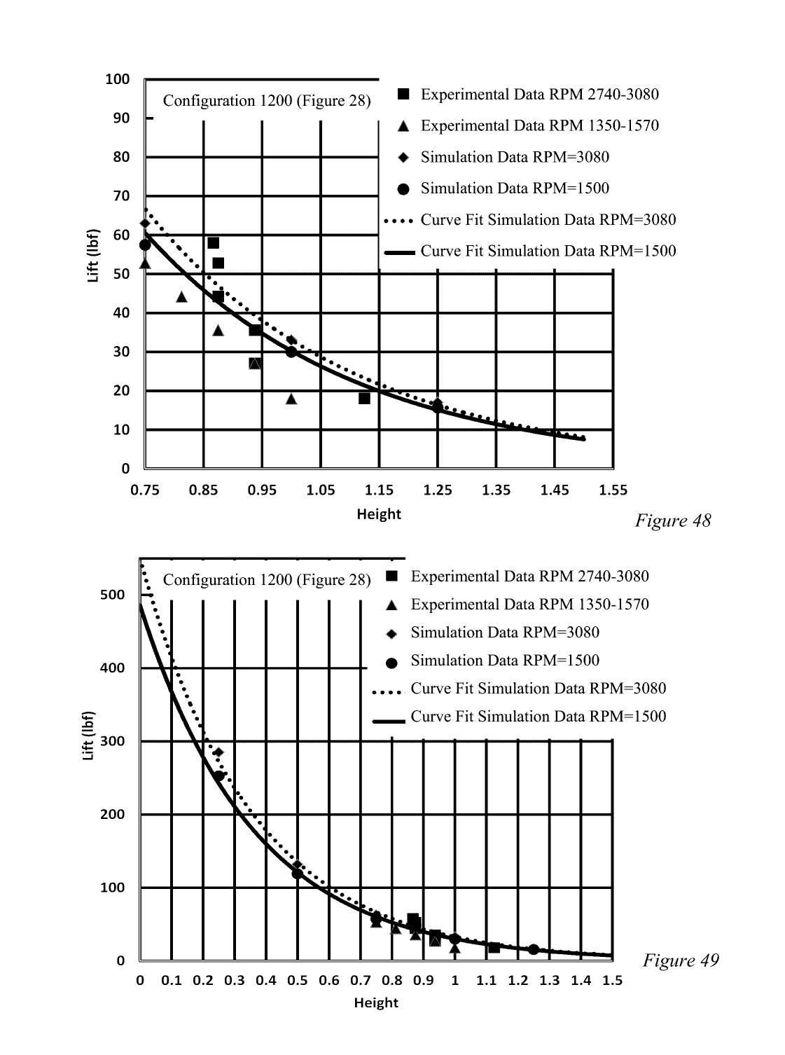

Yet another magnet configuration is described with respect to FIGS. 40 and 41. In this configuration, the magnets are clustered and arranged in a line where the amount of clusters can be varied. The designs 1360 and 1370 in FIGS. 40 and 41 each include twenty cubic inches of magnets. In design 1360, the magnet volume is divided into two rectangular clusters of ten cubic inches each, 1362a and 1362b. In design 1370, the magnet volume is divided into four clusters, 1372a, 1372b, 1372c and 1372d, each with five cubic inches of magnets in each cluster.

A single cluster of twenty cubic inches of magnets can be provided. This design might be incorporated on a STARM with a single arm or a circular STARM with a counter weight to balance the weight of the magnets. In general, one, two, three, four or more clusters can be distributed over a STARM.

Two polarity arrangement patterns 1364 and 1366 are shown. These arrangements can be repeated on each cluster. Pattern 1364 includes two pole regions. Pattern 1366 includes three pole regions. In pattern 1364, the ratio of guide magnet volume to pole magnet volume is 1.5. In pattern 1366, the ratio of guide magnet volume to pole magnet volume is about ⅔. The ratio of the bottom area of the magnets (20 square inches) relative to the Volume^{2/3} of the magnets is about 2.71. Again, like the other designs, this ratio can be varied.

In various embodiments, the ratio of guide magnet volume to pole magnet volume can be varied for patterns 1364 and 1366. In addition, the radial distance from the center axis of rotation can be varied. The radial distance affects the moment of inertia. Further, the relative velocity of the magnets relative to the substrate varies with RPM of the STARM and the radial distance. Thus, the radial distance can be selected to obtain a desired relative velocity which is compatible with the RPM output capabilities of the motor and is compatible with packaging constraints.

In FIGS. 40 and 41, the magnets in each cluster are arranged in rectangles and are configured to touch one another. In various embodiments, the aspect ratio of the length relative to the width of the rectangular clusters can be varied as is shown in FIGS. 40 and 41. Further, spacing can be provided between the magnets in a polarity region or between different polarity region in the polarity arrangement patterns 1364 and 1366. The spacing might be used to allow structure which secures the magnets. Further, the magnets don't have to be arranged to form a rectangle. For example, the magnets can be arranged in arc by shifting the magnets relative to one another while allowing a portion of each adjacent magnet to touch. In general, many different types of cluster shapes can be used an example of a rectangle is provided for the purposes of illustration only.

Next some eddy current patterns for some of the different magnet configurations are illustrated in FIGS. 42 to 47. In the Figures, the arrows indicate a direction of current on the surface of a conductive substrate. The relative magnitude of the current is indicated by a size of the arrows. The eddy current patterns were generated using a finite element analysis to solve Maxwell's equations. The materials and their physical properties are modeled in the simulation.

The simulations were performed using Ansys Maxwell. The simulations used a ½ inch copper plate. The distance from the surface was 0.25 inches. The eddy current patterns remained similar when height was varied. However, the strength of the eddy currents increased as the height above the surface decreased. Peak currents observed for the simulations varied between about three to eight thousand amps per cm² at a 0.25 in height above the surface. The current decreased with depth into the copper.

The RPM value used for the simulations was 3080 RPM except for results shown in FIG. 44. In FIG. 44, a value of 6000 RPM was used. The reasons for using a different RPM value are discussed in more detail with respect to FIGS. 50 and 51.

In FIG. 42, the magnet configuration and polarity arrangement pattern described with respect to FIG. 28 is employed. The polarity arrangement pattern includes ten poles and ten guide magnets. Ten eddy currents, such as 1382 and 1384, are generated to form eddy current pattern 1380.

An eddy current each forms around a pole and guide magnet pair, such as 1386 (pole) and 1388 (guide). The eddy currents spin in alternating directions. The current strength varies around the circumference of the eddy current so that the strongest currents occur where the eddy currents meet and interact with one another. For each pair, the strongest current sets up under a guide magnet, such as 1388.

The simulations indicated in this configuration that the poles generate negative lift and the guide magnets provide lift. When lift from the guide magnets is greater than the pull from the pole magnet, a net lift is generated. Without being bound to a particular theory, it is believed the enhanced current strength due to the eddy current interacting, which passes under the guide magnets, enhances the lift which is generated.

Pattern 1380 is a snap shot at a particular time. In the simulation, the STARM and the magnets rotate according to the proscribed RPM value. Thus, the eddy currents such as 1382 and 1384 do not remain stationary but follow the magnets around as the magnets rotate according to the RPM rate.

In FIG. 43, an eddy current pattern for a variation 1395 of design 1250 in FIG. 32 is shown. The design 1395 includes a small gap 1392 near the axis of rotation. As described above, the gap can be used to mount a rotational member to a STARM. In this design the STARM structure does not have to be cylindrical. For example, a box shaped design may be used to carry and secure the magnets. Thus, the structure used for the STARM may be reduced for this configuration as compared to a circular magnet configuration.

The polarity arrangement pattern 1254 is used. The polarity arrangement pattern includes two pole sections. The two pole sections generate two large eddy currents 1394 and 1396. The simulations predicted that positive lift was generated from the guide magnets in the polarity arrangement pattern and negative lift was generated from the pole magnets. The lift predictions for the configuration as a function of height are shown in FIG. 50.

In FIG. 44, an eddy current pattern 1400 for the design 1290 in FIG. 34 is shown. The simulation predicts design 1290 produces two eddy currents, 1402 and 1404. The current from the two eddy currents merge near the axis of rotation while passing under the three guide magnets in the center. The simulations predict the positive lift is generated from the current passing under these guide magnets. Again, the simulations predict a negative lift or pull being generated from the pole magnet sections.

In FIG. 45, an eddy current pattern 1410 for the design 1320 in FIG. 37 is shown. The simulation predicts design 1320 produce four eddy currents, such as 1412 and 1414. An eddy current forms around each cluster, which circulates around the pole sections. The simulations predict the positive lift is generated from the current passing under the guide magnets which abut the pole section in each cluster. Again, the simulations predict a negative lift or pull being generated from the pole sections in each cluster.

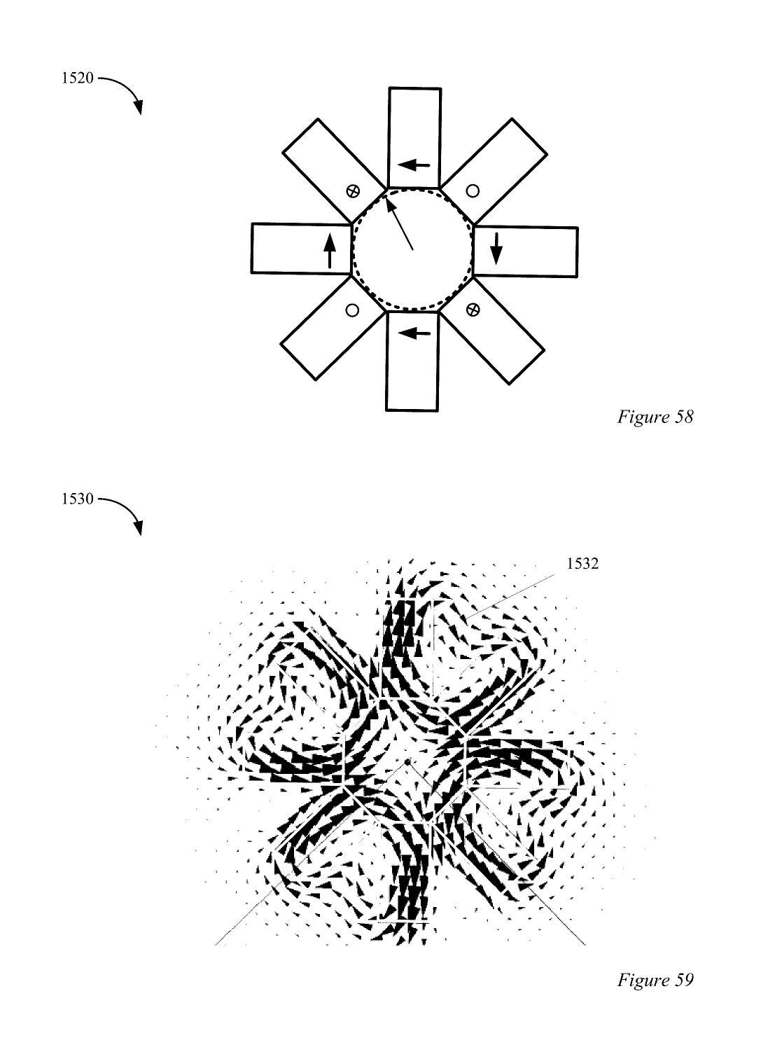

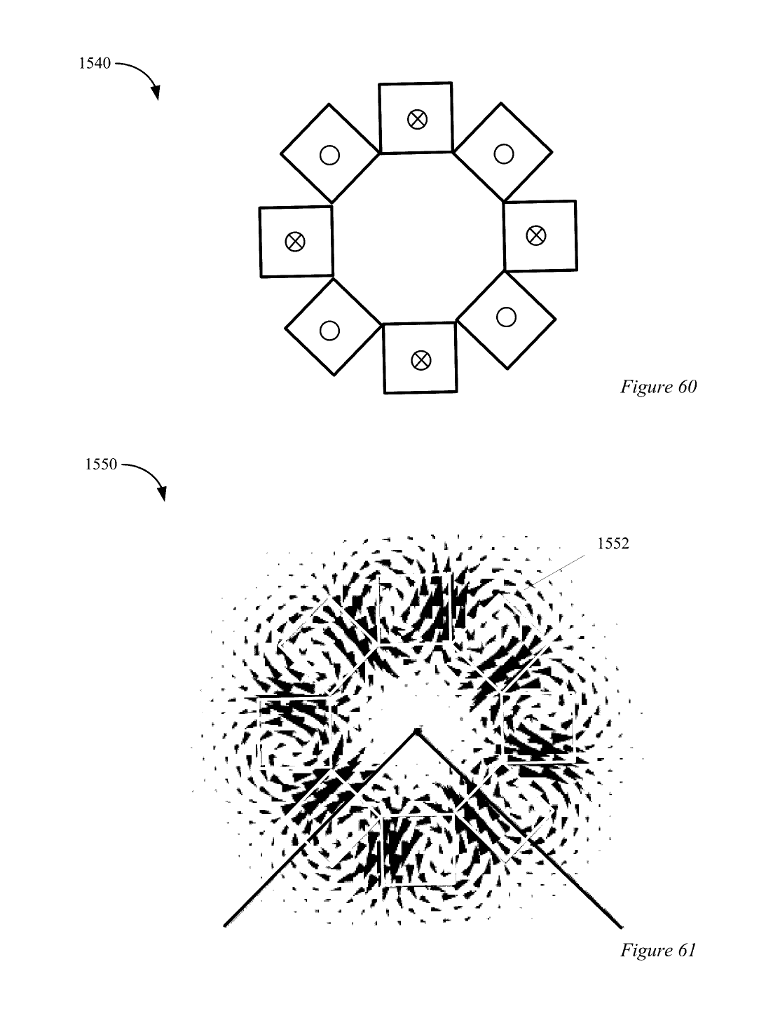

In FIGS. 46 and 47, eddy current patterns 1420 and 1430 for the designs 1370 and 1360 in FIGS. 41 and 40, respectively, are shown. The simulations predict three main eddy currents are formed for each cluster, such as 1422, 1424 and 1426 or 1432, 1434 and 1436. The magnets rotate counter clockwise and the lead eddy currents, 1422 and 1432, are weaker than the two eddy currents, which form under each rectangular cluster.

In each cluster, the strongest eddy currents set up under the guide magnets. The simulations predict the positive lift is generated from the current passing under the guide magnets. Again, the simulations predict a negative lift or pull being generated from the pole sections.

The two designs 1360 and 1370 use the same volume of magnets. However, as shown in FIG. 51 more lift is predicted for design 1360, which uses two clusters, as compared to design 1370. Without being bound to a particular theory, it is believed that the design in FIG. 47 strengthens and concentrates more current underneath the guide magnets in the cluster which generates more lift.

Next, with respect to FIGS. 48 and 49, lift predictions derived from simulation of the design in FIG. 28 are compared to experimentally measured data. Next, the lift predictions derived from simulations are compared for various designs.

To obtain the experimental data, the STARM shown in FIGS. 28 and 29 is coupled to a QSL-150 DC brushless motor from Hacker Motor (Ergolding, Germany). The motor was powered by batteries. The batteries used were VENOM 50C 4S 5000MAH 14.8 Volt lithium polymer battery packs (Atomik RC, Rathdrum, Id.). A structure was built around the motor and batteries. A vehicle including the batteries, motor, STARM and structure weighed 18 lbs. A Jeti Spin Pro Opto brushless electronic speed controller (Jeti USA, Palm Bay, Fla.) was used to control the current supplied to the motor and hence its RPM rate.

The vehicle was started in a hovering position. The height, RPM and other measurements were taken. Then, additional weight, in various increments, was added. The additional weight lowered the hover height of the test vehicle. Height measurements were made at each weight increment. In a first test, the initial RPM rate was 3080 with the test vehicle unloaded and then decreased as weight was added. In a second test, the RPM rate was initially 1570 with the test vehicle unloaded. Table 1 below shows the experimentally measured data for test #1 and test #2. The table includes the total vehicle weight including the payload, the RPM of the motor, the amps drawn, and voltage. These quantities were used to generate power consumption. Finally, the hover height of the vehicle was measured by hand. The height is shown to remain constant at a number of different height increments. The constant height was attributed to inaccuracies in the hand measurements.

TABLE 1
Experimentally Measured Data using Design 1200 in FIG. 28

| | | | | | |
|---|---|---|---|---|---|
| Weight including | | | | Power | Height |
| Payload (lbs) | RPM | Amps | Volts | (W) | (in) |

Test#1

| | | | | | |
|---|---|---|---|---|---|
| 18 | 3080 | 12.1 | 61.6 | 745 | 1.125 |
| 27 | 3000 | 15.4 | 60.8 | 936 | .9375 |
| 35.6 | 2915 | 19.5 | 60 | 1170 | .9375 |
| 44.2 | 2855 | 22.7 | 59.4 | 1348 | .875 |
| 52.8 | 2780 | 26.8 | 58.6 | 1570 | .875 |
| 58 | 2740 | 29.4 | 58.1 | 1708 | .8667 |

Test#2

| | | | | | |
|---|---|---|---|---|---|
| 18 | 1570 | 10.3 | 49.4 | 509 | 1 |
| 27 | 1480 | 13.9 | 49.3 | 685 | .9475 |
| 35.6 | 1420 | 17.4 | 49.3 | 858 | .875 |
| 44.2 | 1390 | 20.8 | 49.2 | 1023 | .8125 |
| 52.8 | 1350 | 24.4 | 49.1 | 1198 | .75 |

To access the accuracy of the simulations of the STARM design in FIG. 28, a constant RPM value was selected and then the distance from the bottom of the magnets to a ½ inch copper plate is varied. FIG. 48 shows a comparison of the numerical simulations with the experimental data from tests number one and two between a height of three quarters of an inch and one and one quarter of an inch. The numerical simulations are curve fit with an exponential. The curve fits are represented by the dashed and solid lines.

The simulations were generated at heights of 0.25 inches, 0.5 inches, 0.75 inches, 1 inch and 1.25 inches. The curve fits were extrapolated to heights of zero inches and to 1.5 inches. In FIG. 49, the experimental data and simulated data is shown from a height range of zero to 1.5 inches.

Next with respect to FIGS. 50, 51 and 52, various designs are described. To compare designs, an average velocity of the bottom of the magnets relative to the top surface of the conductive substrate is considered. In some of the designs, this value was held constant. The average velocity of the magnets relative to the surface can be estimated as an average distance of the bottom of the magnets to the axis of rotation times the RPM rate converted into radians.

The average velocity was calculated because at higher velocities, the lift tends to increase and the drag tends to decrease as a function of the velocity of the magnets relative to the surface. In FIG. 50, the average distance from axis of rotation to the bottom of the magnets was about 2.81 inches for design 1395, 1.56 inches for design 1290 and 4.25 inches for design 1200.

All of the simulations were run at 3080 RPM except for design 1290, which was run at 6000 RPM. The RPM value was increased because the average distance was so much lower for this design and, hence, the average velocity was much lower than other designs when an RPM of 3080 was selected. Based upon these RPM values, the average velocity of design 1395 is 75.2 feet/s, the average velocity of design 1290 is 81.7 feet/s and the average velocity of design 1200 is 114.2 feet/sec.

For the designs in FIGS. 51 and 52, the average distance from the axis of rotation is 4.75 inches and the RPM value is 3080. Thus, the average velocity relative to the surface for the five designs is the same and is 127.6 feet/s. FIGS. 51 and 52 show the same designs. However, in FIG. 52, the height range and lift ranges are narrowed so that the differences between the designs can be discerned.

The numerical results were generated at 0.25, 0.5, 0.75, 1 and 1.25 inches. Some of the numerical results were curve fit using an exponential equation. In FIG. 50, design 1290 is predicted to generate the most lift above 0.75 inches. Below 0.25 inches, the curve fits predict design 1200 will generate more lift. Design 1290 generates more lift at the greater height values than the other designs even with a lower average velocity of the bottom of the magnets relative to the surface, as compared to the other designs.

In FIGS. 51 and 52, the predicted lift as a function of height is presented for five designs. The curve fit with the solid line is an exponential fit of the data for design 1360 in FIG. 40, which includes two linearly arranged clusters of magnets with ten cubic inches of magnets per cluster. The curve fit with the dotted line is an exponential fit of the circularly arranged magnets for design 1230 in FIG. 30.

The five designs in FIGS. 51 and 52 each use the same volume of magnets of the same strength. The magnets are arranged such that the average velocity of the magnets relative to the surface is the same. The lift predictions for the different magnet arrangements vary from arrangement to arrangement. The performance between designs varies between heights. For example, the predicted lift for design 1360 is largest of the five designs at 0.25 and 0.5 inches. However, at 1 inch and 1.25 inches, designs 1320 and 1240 are predicted to generate more lift.

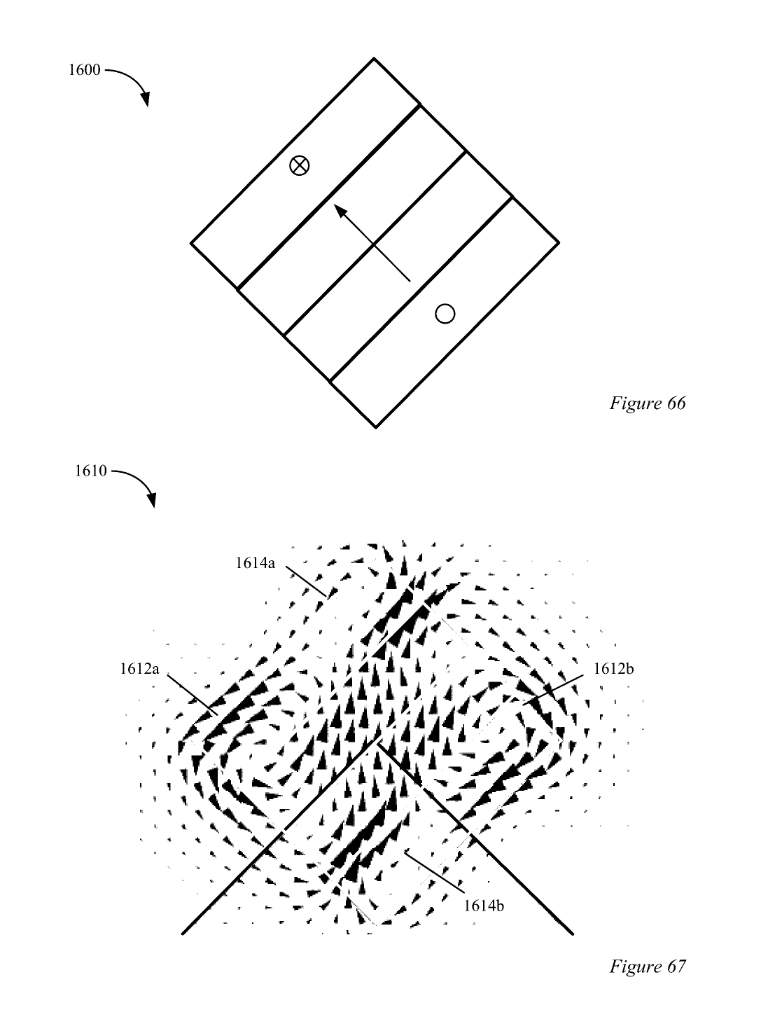

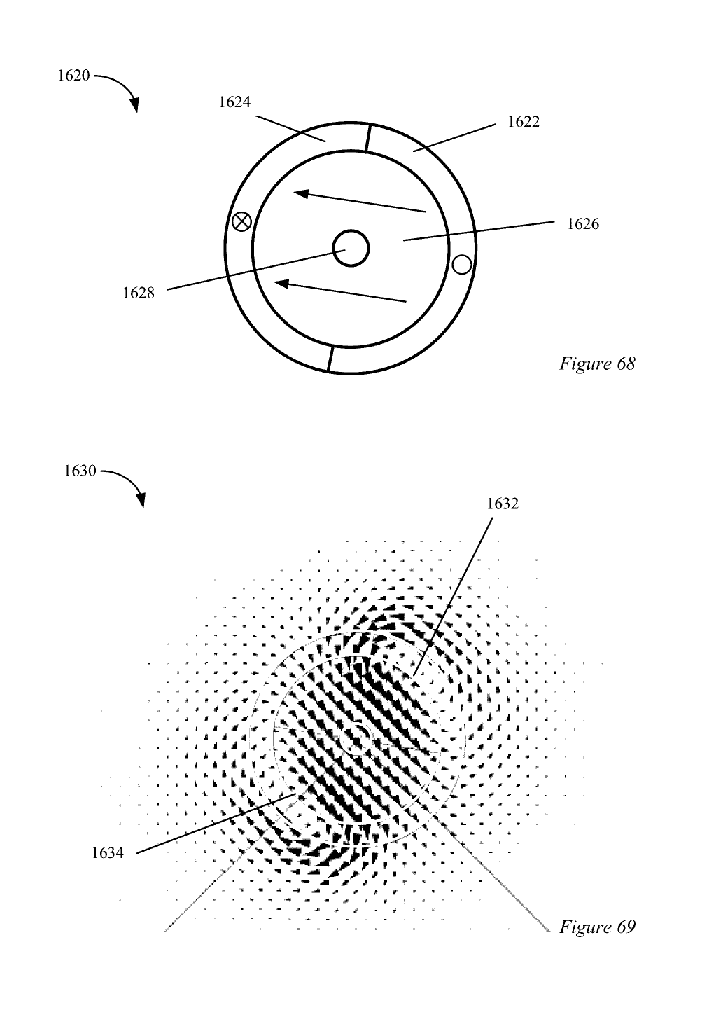

Next, with respect to FIGS. 53, 54 and 55, lift predictions and thrust predictions are made as a function of tilt angle of the STARM. In FIG. 53, predictions of total lift and thrust force as a function of tilt angle are shown for design 1200 shown in FIG. 28. In FIG. 54, the predicted total lift as a function of tilt angle is shown for design 1290 in FIG. 34.

In FIG. 55, the predicted thrust force as a function of tilt angle for design 1290 in FIG. 34 is shown. For design 1290, the thrust force varies as the magnet configuration rotates relative to the surface. It oscillates between a minimum and maximum value. The maximum and minimum values for each tilt angle are shown in the Figure.

In FIG. 53, the tilt angle is varied between zero and seven degrees. A one-inch height above the surface of the tilt axis is simulated where the STARM is rotated at 3080 RPM. Thus, the distance of part of the STARM to the surface of the substrate is greater than one and the distance of part of the STARM is less than one. However, the average distance from the bottom of the STARM to the substrate is one inch. In FIGS. 54 and 55, the tilt angle is varied between zero and eight degrees. A one-inch height above the surface of the axis of rotation is again simulated where the STARM is rotated at 6000 RPM.

In FIGS. 53 and 54, the total lift is predicted to increase with tilt angle. The effect is greater for design 1200 as compared to design 1290. In some embodiments, a STARM can be fixed at angle greater than zero to take advantage of the greater lift which is generated. At the tilt angles considered, the total lift appears to increase linearly with angle.

In FIGS. 53 and 55, the thrust force increases with tilt angle. At the tilt angles considered, the thrust force increases linearly with angle. A greater thrust force is predicted design 1200 in FIG. 53 as compared to design 1290 in FIG. 55 even though a larger total lift is predicted for 1290, as compared to design 1200. Thus, in some embodiments, design 1200 might be selected for generating thrust, whereas design 1290 might be selected for generating lift. As described above with respect to FIG. 37, STARMs can be specialized to generate lift or thrust forces. Based upon these simulations, some designs may be more suitable for generating lift forces and other designs may be more suitable for generating thrust forces.

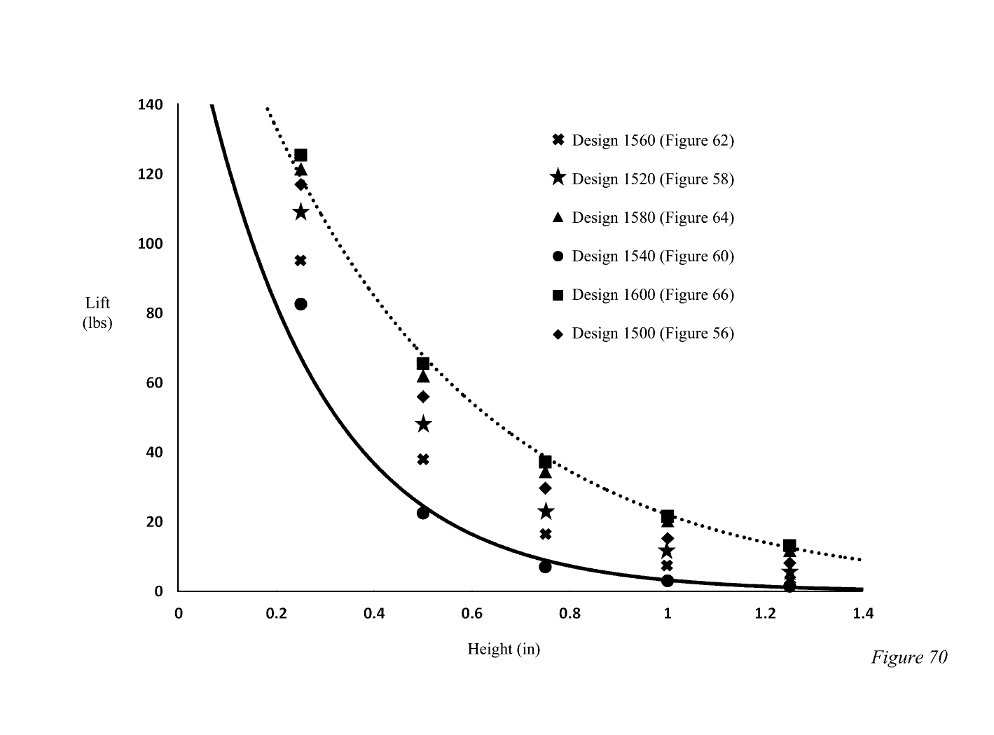

Next, with respect to FIGS. 56-70 some magnet configurations using eight cubic inches of magnets are described. In FIG. 56, magnet configuration 1500 is shown. The magnet configuration includes the polarity alignment pattern shown in magnets 1502, 1504, 1506 and 1508 repeated once. It is formed from eight one-inch cube magnets. The magnet configuration 1500 includes four pole magnets and four guide magnets. The polarity alignment pattern, which is repeated, is the same as the one shown in FIG. 28 for design 1200. Thus, variations described with respect to FIG. 28 can be adopted. The ratio of the bottom area of the magnets to the total volume^{2/3} is two.

Simulations were generated using the magnet configuration 1500. The simulations were carried out over a ½ inch copper plate at 6000 RPM at various heights. In the following figures, eddy current patterns from the simulations are shown. A height of 0.25 inch above the surface is utilized.

In FIG. 57, the eddy current patterns 1510 from the simulation are shown. The polarity arrangement pattern is the same is in FIG. 56. Four eddy currents, such as 1520, are predicted. The eddy currents each include a guide magnet and a pole magnet. For example, eddy current 1520 includes guide magnet 1502 and pole magnet 1504. The strongest current primarily sets up under the guide magnets, such as 1502 and 1506.

In FIG. 58, the magnet polarity arrangement pattern is the same as in FIG. 56. The magnets are 0.5 inch high by two inches long by one inch wide. Thus, the bottom area of the magnets is sixteen. Thus, the ratio of the area of the bottom of the magnets to the total volume^{2/3} is 4.

The predicted eddy current pattern 1530 is shown in FIG. 59. The polarity arrangement pattern in FIGS. 58 and 59 are the same. Four eddy currents, such as 1532, are predicted. The eddy currents with the lengthened magnets provide a clover leaf shape.

In FIG. 60, a configuration 1540 of eight cubic inch magnets is arranged in the same configuration as FIG. 56. However, the polarity arrangement pattern is different. In 1540, an alternating North-South distribution of magnet poles is used. Thus, the ratio of the guide magnet volume to the pole magnet volume is zero. The eddy current pattern 1550 is shown in FIG. 61. Eight eddy currents, such as 1552, are predicted, i.e., one for each pole magnet.

In FIG. 62, a configuration 1560 of eight cubic inch magnets is arranged such that a portion of each of two sides of each magnet is contact with an adjacent magnet. The polarity arrangement pattern shown in magnets 1562, 1564, 1566 and 1568 provides two guide magnets 1562 and 1566, which are aligned along a line and have a polarity direction which points to the pole magnet 1564. This pattern is repeated once.

The eddy current pattern 1570 is shown in FIG. 63. Four eddy currents, such as 1552, are predicted. Each eddy current includes a guide magnet and a pole magnet pair.

In FIG. 64, a configuration 1580 including a four magnet array of two inch by one inch by one inch magnets is shown. The magnet array spans the axis of rotation 1588. The polarity arrangement pattern includes pole magnets, 1582 and 1586 on each end. Between the pole magnets a guide magnets 1584a and 1584b are provided. The guide magnet polarity points from pole magnet 1586 to pole magnet 1582.

The eddy current pattern 1590 is shown in FIG. 65. Two eddy currents, such as 1592, are predicted. The two eddy currents interact with one another to provide strong current under the guide magnets in the center of the array.

In FIG. 66, a configuration 1600 of four magnets is shown. The magnets in the array are one half inch high by four inches long by one inch wide. Thus, the volume is eight cubic inches as in the previous designs. The polarity arrangement pattern is the same as in FIG. 64.

The eddy current pattern 1610 is shown in FIG. 67. Two main eddy currents 1612a and 1612b are predicted. Possible secondary eddy currents 1614a and 1614b, which are somewhat integrated with the main eddy currents are shown. Again, a large amount of current is generated under the guide magnets in the center of the configuration 1600.

In FIG. 68, a configuration 1620 a configuration of three magnets arranged in a disk is shown. The volume of the three magnets is eight cubic inches. The center magnet 1626 is disk shaped and includes an aperture 1628. The aperture 1628 can allow a rotational member to be mounted through the center magnets. Magnets 1622 and 1624 surround the disk 1626 to form a ring. The polarity alignment pattern assigned to the three magnets is similar to the pattern shown in FIGS. 64 and 66.

In alternate embodiment, all of the magnets can be assigned to be a guide magnet with the polarity of magnet 1626. Then, a single disk magnet can be employed. This polarity alignment pattern can also be used for design 1580 in FIG. 64 and design 1600 in FIG. 66. Using only guide magnets, lift is predicted. However, the predicted lift is less than when a combination of guide magnets and pole magnets is used.

In various embodiments, the arc length of magnets 1622 and 1624 can be smaller such that the magnets no longer form a ring. For example, the arc length of magnets 1622 and 1624 can be ninety degrees as opposed to the one hundred eighty degrees, which is shown. In addition, the radial width of the magnets, 1622, 1624 and 1626, can be made larger or smaller. In another embodiment, aperture 1628 can be made smaller, larger or removed.

In FIG. 69, the eddy current pattern 1630 predicted for the design is illustrated. Two eddy currents 1632 and 1634 are predicted. The two eddy currents interact to generate a region of concentrated current under disk shaped magnet 1626. The lift predicted for this design was less than the lift predicted for design 1580 in FIG. 64 and design 1600 in FIG. 66 for the one condition considered.

In FIG. 70, predictions of lift versus height for a) design 1560 in FIG. 62, b) design 1520 in FIG. 58, c) design 1580 in FIG. 64, d) design 1540 in FIG. 60, e) design 1600 in FIG. 66 and f) design 1500 in FIG. 56 are compared. The designs all use eight cubic inches of magnets. The simulations were carried out heights of 0.25, 0.5, 0.75, 1 and 1.25 inches above a ½ inch thick copper plate at 6000 RPM.

Exponential curve fits are shown for design 1600 and design 1540. These two designs provide an upper and lower limit to the lift predictions. Design 1540 uses eight magnets arranged in a circle using only poles arranged to alternate.

Next, some alternate embodiments of magnet configurations and polarity alignment patterns are discussed. A magnet configuration that is formed from octagonally shaped magnets may be used. The center of four of the magnets is aligned around a circle. The remaining four magnets are fit in the gap between these four magnets. The magnets are placed such that two sides of each magnet contact two adjacent magnets. The polarity alignment pattern includes two guide magnets and two pole magnets. The pattern is repeated once and is similar to the pattern previously described above.

A magnet configuration that is formed from rectangularly shaped magnets may be used. The magnets are arranged to form a square with a space in the middle. The polarity alignment pattern includes two guide magnets and two pole magnets. The pattern is repeated once and is similar to the pattern previously described above.

A magnet configuration that is formed from rectangularly shaped magnets may be used. The magnets are arranged such that the outer perimeter is a square. In one embodiment, 24 magnets are employed. In another embodiment, some magnets can be removed to provide a larger space within the configuration. As described above, this space may be used to accommodate a motor. In this example, twenty magnets are used.

The polarity alignment pattern includes two guide regions and two pole regions. The pattern is repeated once and is similar to the pattern previously described above. In a first embodiment, the ratio of the guide magnet volume to pole magnet volume is 0.5. In a second embodiment where four magnets are removed, the ratio of the guide magnet volume to pole magnet volume is ⅔.

A magnet configuration that is disk shaped may also be used. The disk can be formed from three magnets. An aperture can be provided in the center of a first magnet, and a second magnet can be solid. As an example, a disk which is one inch in height has a volume of twenty cubic inches and an aperture radius of ½ inch has an outer radius of about 2.47 inches. In various embodiments, the total volume, height of the disk and aperture radius can be varied.

The polarity alignment pattern includes two pole magnets and a center magnet with a single polarity in between the two pole magnets. This polarity alignment pattern has been described above with respect to various designs. The ratio of guide magnet volume to pole magnet volume can be varied and the design is described for the purposes of illustration only.

In another arrangement, the magnet configuration uses trapezoidally shaped magnets, which fit together to form a ring. The magnets are enclosed in a frame, which can be a structural component of a STARM. The polarity alignment pattern includes two guide magnet regions and two pole magnet regions. The pattern is repeated once and is similar to various previously described designs.

Another design can be a variation of design 1750. In particular, four additional cubic shaped magnets can be added adjacent to each of the four pole regions. These cubic shaped magnets decrease the ratio of the guide magnet volume to the pole magnet volume.

A magnet configuration that uses triangular shaped magnets can alternatively be used. Eight triangular shaped magnets can be used, for example. The magnets are arranged to form a rectangular box. In one embodiment, a cubic magnet can be used for the two triangular shaped magnets. The magnet pattern includes two pole regions and two guide regions. The pattern is repeated once. Alternatively, rectangularly shaped magnets can be used. The guide magnets are magnetized across the diagonal, as opposed to being perpendicular to the face of magnets as shown in previous examples.

### Flight Data

In this section, flight data including performance from two vehicles is presented. First, a description of the vehicles is presented; then the test results are described. FIG. 71 is a bottom view of vehicle 1800. In FIG. 71, the vehicle 1800 includes four hover engines, 1804a, 1804b, 1804c and 1804d. The hover engines are of equal size and use similar components, i.e., similar motor, number of magnets, STARM diameter, etc. The dimensions of the vehicle 1800 are about 37.5 inches long by 4.5 inches high by 18.5 inches wide. The weight of the vehicle unloaded is about 96.2 pounds.

Each hover engine includes a STARM, such as 1825, with a motor (not shown) and engine shroud 1818 with a gap between the shroud 1818 and STARM 1825 to allow for rotation. The STARM 1825 is connected to the motor via connectors 1822. The motor, which mounts below the STARMs in the drawing, provides the input torque which rotates the STARM. In alternate embodiments, a single motor can be configured to drive more than one STARM, such as 1825.

The STARMs, such as 1825 are 8.5 inches in diameter. The STARMs are configured to receive sixteen one-inch cube magnets. Thus, the total volume of the magnets on the vehicle is sixty four cubic inches. The sixteen magnets on each STARM were arranged in a circular pattern similar to what is shown in FIG. 28. The polarity arrangement pattern is similar to what is shown in FIG. 28, except the pattern including two guide magnets and two pole magnets is repeated one less time.

Neodymium N50 strength magnets are used. The magnets each weigh about 3.6 ounces (force). Therefore, the total magnet weight for one hover engine is about 3.6 pounds (force).

In one embodiment, the motors can be a q150 DC brushless motor from Hacker Motor (Ergolding, Germany). The motor has a nominal voltage of 50 Volts and a no load current of 2 Amps. The weight is about 1995 grams. The speed constant is about 52.7/min. The RPM on eta max is about 2540. The torque on eta max is about 973.3 N-cm. The current on eta max is about 53.76 Amps.

The hover engines each have a shroud, such as 1818. The shroud 1818 partially encloses the STARM, such that a bottom of the STARM is exposed. In other embodiment, the shroud can enclose a bottom of the STARM. A tilt mechanism 1812 is coupled to the shroud 1818 of each hover engine. The tilt mechanism 1812 is coupled to a pivot arm 1810. The hover engines 1804a, 1804b, 1804c and 1804d are suspended beneath a support structure 1802. The pivot arms, such as 1810, extend through an aperture in the support structure.

The motors in each hover engine can be battery powered. In one embodiment, sixteen battery packs are used. The batteries are VENOM 50C 4S 5000MAH 14.8 Volt lithium polymer battery packs (Atomik RC, Rathdrum, Id.). Each battery weighs about 19.25 ounces. The dimensions of the batteries are 5.71 inches by 1.77 inches by 1.46 inches. The minimum voltage is 12 V and the maximum voltage is 16.8 V.

The sixteen batteries are wired together in four groups of four batteries and each coupled to motor electronic speed controllers, such as 1806a and 1806b via connectors 1816a and 1816b to four adjacent battery packs. The four batteries in each group are wired in series in this example to provide up to about 60 V to the electronic speed controllers. Connectors 1816c and 1816d each connect to four batteries and an electronic speed controller. Two electronic speed controllers are stacked behind 1806a and 1806b. Thus, four brushless electronic speed controllers, one for each motor, are used. The electronic speed controllers are Jeti Spin Pro 300 Opto brushless Electronic Speed Controllers (Jeti USA, Palm Bay, Fla.).

During the test, a data logger was connected to one of the motors. The data logger was used to record amps, voltage and RPM of the motor. The data logger is an elogger v4 (Eagle Tree Systems, LLC, Bellevue, Wash.). The data recorded during the test is presented below in Table 2.

For the test, the unloaded weight of vehicle #1 at the time of zero seconds is 96.2 pounds. As described above, the vehicle includes four hover engines. The voltage, amps and RPM are measurements from one of the hover engines. The height is measured from the bottom of the magnets on a STARM in one of the hover engines to the surface of the copper test track. The copper test track is formed from three, ⅛ inch thick, sheets of copper.

Test Vehicle #1 (FIG. 71)

| | Total | | | | | Hover |
|---|---|---|---|---|---|---|
| Time | weight | Power | Voltage | Current | | Height |
| (sec) | (lbs) | (Watts) | (Volts) | (Amps) | RPM | (mm) |
| 0 | 96.2 | 855 | 64.64 | 13.22 | 3195 | 24.4 |
| 19.6 | 184 | 1479 | 62.93 | 23.50 | 3020 | 19.9 |
| 33.8 | 273.2 | 2141 | 61.22 | 34.97 | 2848 | 15.5 |
| 46.9 | 362.4 | 2836 | 59.62 | 47.58 | 2689 | 14.2 |
| 57.7 | 450.4 | 3381 | 58.22 | 58.07 | 2549 | 11.9 |
| 69.2 | 499.6 | 3665 | 57.42 | 63.82 | 2486 | 10.7 |
| 83.3 | 550 | 4092 | 56.46 | 72.48 | 2394 | 11 |
| 95.5 | 579.6 | 4316 | 55.92 | 77.18 | 2361 | 8.2 |
| 103.3 | 609.2 | 4418 | 55.60 | 79.47 | 2329 | 7.5 |
| 110.7 | 629.4 | 4250 | 55.71 | 76.30 | 2355 | 7.9 |
| 118.7 | 649.7 | 4363 | 55.27 | 78.95 | 2314 | 7.3 |

In a second vehicle (not shown), a chassis was formed from plywood. The vehicle dimensions were 46 inches by 15.5 inches by 5 inches. The vehicle weighed seventy seven pounds unloaded. Two hover engines with STARMs of fourteen inches in diameter were used. The hover engines were secured in place and a mechanism, which allowed the hover engines to be tilted, was not provided.

Each STARM included thirty two cubic inch magnets arranged in a circular pattern similar to what is shown in FIG. 28. The polarity arrangement pattern is similar to FIG. 28 as well. However, the polarity arrangement pattern including the two guide magnets and two pole magnets is repeated more times as compared to FIG. 28.

Two Hacker motors are used (one for each STARM). Hacker motors model no. QST-150-45-6-48 with a K_{V} of 48 were used to power each STARM. Each hacker motor is coupled to one of the STARMs and an electronic speed controller.

For this vehicle, Jeti Spin Pro 200 Opto brushless Electronic Speed Controllers (Jeti USA, Palm Bay, Fla.) are used. The same battery type as described above for the first test vehicle was used. However, only eight batteries were used for the second vehicle as compared to the first test vehicle. The batteries are two divided into two groups of four and wired in series to provide a nominal voltage of about 60 Volts to each motor.

A test was conducted where the second vehicle was allowed to hover in free flight unloaded and then plate weights were added to the vehicle. The plates were weighed before the test began. The vehicle was operated over three −⅛ inch thick pieces of copper.

The current, voltage and RPM, for one of the motors, was measured in flight using the Eagle system data logger. The distance of the bottom of the magnets to the copper, referred to as the hover height, was measured by hand. Test results for the flight are shown in Table 3 as follows.

TABLE 3
Flight test data for vehicle #2
Test Vehicle #2

| | Total | | | | | Hover |
|---|---|---|---|---|---|---|
| Time | weight | Power | Voltage | Current | | Height |
| (sec) | (lbs) | (Watts) | (Volts) | (Amps) | RPM | (mm) |
| 0 | 77 | 1853 | 61.3 | 30.2 | 2942 | 26.9 |
| 10 | 165 | 3333 | 58.8 | 56.7 | 2820 | 22.3 |
| 17.1 | 254 | 4700 | 56 | 84 | 2686 | 18.3 |
| 23.1 | 343 | 5944 | 52.6 | 113 | 2525 | 14.6 |

Embodiments of the present invention further relate to computer readable media that include executable program instructions for controlling a magnetic lift system. The media and program instructions may be those specially designed and constructed for the purposes of the present invention, or any kind well known and available to those having skill in the computer software arts. When executed by a processor, these program instructions are suitable to implement any of the methods and techniques, and components thereof, described above. Examples of computer-readable media include, but are not limited to, magnetic media such as hard disks, semiconductor memory, optical media such as CD-ROM disks; magneto-optical media such as optical disks; and hardware devices that are specially configured to store program instructions, such as read-only memory devices (ROM), flash memory devices, EEPROMs, EPROMs, etc. and random access memory (RAM). Examples of program instructions include both machine code, such as produced by a compiler, and files containing higher-level code that may be executed by the computer using an interpreter.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

What is claimed is:

1. A hover vehicle comprising:
a plurality of hover engines, each hover engine having,
an electric motor including a winding, a first set of permanent magnets and a first structure which holds the first permanent magnets wherein an electric current is applied to the winding to cause one of the winding or the first set of permanent magnets to rotate; and
a second structure, configured to receive a rotational torque from the electric motor to rotate the second structure,
the second structure holding a second set of permanent magnets wherein the second set of permanent magnets are rotated to induce eddy currents in a substrate such that the induced eddy currents and the second set of permanent magnets interact to generate forces which cause the vehicle to hover above and/or translate from location to location along the substrate;
one or more controllers coupled to the hover engines for individually controlling a tilt of each of the hover engines, wherein the hover engines are arranged with respect to one another and the tilt of each hover engine are selectable so as to cause the vehicle to move in a particular direction;
an on-board electric power source that supplies the electric current to the hover engines via the one or more controllers; and
a rider platform including a front end, a back end and an upper surface.

2. The vehicle of claim 1, wherein the particular direction is a translational direction along a circular or curved path.

3. The vehicle of claim 1, wherein the particular direction is a rotational direction so that the vehicle rotates in place.

4. The vehicle of claim 1, wherein the particular direction is a combined translational and rotational direction so that the vehicle moves along a linear or curved path and rotates around an axis while moving along the path.

5. The vehicle of claim 1, wherein the tilt of each hover engine is further selectable so as to cause the vehicle to maintain a position.

6. The vehicle of claim 1, wherein the one or more controllers are further configured for individually controlling a rotational speed of each of the hover engines, wherein the rotational speed of each hover engine is also selectable so as to contribute to causing the vehicle to move in a particular direction.

7. The vehicle of claim 6, wherein controlling the tilt and rotational speed of each of the hover engines includes individually controlling a translational force generated by each hover engine.

8. The vehicle of claim 1, wherein the one or more controllers are further configured to counter imbalances in one or more forces externally applied to such vehicle.

9. The vehicle of claim 8, wherein the forces externally applied to such vehicle cause a shift of a center of mass of the vehicle.

10. The vehicle of claim 1, wherein the hover engines include a first, second, third, and fourth hover engines that each have a tilt axis about which it is tiltable by the one or more controllers, and wherein an angle between the tilt axes of the first and second hover engines is 90 degrees, wherein an angle between the tilt axes of the third and fourth hover engine is 90 degrees, wherein the first hover engine is arranged opposite the third hover engine so as to have parallel tilt axes, wherein the second hover engine is arranged opposite the fourth hover engine so as to have parallel tilt axes.

11. The vehicle of claim 1, wherein the hover engines include a first, second, third, and fourth hover engines that each have a tilt axis about which it is tiltable by the one or more controllers, and wherein the first and second hover engines are adjacent to each other and have a first angle between their tilt axes and is between 0 and 180 degrees, and wherein the first and third hover engines are opposite each other and have a second angle between their tilt axes that is equal to 180 degrees minus the first angle.

12. The vehicle of claim 1, wherein the hover engines each have a tilt axis about which it is tiltable by the one or more controllers, and wherein angles between all of the tilt axes differ from each other.

13. The vehicle of claim 1, wherein the tilt of each hover engine are selectable as a function of time so as to cause the vehicle to move in different directions as a function of time so as to follow different linear and/or curved paths.

14. The vehicle of claim 13, wherein the tilt of each hover engine are selectable as a function of time so as to cause the vehicle to move in different directions as a function of time so as to follow different linear paths, including a first path in a first direction for a first time period and a second path in a second direction for a second time period that immediately commences after the first time period, wherein the first path is perpendicular to the second path.

15. The vehicle of claim 1, further comprising a plurality of actuators for tilting the hover engines.

16. The vehicle of claim 15, wherein at least one of the actuators is arranged to tilt more than one hover engine.

17. The vehicle of claim 15, wherein the one or more controllers are configured to cause the actuators in combination with input from a rider of the vehicle to tilt one or more of the hover engines.

18. The vehicle of claim 1, wherein the hover engines are arranged to tilt through a range of −10 to 10 degrees.

19. The vehicle of claim 1, wherein the hover engines are arranged to tilt through different ranges of angles.

20. The vehicle of claim 1, wherein the one or more controllers are configured for individually controlling a tilt of each of the hover engines in response to commands received from a remote control device.

21. The vehicle of claim 1, wherein the hover engines have tilt axes that are an equal distance from a center of mass of the vehicle.

22. The vehicle of claim 1, wherein the one or more controllers are further configured for individually controlling a rotational speed of each of the hover engines, wherein the rotational speed of each hover engine is also selectably pulsed so as to contribute to causing the vehicle to move in a particular direction.

23. The vehicle of claim 1 further comprising one or more sensors for detecting a relative position and orientation of the vehicle, wherein the one or more controller are further configured for individually controlling the tilt and/or rotation of each hover engine based on the detected position and orientation as compared to a desired position and orientation.
